(19) United States
(12) Patent Application Publication
(10) Pub. No.: US 2013/0211847 A1
(43) Pub. Date: Aug. 15, 2013

(54) PRESCRIPTION DOSAGE CHECK SYSTEM AND METHOD

(71) Applicants: Vinay Vaidya, Scottsdale, AZ (US); Kelly Basfield, Scottsdale, AZ (US)

(72) Inventors: Vinay Vaidya, Scottsdale, AZ (US); Kelly Basfield, Scottsdale, AZ (US)

(21) Appl. No.: 13/397,359

(22) Filed: Feb. 15, 2012

(51) Int. Cl. G06Q 50/22; G06Q 50/24

(52) U.S. Cl. 705/2

(57) ABSTRACT

Provided is prescription dosage check system and method for ensuring safe and reliable prescription ordering and filling for a medication prescribed by a caregiver. The system includes dose range checking (“DRC”) and an alert system to prevent filling of a prescription where the prescribed dosage falls outside a dosage value or range for that medication, while minimizing nuisance alerts and alert fatigue.

### FIELD

A prescription dosage check system and method are provided for ensuring safe and reliable prescription ordering and filling for a medication prescribed by a caregiver. The system includes dose range checking (“DRC”) and an alert system to prevent filling of a prescription where the prescribed dosage falls outside a dosage value or range for that medication.

### BACKGROUND

There exists a need for a user-friendly, effective system for ensuring the delivery of a safe and effective dosage of a prescribed medication, for example, in a hospital setting, while reducing clinically insignificant alerts, i.e., nuisance alerts.

### SUMMARY

Provided is a prescription dosage check system and method for use by doctors and/or pharmacists, for example, in a hospital setting. The system can also be applied to doctors and pharmacists in separate medical facilities, locations, or practices. The prescription dosage check system and method are configured to be user friendly (i.e. doctor friendly, pharmacist friendly) and effective.

The prescription dosage system and method may utilize an electronic patient record database containing a plurality of patient records (for example, from a particular hospital or hospital network). Data in the electronic patient record database is analyzed and assembled to obtain drug dosage data that is stored in an electronic drug reference database that is part of the electronic patient record database, for one or more medications. The drug dosage data can include, for example, one or more of a 1° dosage range including a minimum dosage endpoint and a maximum dosage endpoint, a 2° dosage range including a highly ineffective dosage endpoint and an alarmingly high dosage endpoint, a minimum dosage range including a minimum dosage endpoint and a highly ineffective dosage endpoint, a maximum dosage range including a maximum dosage endpoint and a highly alarming dosage endpoint, a minimum dosage, a maximum dosage, an alarmingly high dosage, and a highly ineffective dosage.

The electronic patient record database may be limited to a particular patient population, for example including but not limited to, a pediatric patient population, a neonatal patient population, an adult population, a gender-specific population, an ethnic-specific population, a gestational patient population, a renal patient population, and a cancer patient population.

The prescription dosage check system can comprise or consist of a two-tiered system that can generate alerts including, but not limited to, one or more of a soft stop alert, a hard stop alert. For example, the soft stop alert can be based on a first range and a hard stop alert can be based on a second range having a higher maximum dose limit. In one aspect, a doctor entering an order for a dosage exceeding, the first range, may trigger a soft stop alert. The doctor then has the option to override the alert and verify the original dosage prescribed, or the doctor can change the dose to be within the first range. In the event the doctor prescribes a dose exceeding the second range, the doctor will be issued a hard stop alert. The doctor alone does not have an option to override the alert and must then contact a pharmacist to override the hard stop alert, or the doctor can change the dose to be within the first range.

The presently described subject matter is directed to one or more of a method of checking a prescription dosage, a method of reducing medication over-dosage, a method of reducing medication under-dosage, a method of reducing nuisance alerts in a dose checking system, or a system for carrying out one or more of the foregoing methods, using a system having a data terminal, a central processing unit, a central server, and an electronic patient record database comprising a plurality of electronic patient records and an electronic drug reference database. The system may optionally comprise a commercial drug database containing commercially available drug dosage information.

The presently described subject matter is directed to one or more of a method of checking a prescription dosage, a method of reducing medication over-dosage, a method of reducing medication under-dosage, a method of reducing nuisance alerts in a dose checking system, using a device having a data terminal, a central processing unit, a central server, and an electronic patient record database comprising a plurality of electronic patient records and an electronic drug reference database, comprising entering an order into the data terminal, the order comprising a prescribed dosage of a medication for a patient; uploading the order to the central server; identifying a predetermined dosage or dosage range from the electronic reference database for the medication based on the medication prescribed and at least one patient parameter obtained from an electronic patient record for the patient contained in the electronic patient record database; comparing the prescribed dosage with the identified dosage or dosage range; determining whether the prescribed dosage falls above or below the identified dosage or the prescribed dosage falls outside of the identified dosage range; and generating and outputting an alert if the prescribed dosage is above or below the identified dosage or falls outside of the identified dosage range.

The presently described subject matter is also directed to a method wherein the patient is a pediatric patient, the electronic patient record database is an electronic pediatric patient record database, and the electronic drug reference database is a pediatric electronic drug reference database.

In addition, the present subject matter is further directed to a method wherein the identified dosage or dosage range is determined so as not to trigger an alert rate greater than 3.0%.

The presently described subject matter is also directed to a method wherein if the prescribed dosage falls within the identified dosage range, then the order is filled by a pharmacist.

The presently described subject matter is further directed to a method wherein generating and outputting an alert comprises reporting a failure of the prescribed dosage to fall within the identified dosage range to the caregiver.

In addition, the present subject matter is further directed to a method wherein the reporting comprises downloading a report back to the terminal signaling the failure of the prescribed dosage to fall within the identified dosage range.

Further, the present subject matter is further directed to a method wherein the alert is a hard stop alert.

Yet further, the present subject matter is further directed to a method wherein the alert is a soft stop alert.

The presently described subject matter is directed to a method further comprising overriding, by the caregiver, the soft stop alert.

The presently described subject matter is directed to a method further comprising forbidding overriding of the hard stop alert by the caregiver.

The presently described subject matter is further directed to a method further comprising overriding the hard stop alert, by a pharmacist, of the denied order for the prescription.

Further, the presently described subject matter is directed to a method wherein the alert comprises a soft stop alert that can be overridden by the caregiver.

The presently described subject matter is directed to a method wherein the alert comprises a hard stop alert that cannot be overridden by the caregiver alone.

The presently described subject matter is directed to a method wherein the hard stop alert can be overridden by a pharmacist to then confirm filling the order.

In addition, the presently described subject matter is directed to a method wherein the alert comprises a soft stop alert that can be overridden by the caregiver to then confirm filling the order, or a hard stop that cannot be overridden by the caregiver alone.

The presently described subject matter is directed to a method wherein the hard stop alert can be overridden by a pharmacist to then confirm filling of the order by the pharmacist.

The presently described subject matter is directed to a method further comprising contacting, by the caregiver, the pharmacist to request overriding the hard stop alert (i.e., the denied order).

Further, the presently described subject matter is directed to a method wherein contacting the pharmacist comprises in-person contacting or verbally contacting.

The presently described subject matter is directed to a method wherein the identified dosage or dosage range is one or more of a 1° dosage range including a minimum dosage endpoint and a maximum dosage endpoint, a 2° dosage range including a highly ineffective dosage endpoint and an alarmingly high dosage endpoint, a minimum dosage range including a minimum dosage endpoint and a highly ineffective dosage endpoint, a maximum dosage range including a maximum dosage endpoint and a highly alarming dosage endpoint, a minimum dosage, a maximum dosage, an alarmingly high dosage, a highly ineffective dosage, a 24-hour maximum cumulative dosage, a maximum lifetime cumulative dosage, and a 12-hour maximum cumulative dosage.

The presently described subject matter is also directed to a method wherein the identified dosage range comprises a first dosage range and a second dosage range encompassing the first dosage range, wherein the caregiver can override a soft stop alert generated when an order falls outside the first dosage range but not the second dosage range.

The presently described subject matter is directed to a method wherein the caregiver cannot override a hard stop alert generated when an order falls outside the second dosage range.

The presently described subject matter is further directed to a method wherein a pharmacist can override a hard stop alert generated when an order falls outside the second dosage range only upon consultation with the caregiver.

The presently described subject matter is further directed to a system for checking a prescribed dosage for a patient, comprising an electronic patient record database comprising a computer readable assembly of a plurality of electronic patient records each corresponding to a particular patient, and an electronic drug reference database comprising drug dosing data corresponding to one or more medications; means operable to receive an order inputted by a caregiver for a prescription dosage of a medication for the patient; means operable to use the patient database to identify a dosage or dosage range for the medication based on the data contained in the electronic drug reference database and at least one patient parameter contained in an electronic patient record of the patient and contained in the electronic patient record database; means operable to compare a prescribed dosage to the identified dosage or dosage range; and means operable to output an alert to the caregiver, if the prescribed dosage is different from the identified dosage or dosage range.

The presently described subject matter is directed to a system for checking a prescribed dosage for a patient wherein an identified dosage or dosage range is a maximum dosage, and the alert is generated when the prescribed dose exceeds the maximum dosage.

The presently described subject matter is directed to a system for checking a prescribed dosage for a patient wherein an identified dosage or dosage range is a minimum dosage, and the alert is generated when the prescribed dose is less than the minimum dosage.

Further, the presently described subject matter is directed to a system for checking a prescribed dosage for a patient wherein an identified dosage is a dosage range, and the alert is generated when the prescribed dosage is outside the identified dosage range.

The presently described subject matter is also directed to a system for checking a prescribed dosage for a patient wherein the alert comprises a soft stop alert that can be overridden by the caregiver.

In addition, the presently described subject matter is directed to a system for checking a prescribed dosage for a patient wherein the alert comprises a hard stop alert that cannot be overridden by the caregiver alone.

The presently described subject matter is directed to a system for checking a prescribed dosage for a patient wherein a pharmacist can override the hard stop only upon consultation with the caregiver.

Further, the presently described subject matter is directed to a method of checking a prescription dosage using a system comprising a data terminal, a central processing unit, a central server, and an electronic patient database comprising a plurality of electronic patient records and an electronic reference database, comprising entering an order into the data terminal, the order comprising a prescribed dosage of a medication for a patient; uploading the order to the central server; generating a dosage or dosage range from the electronic reference database based on the medication prescribed and at least one patient parameter obtained from an electronic health record for the patient; comparing the prescribed dosage with the generated dosage or dosage range; determining whether the prescribed dosage falls above or below the generated dosage or dosage range; and generating and outputting an alert if the prescribed dosage falls above or below of the generated dosage or dosage range.

The presently described subject matter is directed to a method of checking a prescription dosage where the at least one patient parameter is selected from, for example, weight, allergies, sex, age, current diagnosis, chronic conditions, patient ethnicity, transplant status, genetic abnormalities, current medication, and smoking status.

The presently described subject matter is directed to a method of checking a prescription dosage wherein an electronic patient record for the patient contained in the electronic patient record database is updated with the patient's data in real time.

Further, the presently described subject matter is directed to a method where the patient is a pediatric patient and the patient record database is an electronic pediatric patient record database.

The presently described subject matter is directed to a method of checking a prescription dosage where the electronic patient record database comprises an electronic reference database comprising dosing data corresponding to one or more medications.

The presently described prescription dose checking system can include a maximum dosage and a minimum dosage.

In an aspect, when an ordered prescription dosage exceeds a hard stop maximum dosage, the system issues a hard stop alert preventing the order from being filled.

In a further aspect, when an ordered prescription dosage exceeds a dosage that triggers a soft stop alert, but does not exceed a dosage that triggers a hard stop alert, the caregiver can override the soft stop alert but not the hard stop alert.

In an aspect example, when an ordered prescription dosage exceeds a dosage that triggers a soft stop alert and a dosage that triggers a hard stop alert, the caregiver alone cannot override the hard stop alert. The hard stop alert can only be overridden after the caregiver consultants with a pharmacist who can then override the hard stop alert.

In a another aspect, when an ordered prescription dosage is below a minimum dosage but not below an ineffective dosage, the caregiver receives a soft stop alert and can increase the dosage to the minimum dosage or to a dosage between the minimum dosage and maximum dosage, or the caregiver can override the soft stop alert.

In another aspect, when an ordered prescription dosage falls below a highly ineffective dosage, the caregiver receives a hard stop alert and can increase the dosage to the minimum dosage, or to between a minimum dosage and maximum dosage. The caregiver alone cannot override the hard stop alert. The hard stop alert can only be overridden after the caregiver consults with a pharmacist who can then override the hard stop alert.

Alternatively, the dosage can be in the form of a dosage range or ranges.

In the case where an ordered prescription specifies a dosage falling within a dosage range, then the order is filled.

In another aspect, if an ordered prescription dosage specifies a dosage below the dosage range but not below an ineffective dosage range, then the caregiver receives a soft stop alert and can increase to the dosage to a dosage within the range, or can override the soft stop alert and have the prescription filled at the lower dosage. The method of claim 1, wherein the identified dosage or dosage range is determined by obtaining a dosage or dosage range based on the medication prescribed and at least one patient parameter from the electronic reference drug database and checking the obtained dosage or dosage range against dosage data for that medication contained in a different medication database, to generate the identified dosage or dosage range.

Further, the presently described subject matter is directed to a method wherein the identified dosage or dosage range comprises at least two maximum dosage parameters selected from the group consisting of flat soft stop maximum dosage, flat hard stop maximum dosage, per kilogram soft stop maximum dosage, per kilogram hard stop maximum dosage, daily flat soft stop maximum dosage, daily flat hard stop maximum dosage, daily per kilogram soft stop maximum dosage, and daily per kilogram hard stop maximum dosage.

The presently described subject matter is directed to a method wherein the at least two maximum dosage parameters are processed serially or simultaneously when comparing the ordered prescription dosage with the identified dosage or dosage range.

The presently described subject matter is directed to a method wherein the identified dosage or dosage range comprises more than one threshold measurement point.

Further, the presently described subject matter is directed to a method wherein the more than one threshold measurement point comprises one or more maximum and one or more minimum dosing amounts of at least one dosage form of a drug.

The presently described subject matter is directed to a method wherein each maximum and minimum dosing amount corresponds to one or more units of measurement.

Yet, further, the presently described subject matter is directed to a method wherein the one or more units of measurement is selected from an amount of drug/kg/dose, an amount of drug/kg/day, an amount of drug/m² of body surface area/dose; a flat amount of drug/dose and/or a flat amount of drug/day.

In addition, the presently described subject matter is directed to a method wherein the maximum dosing amount is an alarmingly high dosing amount and the minimum dosing amount is a highly ineffective dosing amount.

The presently described subject matter is directed to a method further comprising a low normal dosing amount that is more than the highly ineffective dosing amount but less than the alarming high dosing amount.

Further, the presently described subject matter is directed to a method further comprising a high normal dosing amount that is less than the alarmingly high dosing amount but more than the highly ineffective dosing amount.

The presently described subject matter is directed to a method further comprising a low normal dosing amount that is more than the highly ineffective dosing amount but less than the alarming high dosing amount and a high normal dosing amount that is less than the alarmingly high dosing amount but more than the highly ineffective dosing amount.

Further, the presently described subject matter is directed to a method wherein when the prescribed dosage is greater than the alarmingly high dosing amount, a hard stop alert is outputted.

Further, the presently described subject matter is directed to a method wherein the hard stop alert prevents the order from processing by a pharmacy unless the prescribed dosage is reduced or a pharmacist manually overrides the hard stop alert and/or documents the reason for proceeding with the order.

In addition, the presently described subject matter is directed to a method further comprising proceeding with order and dispensing of the prescribed dosage when the prescribed dosage is reduced or the pharmacist manually overrides the hard stop and/or documents the reason for proceeding with the order.

Yet further, the presently described subject matter is directed to a method wherein when the prescribed dosage is greater than the high normal dosing amount but less than the alarmingly high dosing amount, a soft stop alert is outputted.

Still further, the presently described subject matter is directed to a method wherein the soft stop alert comprises outputting a message for a caregiver indicating that the prescribed dosage is abnormal and suggesting that the prescribed dose be changed.

The presently described subject matter is directed to a method wherein the soft stop alert is suppressed if a corresponding alert was outputted for the same patient, same drug and same caregiver within the previous 48 hours.

The presently described subject matter is directed to a method wherein when the caregiver reduces the prescribed dosage pursuant to the soft stop alert, a notification of the alert is generated for review by a reviewing party and the order proceeds to being dispensed.

The presently described subject matter is directed to a method wherein the reviewing party is a pharmacist, an information technology team member, or a quality assurance team member.

The presently described subject matter is directed to a method wherein when caregiver does not change the prescribed dosage, the caregiver is required to input a reason for proceeding.

Further, the presently described subject matter is directed to a method wherein the reason for proceeding is sent via an interface to the pharmacy for review by a pharmacist prior to dispensing the prescribed dosage.

Still further, the presently described subject matter is directed to a method wherein the reason for proceeding is populated in a virtual medical record.

Yet further, the presently described subject matter is directed to a method wherein when the pharmacist rejects the reason for proceeding, a consultation form is outputted.

The presently described subject matter is directed to a method wherein the consultation form requires the approval of the caregiver and the pharmacist or the approval of a second caregiver in order for the order to be processed and dispensed by the pharmacy.

The presently described subject matter is directed to a method wherein when the consultation form is not approved by both the pharmacist and the caregiver or the second caregiver, approval is required by the head of pharmacy and/or the head of clinical.

Further, the presently described subject matter is directed to a method wherein when the head of pharmacy and/or the head of clinical do not provide approval, the caregiver is provided with an option to proceed with the order.

The presently described subject matter is directed to a method wherein when approval is provided, the reason for approval is outputted into a virtual medical record.

The presently described subject matter is directed to a method wherein when the prescribed dosage is less than the highly ineffective dosing amount, a hard stop alert is outputted.

Further, the presently described subject matter is directed to a method wherein the hard stop alert prevents the order from processing by a pharmacy unless the prescribed dosage is increased or a pharmacist manually overrides the hard stop alert and/or documents the reason for proceeding with the order.

Further, the presently described subject matter is directed to a method further comprising proceeding with order and dispensing of the prescribed dosage when the prescribed dosage is increased or the pharmacist manually overrides the hard stop and/or documents the reason for proceeding with the order.

The presently described subject matter is directed to a method wherein when the prescribed dosage is less than the low normal dosing amount but greater than the highly ineffective dosing amount, a soft stop alert is outputted.

The presently described subject matter is directed to a method wherein the soft stop alert comprises outputting a message for a caregiver indicating that the prescribed dosage is abnormal and suggesting that the prescribed dose be changed.

The presently described subject matter is directed to a method wherein the soft stop alert is suppressed if a corresponding alert was outputted for the same patient, same drug and same caregiver within the previous 48 hours.

The presently described subject matter is directed to a method wherein when the caregiver increases the prescribed dosage pursuant to the soft stop alert, a notification of the alert is generated for review by a reviewing party and the order proceeds to being dispensed.

Further, the presently described subject matter is directed to a method wherein the reviewing party is a pharmacist, an information technology team member, or a quality assurance team member.

Yet further, the presently described subject matter is directed to a method wherein when the caregiver does not change the prescribed dosage, the caregiver is required to input a reason for proceeding.

Further, the presently described subject matter is directed to a method wherein the reason for proceeding is sent via an interface to the pharmacy for review by a pharmacist prior to dispensing the prescribed dosage.

Further, the presently described subject matter is directed to a method wherein the reason for proceeding is populated in a virtual medical record.

Yet further, the presently described subject matter is directed to a method wherein when the pharmacist rejects the reason for proceeding, a consultation form is outputted.

Still further, the presently described subject matter is directed to a method wherein the consultation form requires the approval of the caregiver and the pharmacist or the approval of a second caregiver in order for the order to be processed and dispensed by the pharmacy.

The presently described subject matter is directed to a method wherein when the consultation form is not approved by both the pharmacist and the caregiver or the second caregiver, approval is required by the head of pharmacy and/or the head of clinical.

The presently described subject matter is directed to a method wherein when the head of pharmacy and/or the head of clinical do not provide approval, the caregiver is provided with an option to proceed with the order.

Further, the presently described subject matter is directed to a method wherein when approval is provided, the reason for approval is outputted into a virtual medical record.

### BRIEF DESCRIPTION OF THE DRAWINGS

FIG. 1 is a schematic block diagram of the pre dose range checking prescription dose check system.

FIG. 2 is a schematic flow diagram showing alerts.

FIG. 3 is a schematic flow diagram showing the balance between sensitivity and specificity regarding the alert logic.

FIG. 4 is a schematic flow diagram of the prescription dose checking system.

FIG. 5 is a table listing “Non-drips,” i.e., non-parenteral dosage forms of various drugs, and information regarding same for use in the prescription dose check system.

FIG. 6 is a table listing “Drips,” i.e., parenteral dosage forms of various drugs, and information regarding same for use in the prescription dose check system.

FIG. 7 is a view of a graphical user interface showing an Alert popup screen—For LIPS—Exceeds Per Kg Soft Stop limit for non drips.

FIG. 8 is a view of a graphical user interface showing an Alert popup screen—For LIPS—Exceeds Per Kg Soft Stop limit for non drips.

FIG. 9 is a view of a graphical user interface showing an Alert popup screen—For LIPS—Exceeds Flat Soft Stop limit for non drips.

FIG. 10 is a view of a graphical user interface showing an Alert popup screen—For LIPS—Exceeds Flat Hard Stop limit for non drips.

FIG. 11 is a view of a graphical user interface showing an Alert popup screen—For LIPS—Exceeds Per Kg Soft Stop limit for drips.

FIG. 12 is a view of a graphical user interface showing an Alert popup screen—For LIPS—Exceeds Per Kg Hard Stop limit for drips.

FIG. 13 is a view of a graphical user interface showing an Alert popup screen—For LIPS—Exceeds Flat Stop limit for drips.

FIG. 14 is a view of a graphical user interface showing an Alert popup screen—For LIPS—Exceeds Flat Hard limit for non drips.

FIG. 15 is a view of a graphical user interface showing an Alert popup screen—For nurses (non-LIPS)—for non drips.

FIG. 16 is a view of a graphical user interface showing an Alert popup screen—For nurses (non-LIPS)—for drips.

FIG. 17 is a view of a graphical user interface showing an Alert popup screen—For Pharmacists—exceeding soft stop limit.

FIG. 18 is a view of a graphical user interface showing an Alert popup screen—for Pharmacists—exceeding hard stop limit.

FIG. 19 is a schematic flow diagram of the hospital computer network, including the prescription dose checking system.

FIG. 20 is a schematic flow diagram of the overall hospital computer network, including the prescription dose checking system.

FIG. 21 is a schematic flow diagram of the hospital network with the AllScripts™ Network.

FIG. 22 is a view of a graphical user interface showing Before DRC.

FIG. 23 is a view of a graphical user interface showing Traditional Approach.

FIG. 24 is a view of a graphical user interface showing Each Limit=unique configuration and Manual entry=chances for error.

FIG. 25 is a view of a graphical user interface showing New Approach for Rapid DEVELOPMENT OF DRC.

FIG. 26 is a view of a graphical user interface showing New Approach: Critical Step.

FIG. 27 is a view of a graphical user interface showing Analysis of Most Frequently Used Drugs.

FIG. 28 is a view of a graphical user interface showing Basic Schematic Approach for DRC Limits.

FIG. 29 is a view of a graphical user interface showing Determining Hard & Soft Limits: Historical Ordering Pattern.

FIG. 30 is a view of a graphical user interface showing Create Dose Range Table in Excel.

FIG. 31 is a view of a graphical user interface showing Step 1: Export Drug Item Catalogue.

FIG. 32 is a view of a graphical user interface showing Step 2: Set Four Basic Dosing Limits.

FIG. 33 is a view of a graphical user interface showing Step 3: Define “Normal” Values.

FIG. 34 is a view of a graphical user interface showing Final Dosing Table in Excel.

FIG. 35 is a view of a graphical user interface showing Future Enhancements.

FIG. 36 is a view of a graphical user interface showing Final Workflow: Specs for MLM Logic.

FIG. 37 is a view of a graphical user interface showing One Single MLM.

FIG. 38 is a view of a graphical user interface showing DRC Soft Stop Example.

FIG. 39 is a view of a graphical user interface showing Verbal/Telephone Order.

FIG. 40 is a view of a graphical user interface showing DRC Hard Stop Example.

FIG. 41 is a view of a graphical user interface showing Only a Pharmacist is permitted to override a Hard Stop in SCM.

FIG. 42 is a view of a graphical user interface showing Soft Alert Flows From SCM to GE Pharmacy.

FIG. 43 is a view of a graphical user interface showing Automatic Order Intervention is Created in the GE Pharmacy System.

FIG. 44 is a view of a graphical user interface showing Order Intervention in GE Pharmacy System.

FIG. 45 is a view of a graphical user interface showing Email Alert Generated By MLM.

FIG. 46 is a view of a graphical user interface showing Of 1154 Medication Orders.

FIG. 47 is a view of a graphical user interface showing Of 923 Meds Checked for DRC.

FIG. 48 is a view of a graphical user interface showing Of 30 Alerts.

FIG. 49 is a view of a graphical user interface showing 17 Of 30 (56%) Alerts/day.

FIG. 50 is a view of a graphical user interface showing What Did the Modifications Look Like?

FIG. 51 is a view of a graphical user interface showing SUMMARY: 1154 drug orders/day.

FIG. 52 is a view of a graphical user interface showing Results/Impacts.

FIG. 53 is a view of a graphical user interface showing Alerts by Users.

FIG. 54 is a view of a graphical user interface showing Potassium: 11 Hard Stops 4 months.

FIG. 55 is a view of a graphical user interface showing Insulin Drip: 9 Soft+Hard Stops.

FIG. 56 is a view of a graphical user interface showing Fentanyl: 12 Soft & Hard Stops.

FIG. 57 is a view of a graphical user interface showing Hydrocodone: Tab.

FIG. 58 is a view of a graphical user interface showing Hydrocodone Elixir.

FIG. 59 is a view of a graphical user interface showing Morphine Soft Stop.

FIG. 60 is a view of a graphical user interface showing Heparin: Overdose overlaps with increased requirements.

FIG. 61 is a view of a graphical user interface showing Digoxin: Decimal Error.

FIG. 62 is a view of a graphical user interface showing Top 10 Hard Stops: Cancelled or reduced suggesting dosing error.

FIG. 63 is a view of a graphical user interface showing Top 10 Drugs where Hard Stop was Overridden.

FIG. 64 is a view of a graphical user interface showing Summary.

FIG. 65 is a view of a graphical user interface showing PRACTIONER EXPERIENCE DECREASES MEDICATION DOSING ERRORS IN A PEDIATRIC ICU.

FIG. 66 is a view of a graphical user interface showing CUSTOMIZATION OF A DOSE RANGE CHECKING SYSTEM DECREASES MEDICATION ERRORS IN A PEDIATRIC ICU.

### DETAILED DESCRIPTION

### Definitions

The term “about” as used herein refers to a quantity, level, value, dimension, size, or amount that varies to some extent based on the context in which it is used. For example, such variation can be by as much as 5%. At the least, each numerical parameter can be construed in light of the number of reported significant digits and by applying ordinary rounding techniques.

The term “alert” as used herein refers to a two-tiered alert system where a caregiver is alerted that a prescribed dosage falls outside an identified dosage or dosage range, by the generation of a soft stop or a hard stop. Alerts can be generated for dosages that exceed or fall below an identified dosage or dosage range. Alerts can also be generated for renal, gestational, and chemotherapy dosing. Soft stop alerts may be overridden by a caregiver. Hard stop alerts may not be overridden by a caregiver alone. For example, when an order for a prescribed medication exceeds a maximum dosage but is less than an alarmingly high dosage, a soft stop alert is generated. When the order exceeds an alarmingly high dosage, a hard stop is generated that can be overridden by a pharmacist only upon communication with the caregiver.

The term “alert fatigue” refers to a type of fatigue whereby a physician, after receiving too many alerts, begins to ignore and/or override the alerts. Receiving too many alerts can result in slowing the physician down rendering the alert useless.

The term “soft stop alert” refers to an alert that can be overridden by the caregiver.

The term “hard stop alert” refers to an alert that cannot be overridden by the caregiver alone, but can be overridden by a pharmacist only upon consultation with the caregiver.

The term “caregiver” or “care-giving party” as used herein refers to a person authorized to order a medication, and can include, for example, physicians, residents, and/or nurse practitioners.

The phrase “computerized physician order entry” (CPOE) as used herein refers to known systems that enhance the medication ordering process. Suitable CPOE systems that can be configured for use herein include, for example, the ECLIPSYS™ CPOE system.

The term “check” or “checking” as used herein means clinical checks or verifications of medication orders that are carried out at the time of order entry, order verification, and/or medication administration. Alerts, for example, that indicate that a dosage falls above or below an identified dosage or dosage range, may be generated during these checks.

The phrase “drug dosage data” as used herein refers to one or more of an identified dosage or dosage range, including but not limited to, one or more of a 1° dosage range including a minimum dosage endpoint and a maximum dosage endpoint, a 2° dosage range including a highly ineffective dosage endpoint and an alarmingly high dosage endpoint, a minimum dosage range including a minimum dosage endpoint and an ineffective dosage endpoint, a maximum dosage range including a maximum dosage endpoint and a highly alarming dosage endpoint, a minimum dosage, a maximum dosage, an alarmingly high dosage, a highly ineffective dosage, a 24-hour maximum cumulative dosage, a maximum lifetime cumulative dosage, and a 12-hour maximum cumulative dosage.

The term “electronic patient record” (EPR) or “electronic medical record” (EMR) or “electronic health record” (EHR) are interchangeable, and as used herein refers to electronically recorded patient history elements for a particular patient, including but not limited to, the patient's name, personal statistics including body weight, sex, age, and body surface area, diagnoses, medication and allergies, dosage amounts, frequency and duration, routes of administration, dates, side effects, complications, effectiveness data, immunization status, laboratory test results, radiology images, vital signs, adverse events, history & physical notes, hospital admissions, admission notes, progress notes, and triage notes. The EPR can be updated in real time. EPR's that can be configured for use with the presently described subject matter include ALLSCRIPTS™ Electronic medical record products.

The term “electronic patient record database” as used herein refers to an electronic database comprising a plurality of patient records and an electronic reference database. The electronic patient record database is updated in real time as a particular patient record is updated. The electronic patient record database may include only patient records for a particular population of patients, for example, pediatric patients, adult patients, neonatal patients, geriatric patients, female patients, male patients, gestational patients, as well as patients of a particular ethnic descent, for example, Caucasian patients, African patients, and Asian patients. Each of the foregoing patient groups may optionally be further limited by one or more of age (neonatal, pediatric, adult geriatric, pre- and post-menopausal), sex, and ethnic background. Suitable electronic patient record databases can include, but are not limited to, a pediatric patient record database, a neonatal patient record database, a geriatric patient record database, a female patient record database, a male patient record database, a Caucasian patient record database, an African patient record database, and an Asian patient record database.

The term “electronic pediatric patient database” as used herein refers to a patient database as defined herein where the patient population is a pediatric patient population. Such pediatric patients can weigh as little 10 ounces or as much as 300 pounds or more for adolescents.

The term “electronic drug reference database” refers to a database comprising drug dosage data as defined herein for one or more drugs. The electronic drug reference database can be created, in part, from data contained in an electronic patient record database, including for example, historical data. The electronic drug reference database does not contain dosage values derived only from drug manufacturer provided dosing information. The electronic drug reference database may contain data derived from manufacturer provided dosing information along with data derived from an electronic patient record database. The data in the electronic patient record database is analyzed and assembled to provide the data in the electronic drug reference database. For example, over 750,000 drugs ordered were analyzed from an 8 year period of computerized physician order entry. By examining the historical orders entered, the dosage limits being established were validated against real orders that had been placed in the system. The specificity and sensitivity of the dosage limits being set were then validated using, in part, the drug analysis. As a result, the number of alerts a physician would be subjected to could be determined with certainty.

Suitable electronic drug reference databases can include, but are not limited to, a pediatric drug reference database, a neonatal drug reference database, a geriatric drug reference database, a female drug reference database, a male drug reference database, a gestational drug reference database, a Caucasian drug reference database, an African drug reference database, and an Asian drug reference database.

The term “electronic pediatric drug reference database” refers to a database of drug dosage data for one or more drugs, where the data is derived, at least in part, from data in an electronic pediatric patient database, including for example, historical data.

The term “highly ineffective dosage” refers to a dosage at which or below, no discernable therapeutic benefit is derived.

The term “nuisance drug alert” as used herein refers a drug alert rate of greater than 7%, greater than 6%, greater than 5%, greater than 4%, greater than 3.9%, greater than 3.7%, greater than 3.5%, greater than 3.2%, greater than 3.0%, greater than 2.9% greater than 2.8%, greater than 2.7%, greater than 2.6%, greater than 2.5%, or greater than 2.4%.

The term “overdose” or “overdose error” refers to a dosage amount of a medication that falls outside of an identified dosage amount that triggers hard stop alert in the presently described method.

The term “pharmacist” as used herein refers to a pharmacist.

As used herein, “subject” or “individual” or “patient” refers to any subject, for whom diagnosis, prognosis, or therapy is desired, for example, a human.

As used herein, a “treatment” or “treating” of a disease, disorder, or condition encompasses alleviation of at least one symptom thereof, a reduction in the severity thereof, or the delay or inhibition of the progression thereof. Treatment need not mean that the disease, disorder, or condition is totally cured. A useful composition herein needs only to reduce the severity of a disease, disorder, or condition, reduce the severity of symptoms associated therewith, provide improvement to a patient or subject's quality of life, or delay or inhibit the onset of a disease, disorder, or condition.

Any concentration ranges, percentage range, or ratio range recited herein are to be understood to include concentrations, percentages or ratios of any integer within that range and fractions thereof, such as one tenth and one hundredth of an integer, unless otherwise indicated.

Any number range recited herein relating to any feature, such as is to be understood to include any integer within the recited range, unless otherwise indicated.

It should be understood that the terms “a” and “an” as used above and elsewhere herein refer to “one or more” of the enumerated components. It will be clear to one of ordinary skill in the art that the use of the singular includes the plural unless specifically stated otherwise.

Unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained.

Throughout the application, descriptions of various embodiments use “comprising” language; however, it will be understood by one of skill in the art, that in some specific instances, an embodiment can alternatively be described using the language “consisting essentially of” or “consisting of.”

Other terms as used herein are meant to be defined by their well-known meanings in the art.

### Alerts:

To create drug alerts within a CPOE system, configuration is separated from the programming logic by creating a separate reference table. Drug-by-drug configuration is removed, and for each of the drugs in the system, for example over 1,100 drugs, there is one single custom code that looks up all the drugs. The custom code identifies the drug that is ordered and evaluates the order to see if it falls within the dosing value ranges in the reference table. If the order does not fit within the ranges, the system will generate a soft stop alert; or if the dose is so high, the system will initiate a hard stop.

Alerting configuration has to be sensitive and strike the right balance, so that alerts will not be perceived as nuisances by a care-giving party. Accordingly, a dose strategy was adopted that allowed determination of the point at which to alert a physician that is very different than alerts at the normal dosing ranges. Because the present inventors had access to dosing patterns, appropriate limits were set to correspond with these patterns.

The literature suggests that hard stops can significantly decrease physician workflow. The presently described hard stops if used judiciously with multidisciplinary buy-in, with data to support, they can be extremely powerful.

A two-tiered system of alerts was devised to target the caregiver, i.e., a physician, at the point of order entry. If the physician orders a drug that exceeds a soft stop limit, a hard stop alert is provided with instructions on how to resolve the problem, along with normal dose ranges for reference. In more than 60.7 percent of the cases alerts have resulted in the physician either cancelling or correcting the order. If the physician wants to proceed, a reason must be provided. That reason is then sent to the pharmacy system through the interface so that the pharmacist doing the clinical verification can understand the physician's intent, 80% of orders are checked, 3% result in an alert. Of the alerts, 66% are soft stops, 33% are hard stops, 53% of those alerts result in a cancellation or modification of the order. See the presentation named, “DRC Presentation to PCH Patient Safety Committee Vinay November 2011”.

Using the present system, the alerting rate for soft and hard stops for all orders is in the range of from about greater than 0% to about 5%, from about 1% to about 4.5%, from about 1% to about 4.0%, from about 1.5% to about 3.75%, from about 1.75% to about 3.5%, from about 2% to about 3.25%, from about 2.25% to about 3.0%, from about 1.75% to about 2.5%, from about 1.75% to about 3%, from about 1.75% to about 2.9%, from about 1.75% to about 2.8%, from about 1.75% to about 2.7%, from about 1.75% to about 2.7%, from about 1.75% to about 2.6%, less than 2%, less than 2.5%, less than 2.4%, less than 2.6%, less than 2.7% less than 2.8% less than 2.9%, less than 3%, less than 3.1%, less than 3.2%, about 2.7%, about 2.8%, about 2.9% or about 3%. The alerting rate for soft stops for all orders is in the range of from about greater than 0% to about 5%, from about 1% to about 4%, from about 1% to about 3%, from about 1.5% to about 3%, from about 1.5% to about 2.5%, or about 2%. The alerting rate for hard stops for all orders is in the range of from about greater than 0% to about 3%, from about 0.25% to about 2.5%, from about 0.5% to about 2%, from about 0.5% to about 1.5%, from about 0.75% to about 1.25%, or about 1%. The ratio of soft to hard stops is from about 2 to about 8:10, from about 3 to about 7:10, from about 4 to about 7:10, from about 5 to about 7:10, from about 5.5 to about 7:10, from about 6 to about 7:10, from about 6.4 to about 7:10, or about 6.7:10.

Using the present system, prescription overdose errors are minimized. For example, prescription overdose errors are from about 0% to about 3%, from 0% to about 2%, from 0% to about 1%, from 0% to about 0.75%, from 0% to about 0.5%, from 0% to about 0.25%, from 0% to about 0.2%, from 0% to about 0.15%, from 0% to about 0.1%, from 0% to about 0.05%, less than about 3%, less than about 2.5%, less than about 2%, less than about 1.5%, less than 1%, less than about 0.5%, less than about 0.25%, less than about 0.2%, less than about 0.15%, less than about 0.1% or less than about 0.05%,

### Reference Table:

A table of all of the pharmacy items at Phoenix Children's Hospital's formulary was created. For each item, each way the drug could be ordered by a physician was listed. For every order listed, the “flat soft max dose limit”, the “flat hard max dose limit”, the “per kg soft max dose limit” and the “per kg hard max dose limit” was determined. These values were vetted through an analysis of historical orders that had all ready been entered into the CPOE system during the last 8 years. Once the dose limits met predetermined goals of appropriate specificity and sensitivity, those limits were entered into the custom table. This iterative process was used for establishing the highly ineffective dose limits.

### Custom Code:

The custom code described herein, for example, was written in Arden Syntax. It was designed to match the logic of the process flow algorithm.

### Prescription Dose Check System:

The dose range checking system is provided as a Medical Logic Module (MLM) using, for example, the Arden Syntax computer language. The dose range checking system utilizes: 1) a computer physician order entry (CPOE) system, for example the ECLIPSYS™ CPOE system (See www.elipsys.com and www.allscripts.com); a physicians database, for example, MULTUM™ (Denver, Colo. 80222); a pharmacy IT system, for example, GE CENTRICITY PHARMACY (GE Healthcare, See www3.gehealthcare.com); a drug information database, for example, from MEDISPAN™ (Indianapolis, Ind.); and a clinical support database, for example, LEXI-DATA™, (Hudson, Ohio).

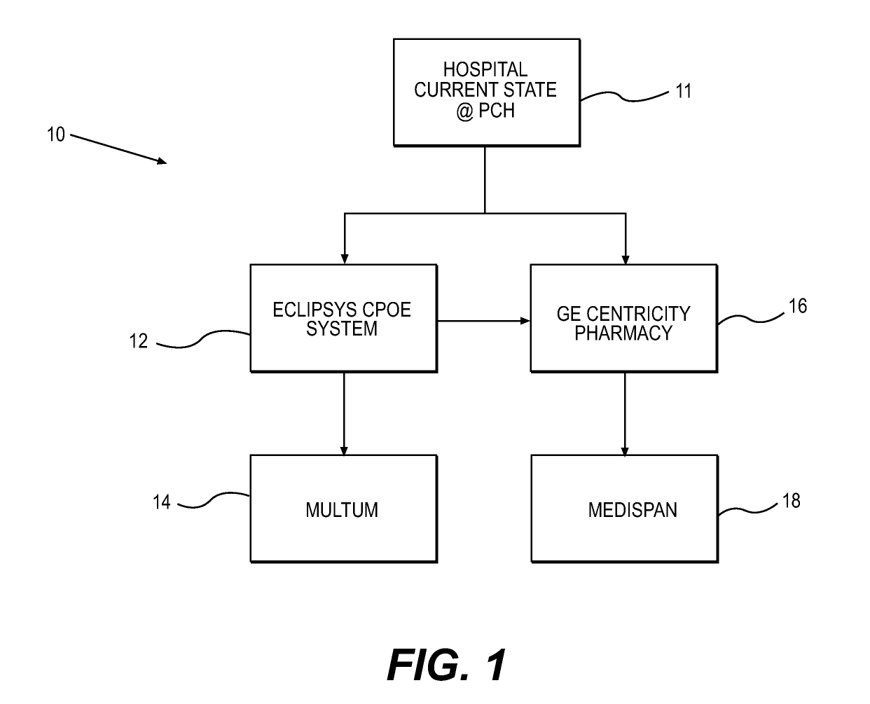

The configuration of the prescription dose check system 10, is shown in FIG. 1.

The prescription dose checking system 10, includes HOSPITAL computer system 11 supported by ECLIPSYS computerized physician order entry (CPOE) system 12; MULTUM physician's database 14; GE CENTRICITY PHARMACY, a pharmacy IT system with advanced pharmacy medication management software 16; and MEDIPSAN, a drug information database 18, in the arrangement as shown and indicated.

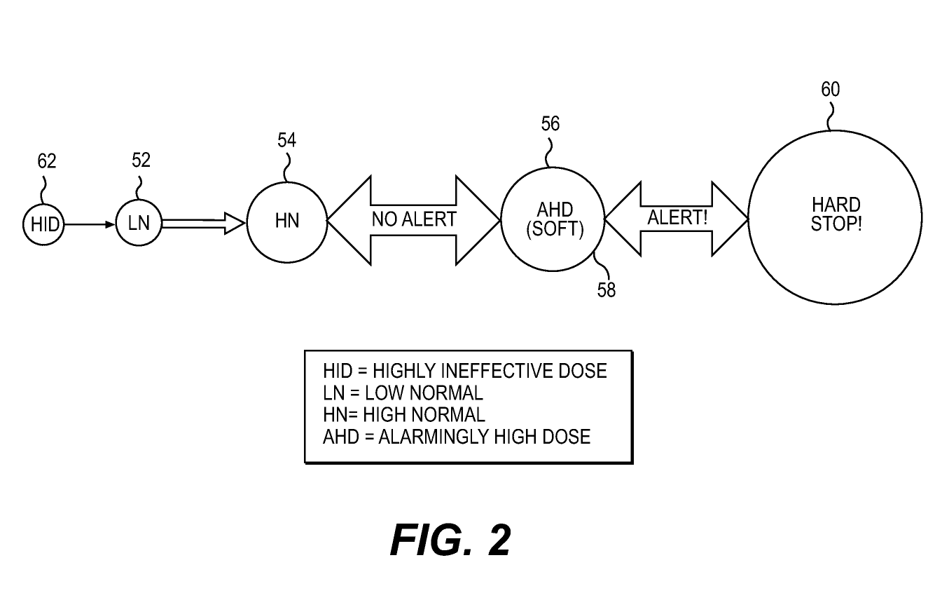

A schematic flow diagram showing the alert logic 50 for the prescription dose check system is shown in FIG. 2.

The diagram shows that a prescription order for a Low Normal (LN) Dose 52 and a High Normal (HN) Dose 54, defining a dosage range, results in “No alert.” In contrast, an Alarmingly High Dose (AHD) 56 results first in a Soft Stop Alert 58 and then a Hard Stop! Alert 60.

A Highly Ineffective Dose (HID) 62 results in a referral to the Low Normal (LN) Dose 52 and High Normal (HN) Dose 54 range.

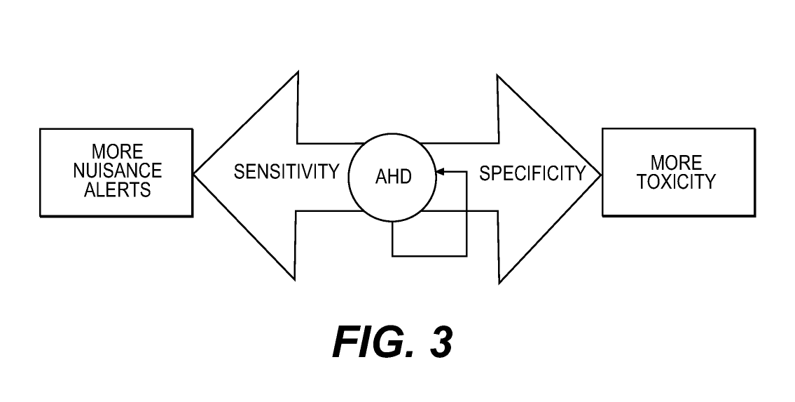

FIG. 3 shows the balance between alert sensitivity and alert specificity. Too much sensitivity results in More Nuisance Alerts, and too much specificity results in More Toxicity.

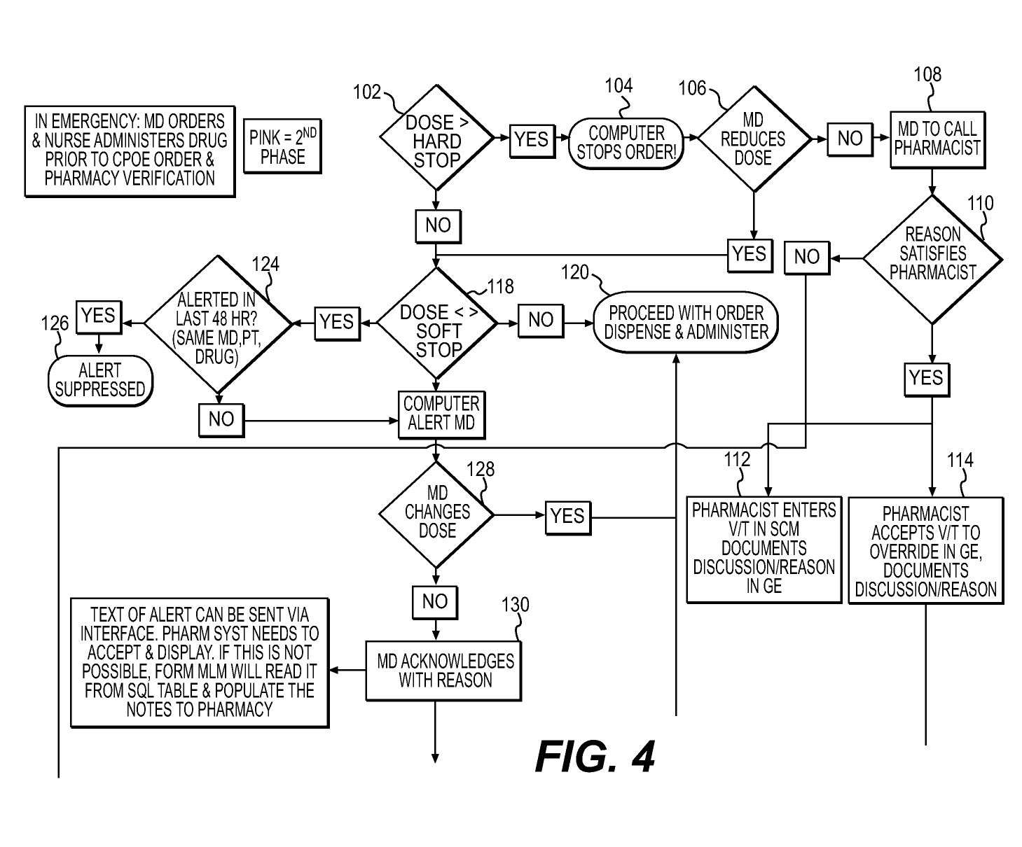

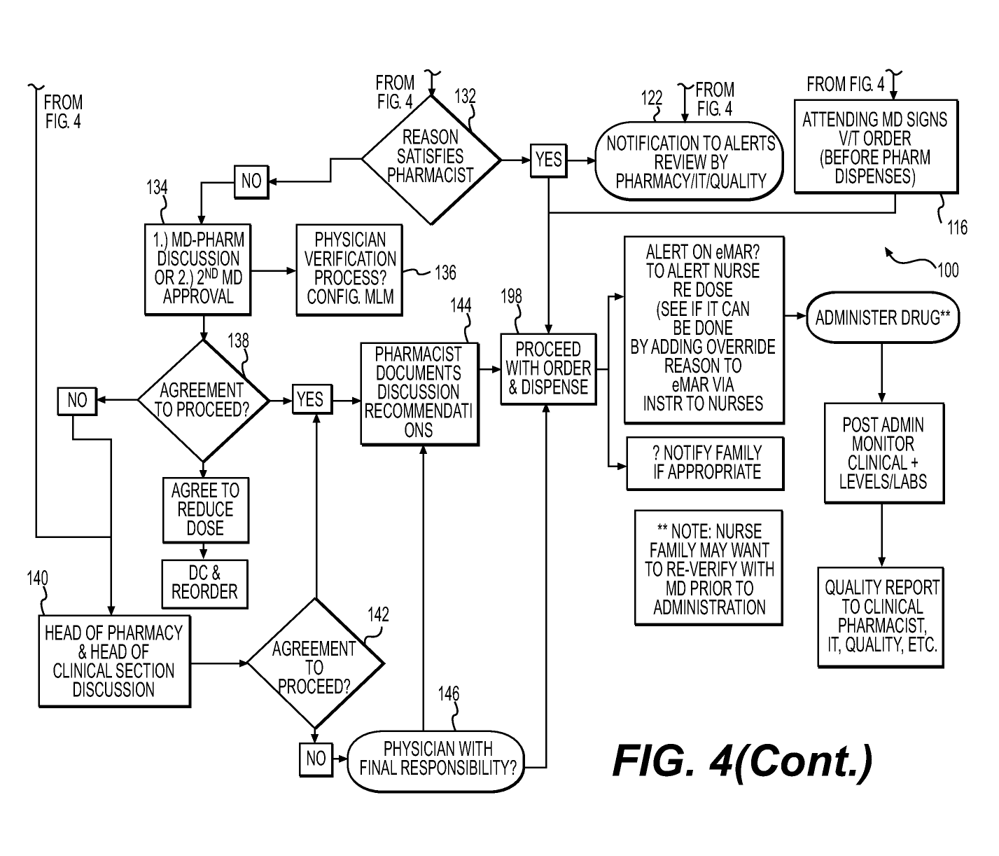

A flow diagram of the prescription dose system 100, is shown in FIG. 4.

A Physician orders a prescription, and the prescription dose system 100 determines whether the ordered dose is greater than the hard stop (step 102). If Yes, then COMPUTER STOPS Order! (step 104). Then, the Physician decides whether to Reduce the dose (step 106). If Yes, then order moves forward. If No, then Physician calls Pharmacist (step 108) to determine whether Reason satisfies Pharmacist (step 110). If Yes, Pharmacist enters a verbal or telephone order in Sunrise Clinical Manager documents and discussion and reason in GE (step 112) and Pharmacist accepts verbal/telephone order to override in GE Centricity Pharmacy system and documents discussion and reason (step 114). Then, the Attending Physician signs verbal/telephone order (before Pharmacy dispenses order) (step 116) and then Proceed with Order and Dispense (step 198).

If the ordered dose is determined not to be greater than the hard stop (i.e. No) (step 102), then it is determined whether the dose is greater than or less than the pre-approved range (step 118). If No, then proceed with Order, Dispense and Administer (step 120) and then the Notification to Alerts are Reviewed by Pharmacy/IT/Quality Control (step 122). If approved (Yes), then Proceed with Order and Dispense (step 198).

If the ordered dose is greater than or less than the pre-approved range (i.e. Yes) (step 118), then it is determined whether there was an alert in the last 48 hour time period (same doctor, same drug) (step 124). If Yes, the Alert is suppressed (step 126). If No, then Physician decides whether to change the dose (step 128). If Yes, then the Notification to Alerts is Reviewed by the Pharmacy/IT/Quality Control (step 122), and if approved (i.e. Yes) then Proceed with Order and Dispense (step 198). If No, then the Physician Acknowledges with Reason (step 130).

The pharmacist decides whether Reason satisfies Pharmacist (stop 132). If Yes, then Proceed with Order and Dispense. If No, then Physician and Pharmacist hold discussion, or obtain second doctor approval (step 134) and then there is a Physician verification process and/or configuration of MLM (step 136).

It is then determined whether there is an Agreement to proceed (step 138). If No, then there is a Head of Pharmacy and Head of Clinical section discussion (step 140). It is then determined whether there is an Agreement to then proceed (step 142). If Yes, the Pharmacist documents discussion and recommendations (step 144) and Proceed with Order and Dispense (step 198). If No, then the decision is made by a Physician with final authority (step 146), and then either Pharmacist Documents provide discussions and recommendations (step 144) and then Proceed with Order and Dispense (step 198), or order goes directly from (step 146) to (step 198).

If there is an Agreement to proceed (i.e. Yes) in (step 138), then the order proceeds through (step 144) and (step 198).

### EXAMPLES

### Example I

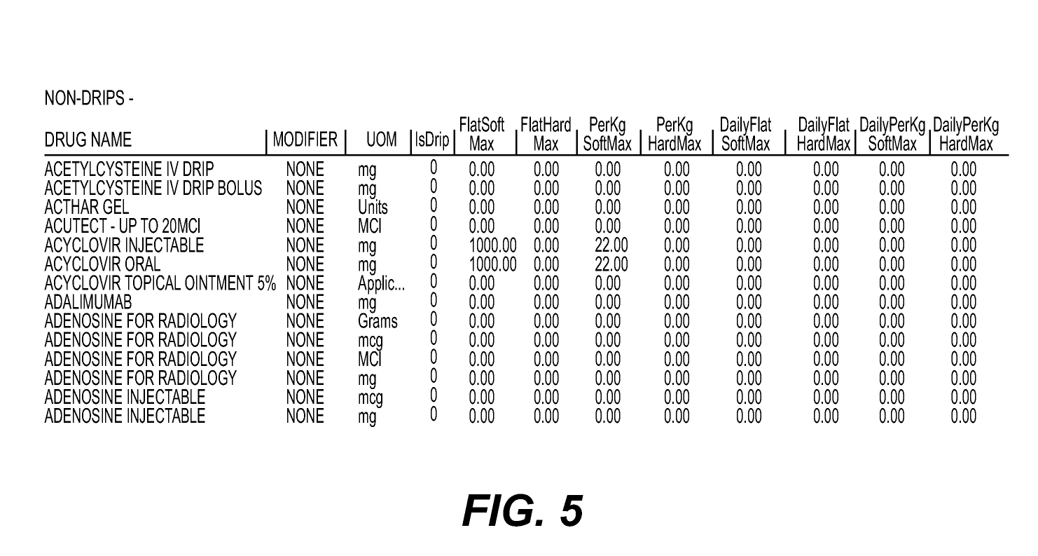

A prescription Dose Range Checking table (DRC table) for drugs in “Non-drips,” i.e., non-parenteral dosage forms, format, is shown in FIG. 5. The dose can be in DosePerKg=Enter Dose/Patient Weight, or can be in FlatDose=Entered Dose.

The prescription dose table, includes rows for each drug, and column headings, including

1) drug names (DrugName);

2) any modifier(s) (Modifier);

3) unit of measurement (UOM);

4) whether the drug is in drip format (IsDrip);

5) soft maximum flat dose (FlatSoftMax);

6) hard maximum flat dose (FlatHardMax);

7) dose per kilogram soft maximum dose (PerKgSoftMax);

8) dose per kilogram hard maximum dose (PerKgHardMax);

9) daily flat dose soft maximum dose (DailyFlatSoftMax);

10) daily flat dose hard maximum dose (DailyFlatHardMax);

11) daily dose per kilogram soft maximum dose (DailyPerKgSoftMax); and

12) daily dose per kilogram hard maximum dose (DailyPerKgHardMax).

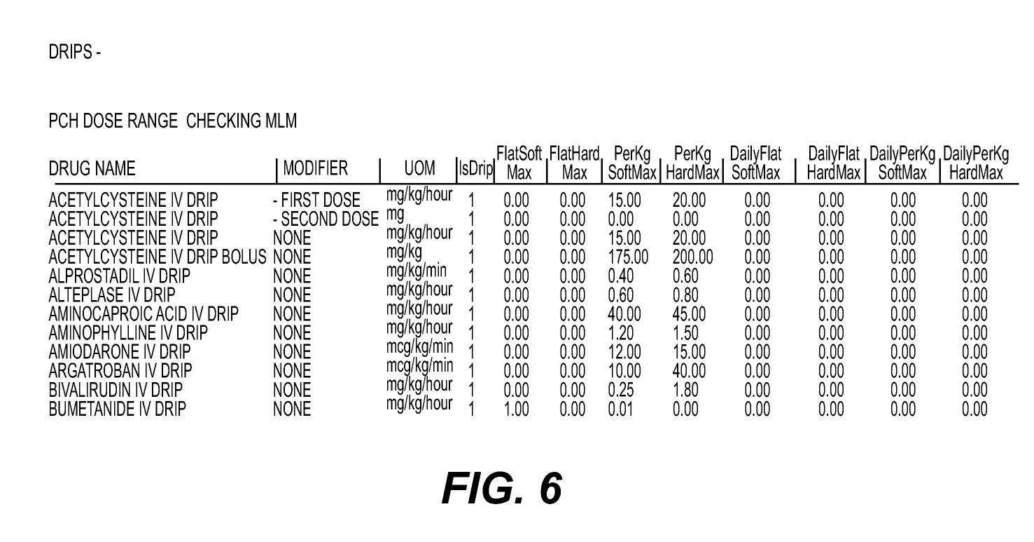

A prescription dose range checking table (DRC table) for drugs in “Drip,” i.e., parenteral dosage forms, format, is shown in FIG. 6. The dose can be in DosePerKg=Entered Dose, or can be in FlatDose=Entered Dose*PatientWeight.

The prescription dose table, includes rows for each drug, and column headings, including

1) drug names (DrugName);

2) any modifier(s) (Modifier);

3) unit of measurement (UOM);

4) whether the drug is in drip format (IsDrip);

5) flat soft maximum dose (FlatSoftMax);

6) flat hard maximum dose (FlatHardMax);

7) per kilogram soft maximum dose (PerKgSoftMax);

8) per kilogram hard maximum dose (PerKgHardMax);

9) daily flat soft maximum dose (DailyFlatSoftMax);

10) daily flat hard maximum dose (DailyFlatHardMax);

11) daily per kilogram soft maximum dose (DailyPerKgSoftMax); and

12) daily per kilogram hard maximum dose (DailyPerKgHardMax).

The dose range checking includes alert trigger on OrderEnter and OrderModify events which occur after entering/modifying order information and clicking the OK button. The alert must be acknowledged before proceeding when soft max limits are exceeded and it hard stops on exceeding hard max limits.

If the order is entered by a pharmacist AND the order is a verbal order from a physician, then do not hard stop, and provide a soft stop alert. Pharmacists will see the alert only when the order is entered in SCM and not in GE. If the Order role is in (“Pharmacist”, “Chemo Pharmacist”) then the user is considered as pharmacist. Check only soft stop limits for nurses and other non Licensed Independent Practitioner (LIP), and if that exceeds then they should be hard stopped.

If Order role is in (“Attending MD”, “Chemo Physician”), “Nurse Practitioner”, “Physician”, “Resident”, “Physician Assistant”) then the user is considered as a Licensed Independent PRACTITIONER (LLP) else non-LIP.

Do not alert for certain drugs for chemo physicians (i.e. the user is a chemo physician, or if the care provider discipline is Oncology and type is—(“Physician”, “Nurse Practitioner”, “Resident”).

The logic for checking whether the dose set forth in a prescription is suitable is based on whether the maximum dose exceeds in the following priority. Even if multiple conditions are met, the first condition met will only be reported.

1. PerKgDose exceeds PerKgHardMax;

2. FlatDose exceeds FlatHardMax;

3) PerKgDose exceeds PerKgSoftMax; and

4) FlatDose exceeds FlatSoftMax.

A Pharmacy Consult is automatically created when the Dose Range Checking (DRC) is alerted with a hard stop limit for a drug order in entered by a Pharmacist.

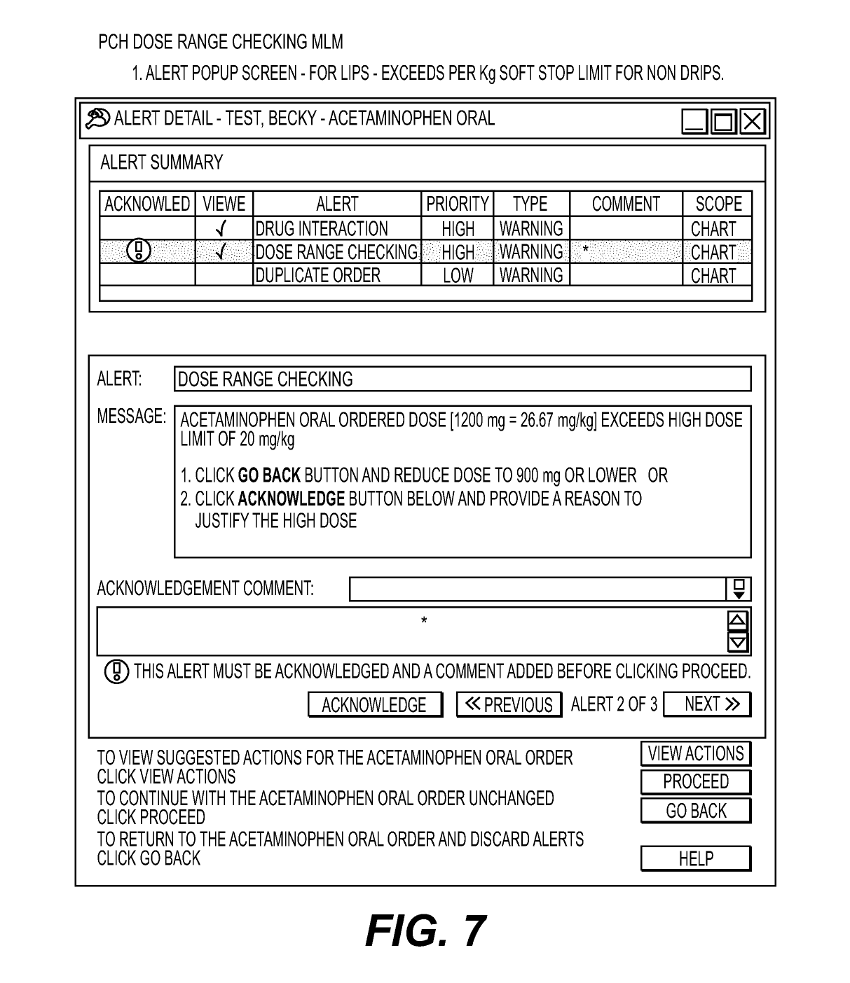

An alert popup screen—For LIPs—Exceeds Per Kg Soft Stop limit for non drips, is shown in FIG. 7.

The Alert Detail shows TEST, BECKY—Acetaminophen Oral, and the Alert Summary shows a warning for Drug Interaction as being HIGH, and a warning for the Dose Range Checking as being HIGH. The Alert for Dose Range Checking provides a Message that the Acetaminophen Oral ordered dose “exceeds high dose limit of 20 mg/kg. 1. Click the Go Back button and reduce the dose to 900 mg or lower, OR 2. Click the Acknowledge button and provide a reason to justify the high dose. If the user clicks the Acknowledge button and provides an Acknowledge Comment, then To continue with the Acetaminophen Oral order unchanged click Proceed, OR to return to the Acetaminophen Oral order and discard alerts click Go Back.

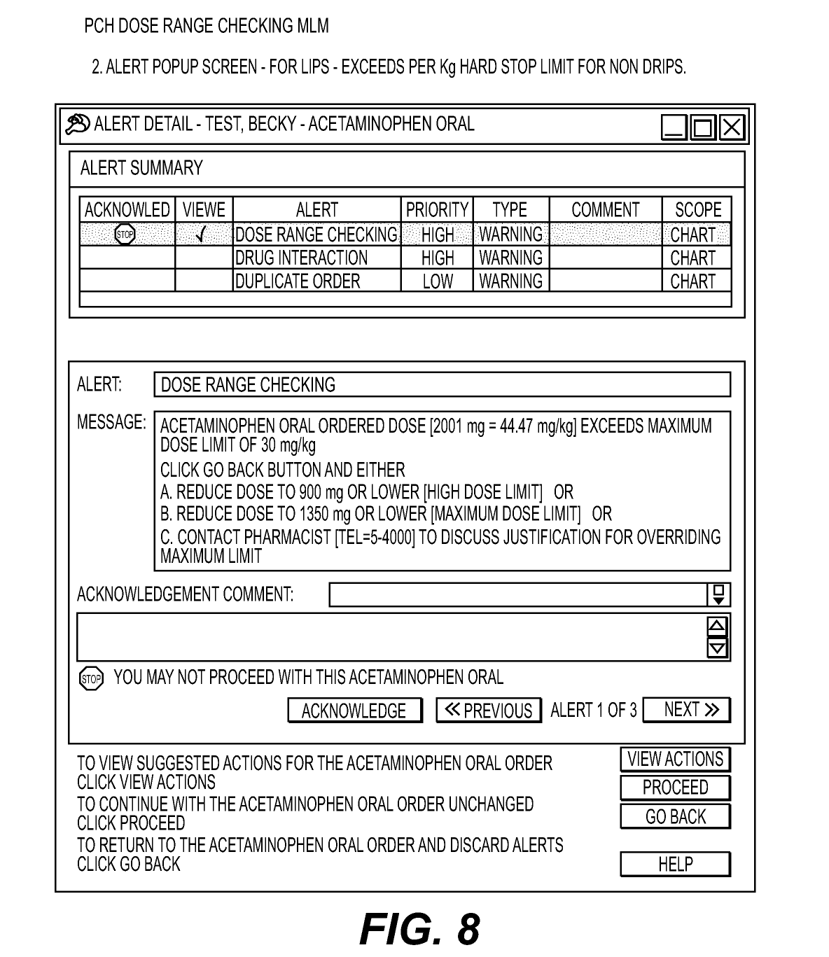

An alert popup screen for LIPs—Exceeds Per Kg Hard Stop limit for non drips, is shown in FIG. 8.

The Alert Detail shows TEST, BECKY—Acetaminophen Oral, and the Alert Summary shows a warning for the Dose Range Checking as being HIGH. The Alert for the Dose Range Checking provides the Message that the Acetaminophen Oral ordered dose (2001 mg=44.47 mg/hg) exceeds MAXIMUM dose limit of 30 mg/kg. Click Go Back button and either a. Reduce dose to 900 mg or lower (HIGH Dose limit), or b. Reduce dose to 1350 mg or lower (MAXIMUM Dose limit), or c. Contact Pharmacist (Tel=5-4000) to discuss justification for overriding maximum limit. The user is unable to click on the Acknowledge button, and receives a message STOP, You may not proceed with this Acetaminophen Oral.

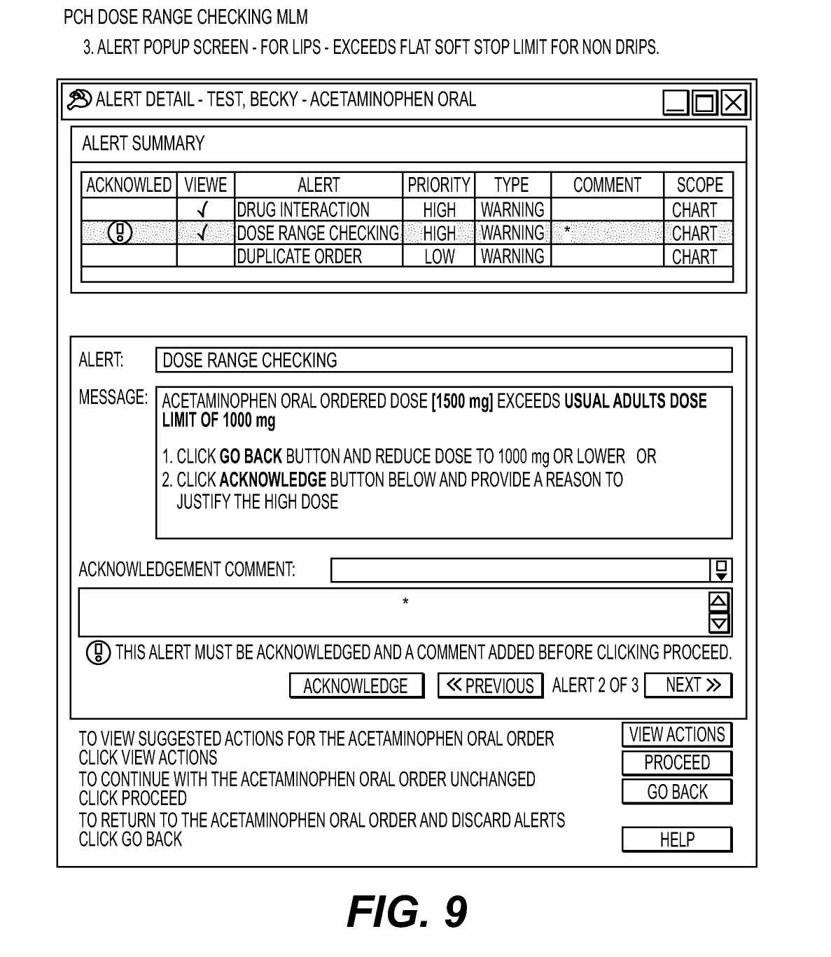

An alert popup screen—For LIPs—Exceeds Flat Soft Stop limit for non drips, is shown in FIG. 9.

The Alert Detail shows TEST, BECKY—Acetaminophen Oral, and the Alert Summary shows a warning for Drug Interaction being HIGH, and the Dose Range Checking as being HIGH. The Alert for the Dose Range Checking provides the Message that the Acetaminophen Oral ordered dose (1500 mg) exceeds usual adult dose limit of 1000 mg. 1. Click Go Back button and reduce dose to 1000 mg or lower, OR 2. Click Acknowledge button below and provide a reason to justify the high dose. If the user clicks the Acknowledge button and provides an Acknowledge Comment, then To continue with the Acetaminophen Oral order unchanged click Proceed, OR to return to the Acetaminophen Oral order and discard alerts click Go Back.

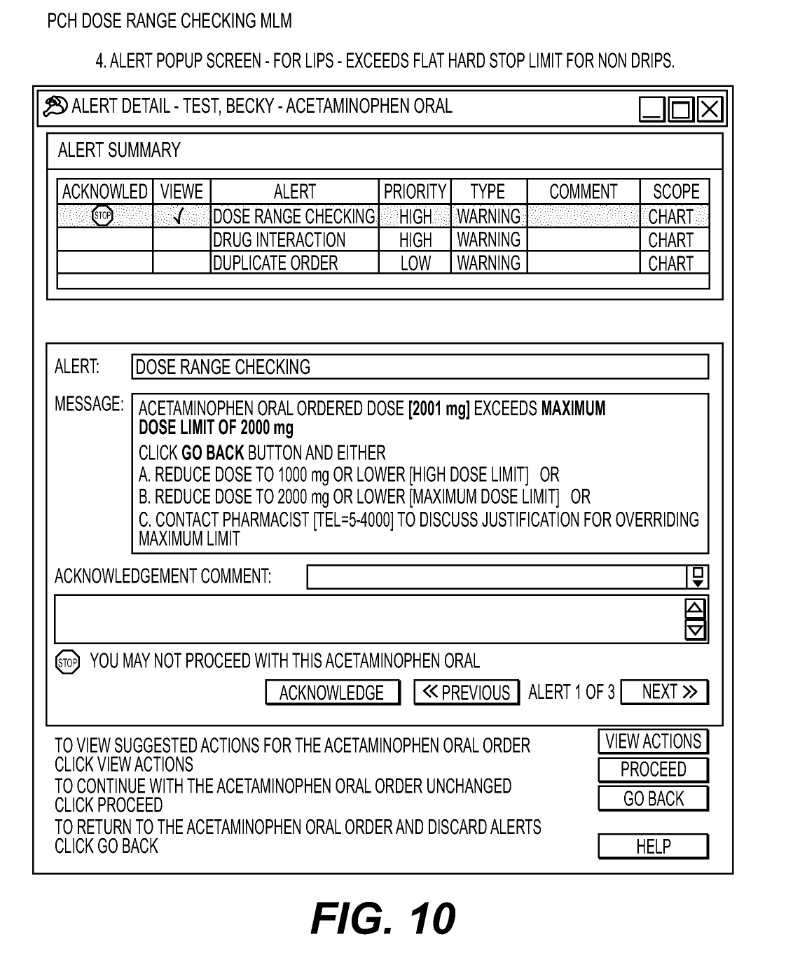

An alert popup screen—For LIPs—Exceeds Flat Soft Stop limit for non drips, is shown in FIG. 10.

The Alert Detail shows TEST, BECKY—Acetaminophen Oral, and the Alert Summary shows a warning for the Dose Range Checking as being HIGH. The Alert for the Dose Range Checking provides the Message that the Acetaminophen Oral ordered dose (2001 mg) exceeds MAXIMUM dose limit of 2000 mg. Click Go Back button and either a. Reduce dose to 100 mg or lower (HIGH Dose limit) or b. Reduce dose to 2000 mg or lower (MAXIMUM Dose limit), or Contact Pharmacist (Tel=5-4000) to discuss justification for overriding maximum limit. The user is unable to click on the Acknowledge button, and receives a message STOP, You may not proceed with this Acetaminophen Oral.

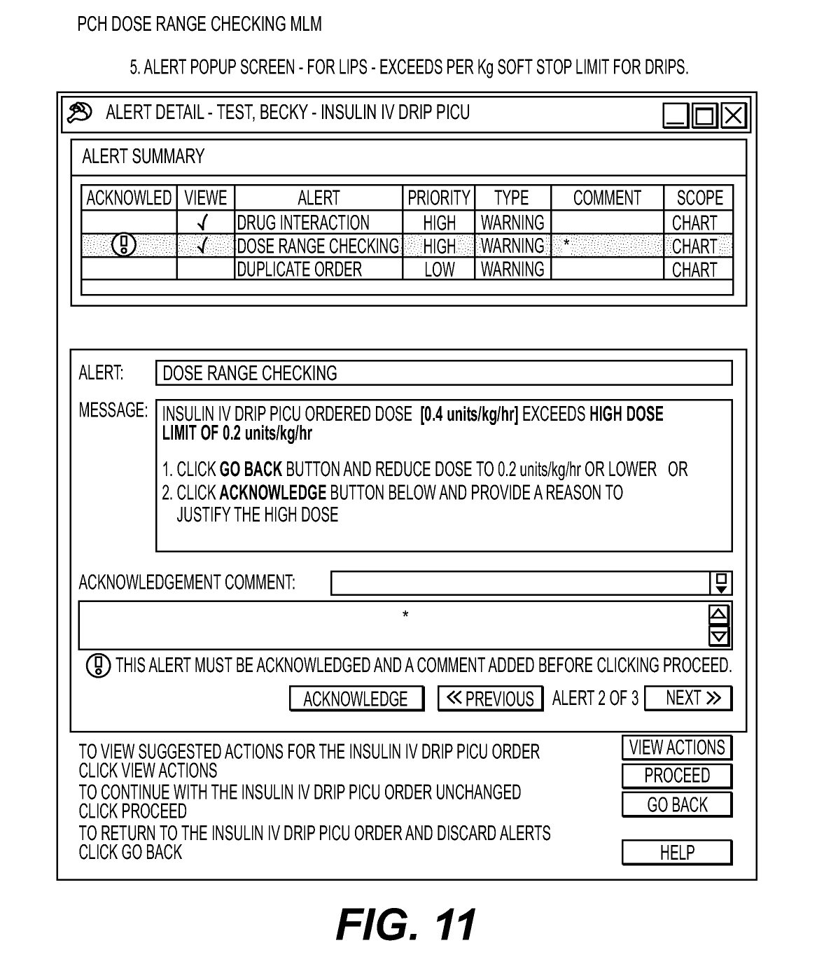

An alert popup screen—For LIPs—Exceeds Flat Soft Stop limit for non drips, is shown in FIG. 11.

The Alert Detail shows TEST, BECKY—Insulin IV Drip PICU, and the Alert Summary shows a warning for Drug Interaction being HIGH, and the Dose Range Checking as being HIGH. The Alert for the Dose Range Checking provides the Message that the Insulin IV Drip PICU ordered dose (0.4 units/kg/hr) exceeds high dose limit of 0.2 units/kg/hr. 1. Click Go Back button and reduce dose to 0.2 units/kg/hr or lower, OR 2. Click Acknowledge button below and provide a reason to justify the high dose. If the user clicks the Acknowledge button and provides an Acknowledge Comment, then To continue with the Insulin IV PICU order unchanged click Proceed, OR To return to the Insulin IV Drip PICU order and discard alerts click Go Back.

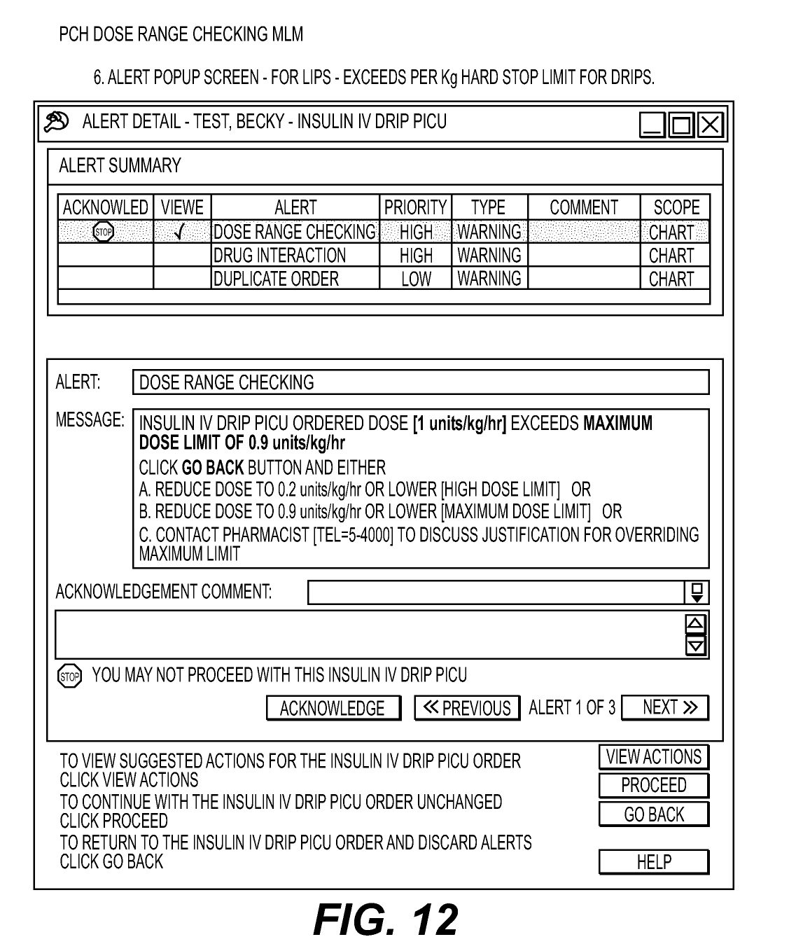

An alert popup screen—For LIPs—Exceeds Per Kg Hard Stop limit for drips, is shown in FIG. 12.

The Alert Detail shows TEST, BECKY—Insulin IV Drip PICU, and the Alert Summary shows a warning for Dose Range Checking as being HIGH. The Alert for the Dose Range Checking provides the Message that the Insulin IV Drip PICU ordered dose (1 units/kg/hr) exceeds MAXIMUM dose limit of 0.9 units/kg/hr. Click Go Back button and either a. Reduce dose to 0.2 units/kg/hr or lower (HIGH Dose limit, or b. Reduce dose to 0.9 units/kg/hr or lower (MAXIMUM Dose limit), or c. Contact Pharmacist (Tel=5-4000) to discuss justification for overriding maximum limit. The user is unable to click on the Acknowledge button, and receives a message STOP, You may not proceed with this Insulin IV Drip PICU.

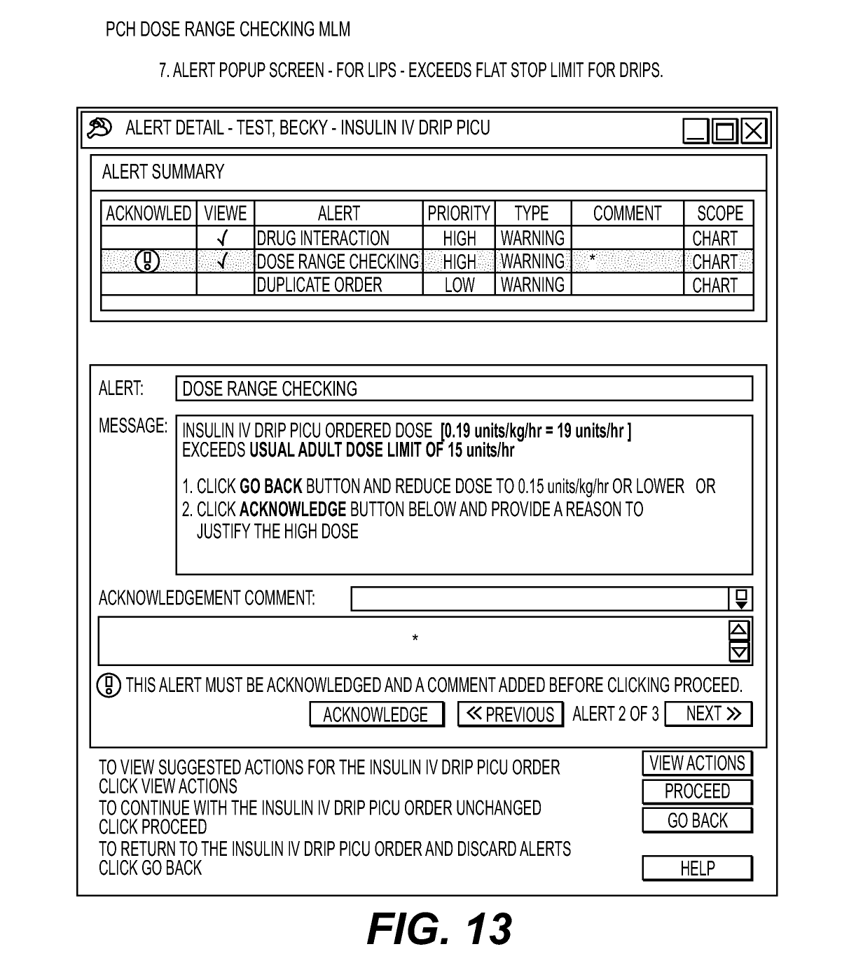

An alert popup screen—For LIPs—Exceeds Flat Soft Stop limit for drips, is shown in FIG. 13.

The Alert Detail shows TEST, BECKY—Insulin IV Drip PICU, and the Alert Summary shows a warning for Drug Interaction being HIGH, and the Dose Range Checking as being HIGH. The Alert for the Dose Range Checking provides the Message that the Insulin IV Drip PICU ordered dose (0.19 units/kg/hr=19 units/hr) exceeds usual adult dose limit of 15 units/hr. 1. Click Go Back button and reduce dose to 0.15 units/kg/hr or lower, OR 2. Click Acknowledge button below and provide a reason to justify the high dose. If the user clicks the Acknowledge button and provides an Acknowledge Comment, then To continue with the Insulin IV PICU order unchanged click Proceed, or To return to the Insulin IV Drip PICU order and discard alerts click Go Back.

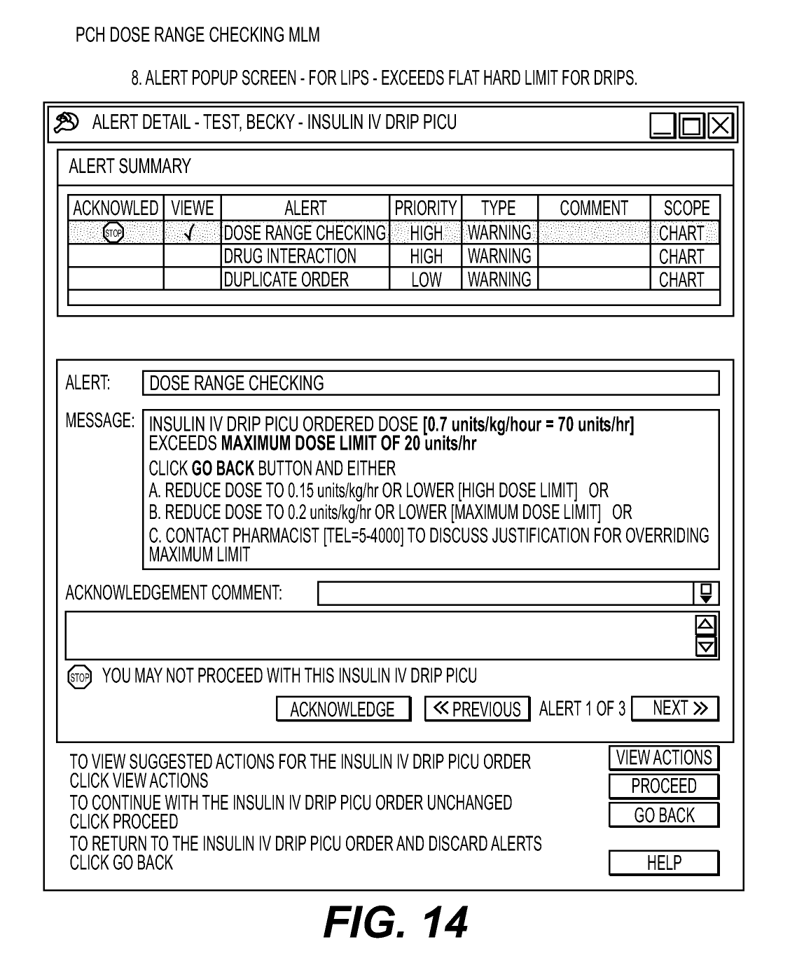

An alert popup screen—For LIPs—Exceeds Flat Hard limit for drips, is shown in FIG. 14.

The Alert Detail shows TEST, BECKY—Insulin IV Drip PICU, and the Alert Summary shows a warning for Dose Range Checking as being HIGH. The Alert for the Dose Range Checking provides the message that the Insulin IV Drip PICU ordered dose (0.7 units/hr) exceeds MAXIMUM dose limit of 20 units/hr. Click Go Back button and either a. Reduce dose to 0.15 units/kg/hr or lower (HIGH Dose limit, or b. Reduce dose to 0.2 units/kg/hr or lower (MAXIMUM Dose limit), or c. Contact Pharmacist (Tel=5-4000) to discuss justification for overriding maximum limit. The user is unable to click on the Acknowledge button, and receives a message STOP, You may not proceed with this Insulin IV Drip PICU.

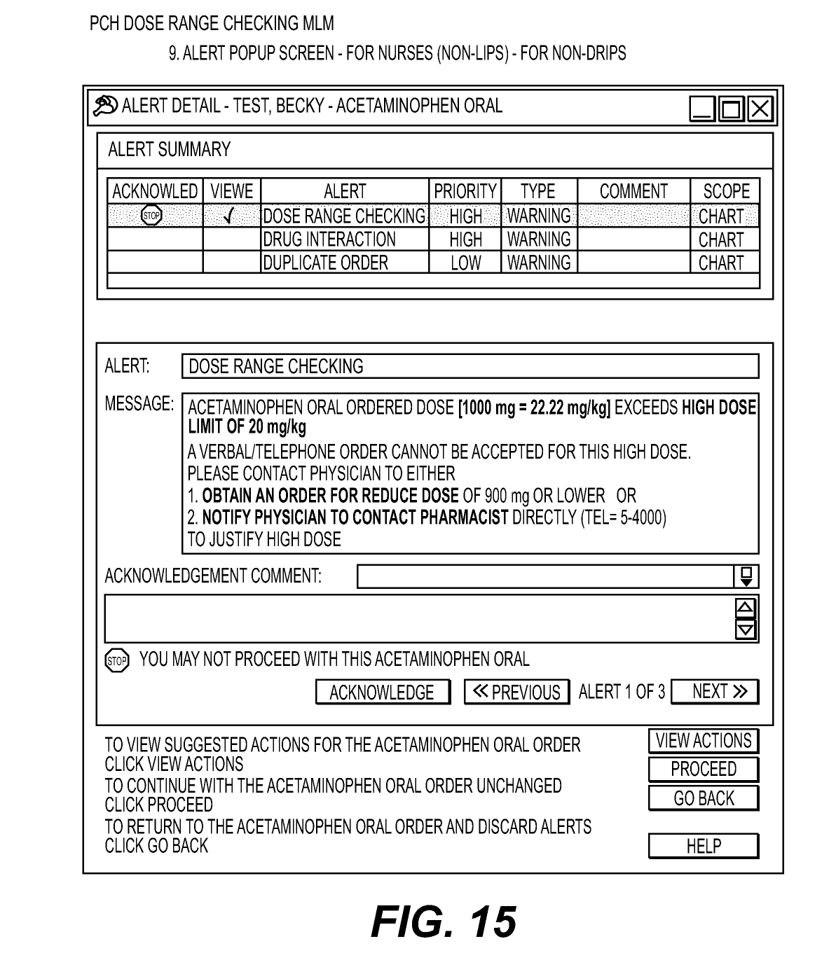

An alert popup screen—For nurses (non-LIPs)—for non-drips, is shown in FIG. 15.

The Alert Detail shows TEST, BECKY—Acetaminophen Oral, and the Alert Summary shows a warning for Dose Range Checking as being HIGH. The Alert for the Dose Range Checking provides a message that the Acetaminophen Oral ordered dose (1000 mg=22.22 mg/kg) exceeds high dose limit of 20 mg/kg. A Verbal/Telephone order cannot be accepted for this high dose. Please contact physician to either 1. Obtain an order for reduced dose of 900 mg or lower, OR 2. Notify physician to contact Pharmacist directly (Tel=5-4000) to justify high dose. The user is unable to click on the Acknowledge button, and receives a message STOP, You may not proceed with this Acetaminophen Oral.

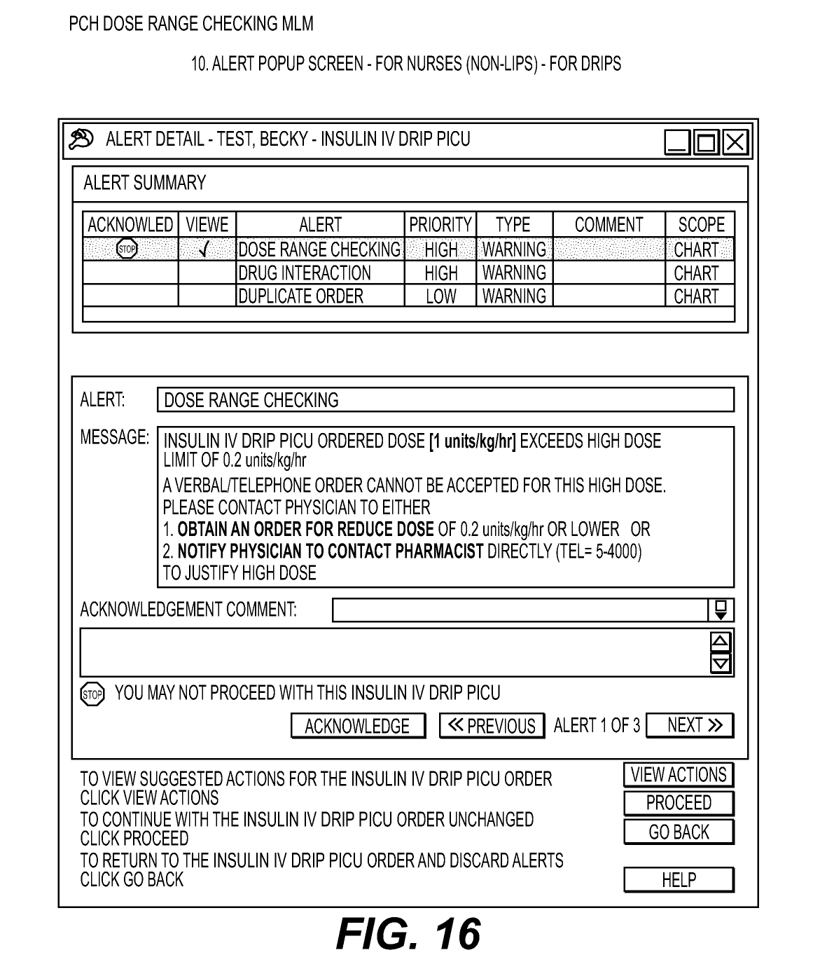

An alert popup screen—For nurses (non-LIPs)—for drips, is shown in FIG. 16.

The Alert Detail shows TEST, BECKY—Insulin IV Drip PICU, and the Alert Summary shows a warning for Dose Range Checking as being HIGH. The Alert for the Dose Range Checking provides a message that the Insulin IV Drip ordered dose (1 units/kg/hr) exceeds high dose limit of 0.2 units/kg/hr. A Verbal/Telephone order cannot be accepted for this high dose. Please contact physician to either 1. Obtain an order for reduced dose of 0.2 units/kg/hr or lower, OR 2. Notify physician to contact Pharmacist directly (Tel=5-4000) to justify high dose. The user is unable to click on the Acknowledge button, and receives a message STOP, You may not proceed with this Acetaminophen Oral.

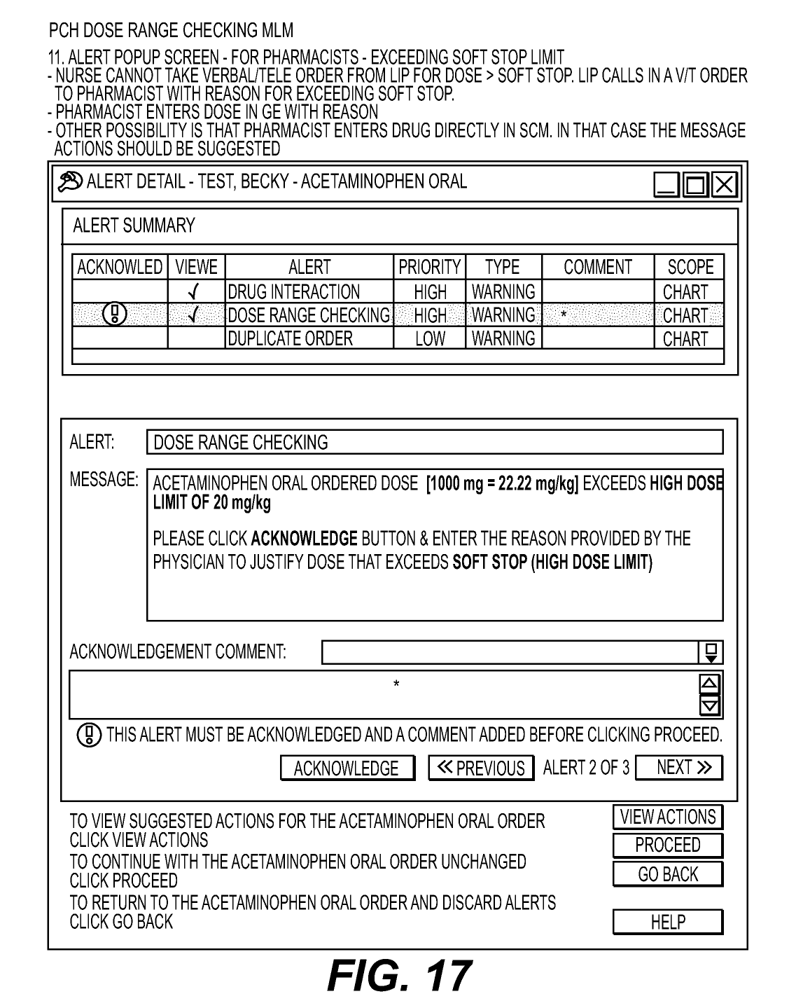

An alert popup screen—for Pharmacists—exceeding soft stop limit, is shown in FIG. 17.

The Alert Detail shows TEST, BECKY—Acetaminophen Oral, and the Alert Summary shows a warning for Drug Interaction being HIGH, and the Dose Range Checking as being HIGH. The Alert for the Dose Range Checking provides the Message that the Acetaminophen Oral ordered dose (1000 mg=22.22 mg/kg) exceeds high dose limit of 20 mg/kg. Please click Acknowledge button & enter reason provided to justify dose that exceeds SOFT STOP (HIGH Dose Limit). If the user clicks the Acknowledge button and provides an Acknowledge Comment, then To continue with the Acetaminophen order unchanged click Proceed, or To return to the Acetaminophen order and discard alerts click Go Back.

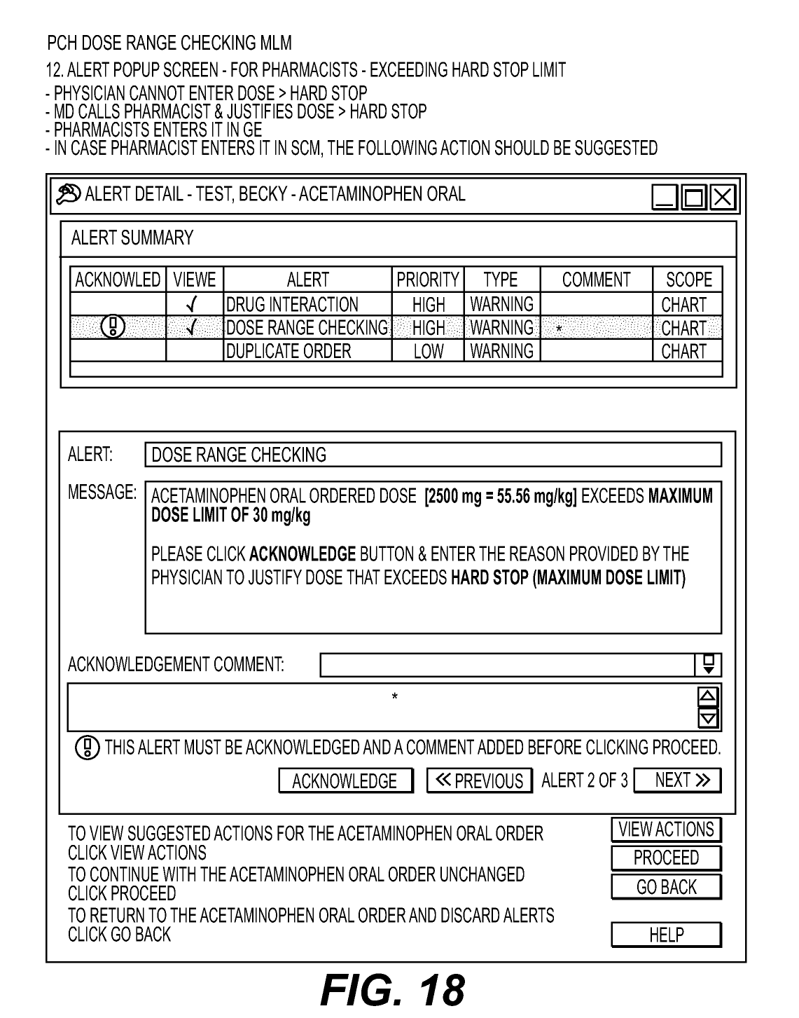

An alert popup screen—for Pharmacists—exceeding hard stop limit, is shown in FIG. 18.

The Alert Detail shows TEST, BECKY—Acetaminophen Oral, and the Alert Summary shows a warning for Drug Interaction being HIGH, and the Dose Range Checking as being HIGH. The Alert for the Dose Range Checking provides the Message that the Acetaminophen Oral ordered dose (2500 mg=55.56 mg/kg) exceeds MAXIMUM dose limit of 30 mg/kg. Please click Acknowledge button & enter reason provided by the physician to justify dose that exceeds HARD STOP (Maximum Dose Limit). If the user clicks the Acknowledge button and provides an Acknowledge Comment, then To continue with the Acetaminophen order unchanged click Proceed, or To return to the Acetaminophen order and discard alerts click Go Back.

### Example II

### Pediatric Dose Range Checking

A. Analysis

The frequency of drugs ordered since 2002 at Phoenix Children's Hospital was analyzed, which yielded close to 750,000 orders. Then the 100 most ordered drugs were targeted, as well as the most high-risk drugs. This pre-analysis of ordering habits, rather than taking a different formulary approach (i.e., alphabetically), enhanced the breadth of coverage in phase one.

To create drug alerts within the CPOE system, configuration was separated from the programming logic by creating a separate electronic drug reference table. See page 25 Drug-by-drug configuration was removed, and for about 1,100 drugs one single custom code was created that looks up all the drugs. The custom code identifies the ordered drug and evaluates the order to see if it falls within the dosing ranges in the reference table. If the order does not fit within the ranges, the system will generate a soft stop alert; or if the dose was so high, it will initiate a hard stop. Nuisance alerts are not generated. The clinical team realized that the alerting configuration had to be sensitive and strike the right balance, so that alerts would not be seen as nuisances. When a physician is about to be alerted in real-time, the level at which they are alerted must be carefully determined in order to avoid nuisance alerts.

Accordingly, an “alarmingly high” dose strategy was implemented that allowed the determination of a point at which to alert a physician, which is very different than alerts at the normal dosing range. Because the Phoenix Children's Hospital clinical team had access to dosing patterns, it could set appropriate limits to correspond with these patterns.

The clinical team devised a two-tiered system of alerts to target the physician at the point of order entry. If the physician orders a drug that exceeds a soft stop limit, a hard stop alert is provided with instructions on how to resolve the problem, along with normal dose ranges for reference where normal dose ranges are obtained from pharmacy reference books.

B. Dose Range Checking Go-Live:

In more than 50 percent of the cases at Phoenix Children's, alerts have resulted in the physician either cancelling or correcting the order. If a physician wants to proceed with an order, a reason must be provided. That reason is then sent to the pharmacy system through the interface so that the pharmacist doing the clinical verification can understand the physician's intent.

604 drugs-80 percent of ordered medications-were mapped in phase one and the new system went live. Queries were pre-set to analyze how frequently alerts were firing and what effect they were having. In the first month, Phoenix Children's had a 3-percent alerting rate for all orders, of which 2 percent were soft stops, which proved to be good balance for providers. The initiative has also resulted in an 80 percent reduction in follow-up phone calls from the pharmacists back to physicians, which at five minutes per call, represents a significant improvement in efficiency and a huge cost savings. Since go-live, there have been no prescription overdose errors.

### Example III

### Alert Data

Percentage of Medication Orders Resulting in an Alert & Percentage of Soft or Hard Alerts

As can be seen below, only 2.4% of orders resulted in an alert, minimizing alert fatigue

Of the orders that alerted, approximately ⅔ fell into abnormally high dose ranges. The remaining ⅓ of the orders that generated an alert had doses that were above the dangerously high dose mark. Without the Dose Range Checking program these doses would have been submitted and would have depended on the pharmacist to catch, evaluate, and contact the practitioner for evaluation/confirmation of the dose. The Dose Range Checking program stops the order and makes the practitioner evaluate the appropriateness of dose before sending it to the pharmacist.

Percentage of Alerts Resulted in a Dose Modification or Cancellation

The charts below show when the dose is in the Soft Stop (abnormally high dose) range, in 65% of the cases, practitioners reduced or cancelled the dose after receiving the alert. The practitioner overrode the alert and proceeded with the high dose order in 35% of the cases. When the dose is above the Hard Stop (dangerously high dose) limit, practitioners reduced or cancelled the dose in 75% of the cases.

### Computer Network/System

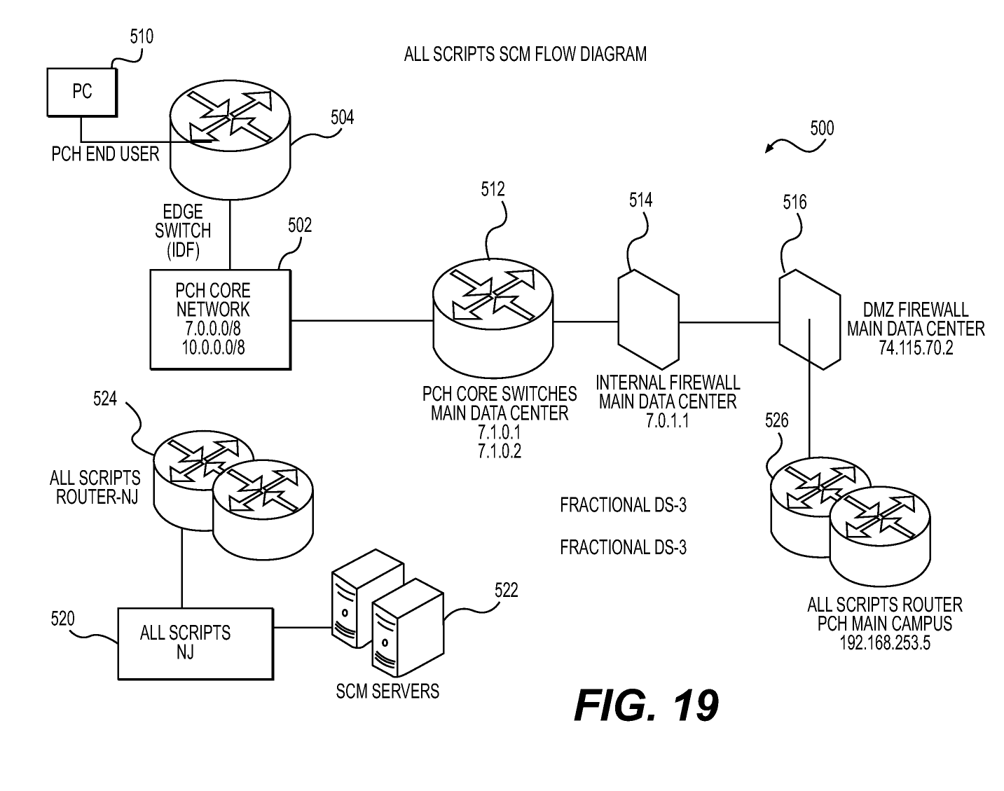

A schematic flow diagram of the hospital computer network 500, including the prescription dose checking system, is shown in FIG. 19.

The hospital core network 502 is connected through Edge Switch 504 to the End User 510 using a personal computer (PC), and connected to the Core Switches 512. An Internal Firewall 514 and a DMZ Firewall 516 are connected to the Core Switches 512 protecting the Core Network 502.

The All Scripts™ computer system 520, includes SCM Servers 522, All Scripts™ Router 524, and All Scripts™ Router 526.

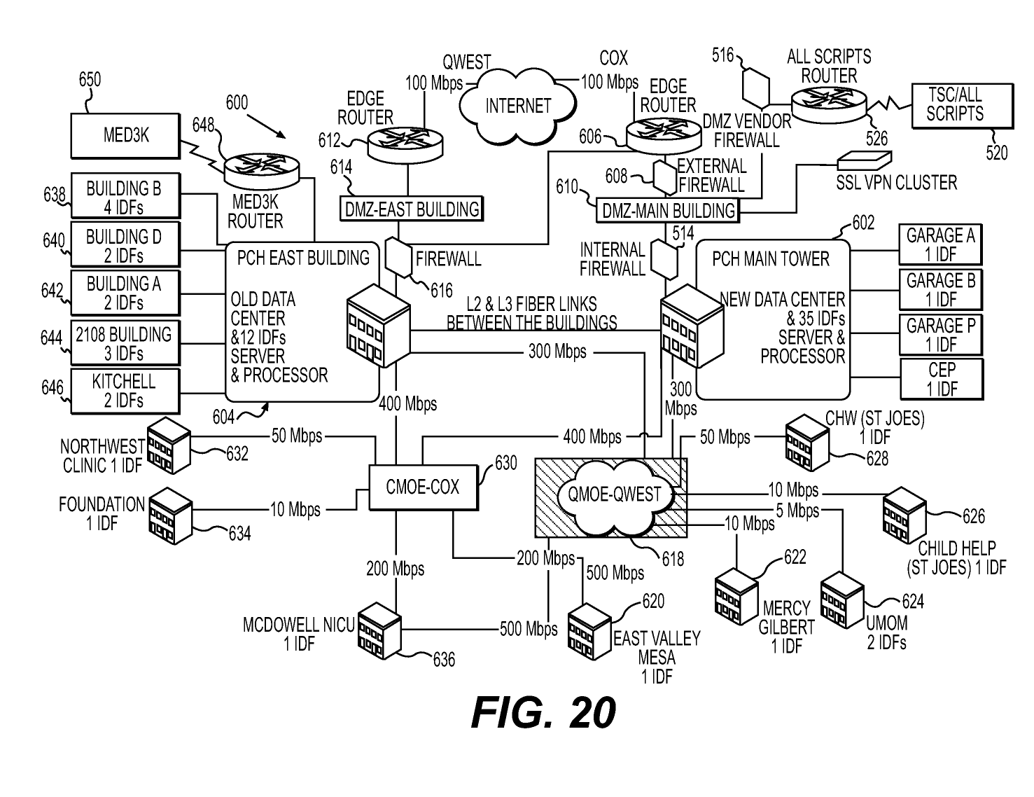

A schematic flow diagram of the overall hospital computer network 600, including the prescription dose checking system, is shown in FIG. 20.

The computer network, includes a New Data Center 602 and an Old Data Center 604 linked by fiber optics; however, only a single Data Center is required. The Internet 606 is connected to the New Data Center 602 through Edge Router 606, DMZ Main Building, and Internal Firewall 514. The Internet 606 is connected to the Old Data Center 604 through Edge Router 612, DMZ East Building, and Firewall 616.

The New Data Center 602 is connected to QMOE-QWEST 618, which in turn is connected to and networks the East Valley Mesa Building 620, Mercy Gilbert Building 622, UMOM Building 624, Child Help (St Joes) Building 626, and CHW Building (ST Joes) Building 628.

The Old Data Center 604 is connected to CMOE-COX 630, which in turn is connected to and networks the Northwest Clinic Building 632, Foundation Building 634, McDowell NICU Building 636 and the East Valley Mesa Building 620. The Old Data Center 604 is also connected to and networks Building B 638, Building D 640, Building A 642, 2108 Building 644, and Kitchell Building 646.

The Old Data Center 604 is connected through Med3K Router 648 to Med3K 650.

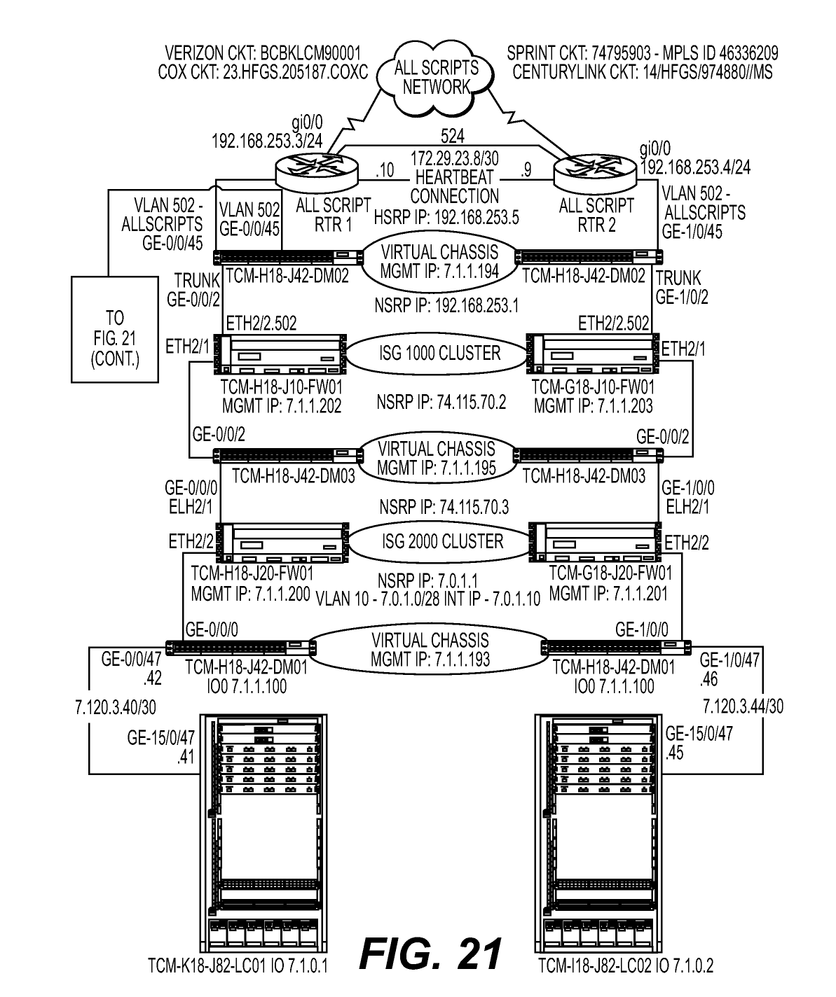

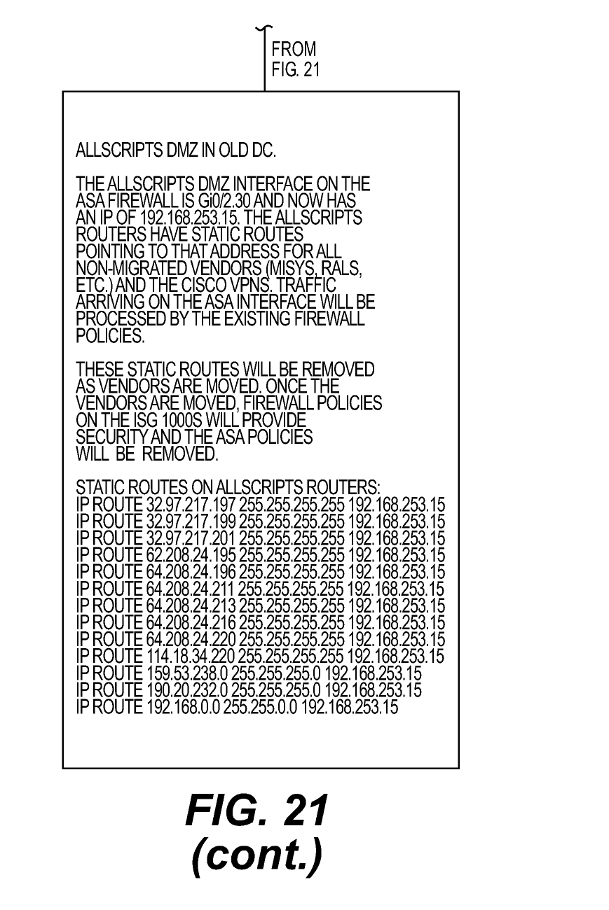

A schematic flow diagram of the hospital network with the AllScripts™ Network, is shown in FIG. 21.

### Hospital Example

### Pediatric Dose Range Checking (DRC)

### Phoenix Children's Hospital, Example #1

465 licensed beds free standing Children's Hospital, 626 beds when expansion complete
2011: Third largest children's hospital
More than 913 staff physicians, 258 employed
Employees: 3,056
The 40-bed Emergency Department includes a trauma bay, 25 acute rooms, and 13 fast track rooms during evening hours.
Level I Pediatric Trauma Center—ACS verified Trauma Center
143 licensed NICU beds
2010 Inpatient Admission Data: 12,530
2010 ED visits: 57,140

### DRC: Discussion Points

1. Problems & Challenges

2. Project Aims/Goals

3. DRC Solution

4. Step-by-Step Process

5. Results & Impact on Safety

6. Success Factors

7. Future Direction

### Dose Range Checking Importance

Validating APPROPRIATE dose electronically when orders are placed in CPOE
Alerting physicians even before order is transmitted to pharmacy computer system and manually reviewed by a staff pharmacist
Preventing dosing errors at the SOURCE before they propagate downstream
Wide pediatric weight ranges, weight-based and non-weight based dosing

### Pharmacy Integration Foundation

2002: Allscripts Sunrise Acute Care (SCM)
2002 to 2011: Only 70 of 1200 drugs (6%) had a DRC built into our CPOE system providing insufficient safety, leading to RCAs.
April, 2009: Implemented new pharmacy system (GE Centricity)
May 5, 2009: Hospital wide CPOE (except Chemo)
April, 2010: Implemented bi-directional pharmacy interface

### DRC Problems & Challenges

Two discrepant DRC systems in place, one in SCM, one in GE.
SCM DRC was limited and cumbersome to configure/maintain
GE DRC was more robust, but allowed orders to be submitted by providers.
SCM and GE DRC tables were out of sync due to different system parameters.
Dosing thresholds for excessive doses not defined in literature
Lack of commercially available, pediatric specific, plug-and-play DRC applications.
Recently available commercial application failed successful implementation at other sites.

### Before DRC

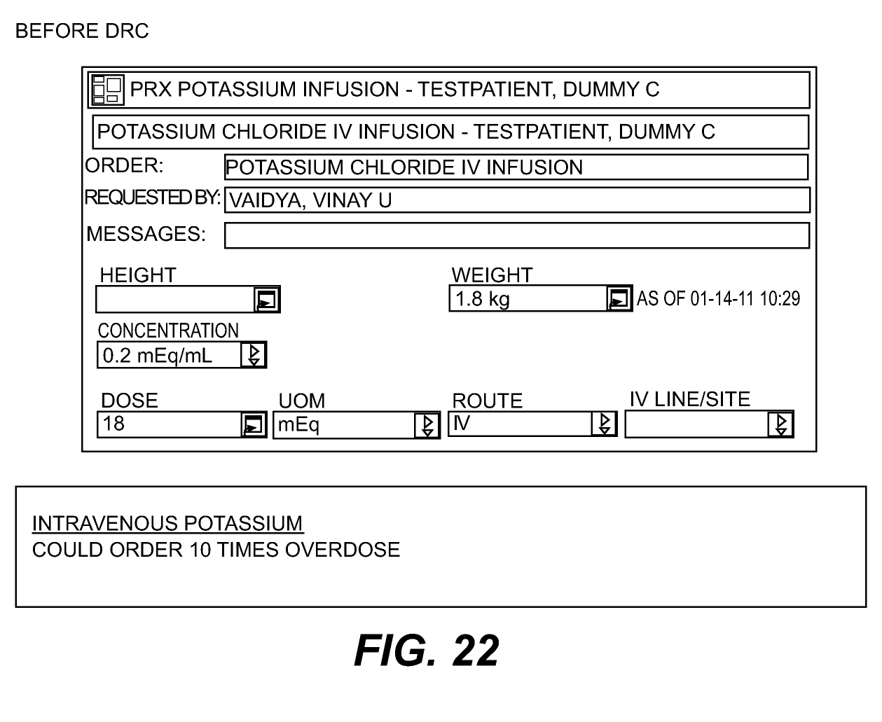

See FIG. 22.

### Project Aims & Goals

Develop rapid DRC solution
Phased approach. High risk, high frequency drugs first
Basic features first, stepwise enhancement later
Strive for ZERO prescribing errors (initial focus on overdose)

### Step by Step DEVELOPMENT PROCESS

Traditional Approach:

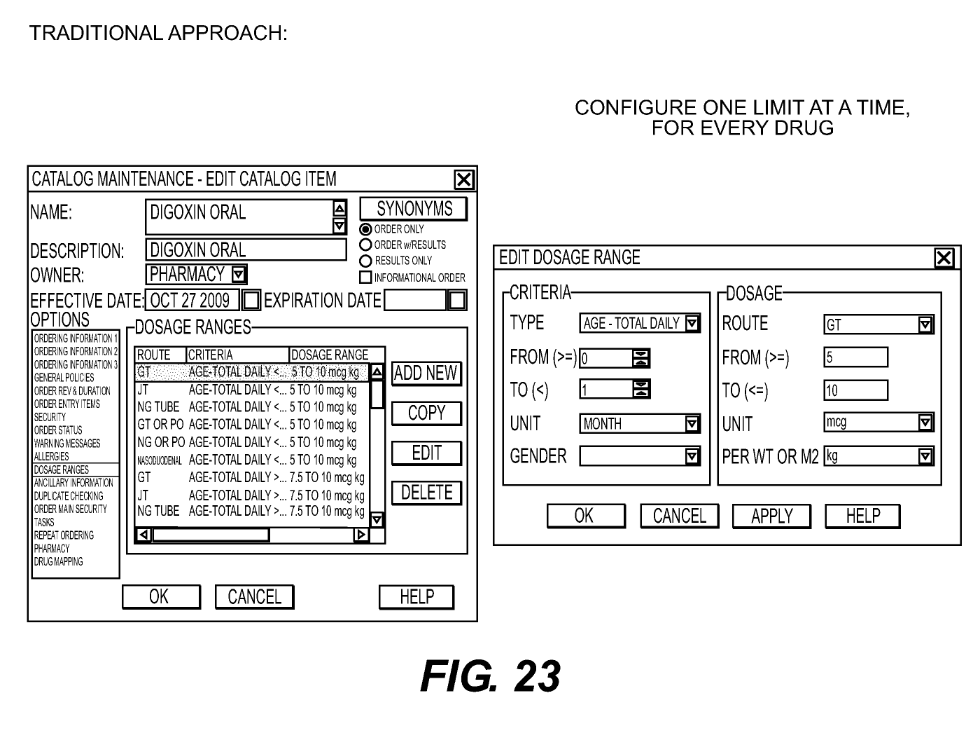

See FIG. 23.

Each limit=unique configuration
Manual entry=chances of error

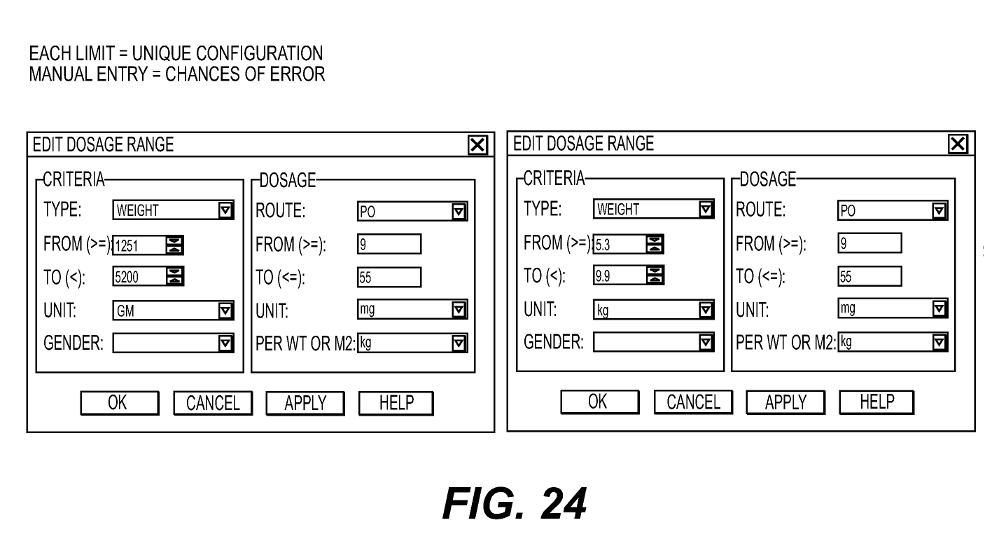

See FIG. 24.

### New Approach for Rapid DEVELOPMENT OF DRC

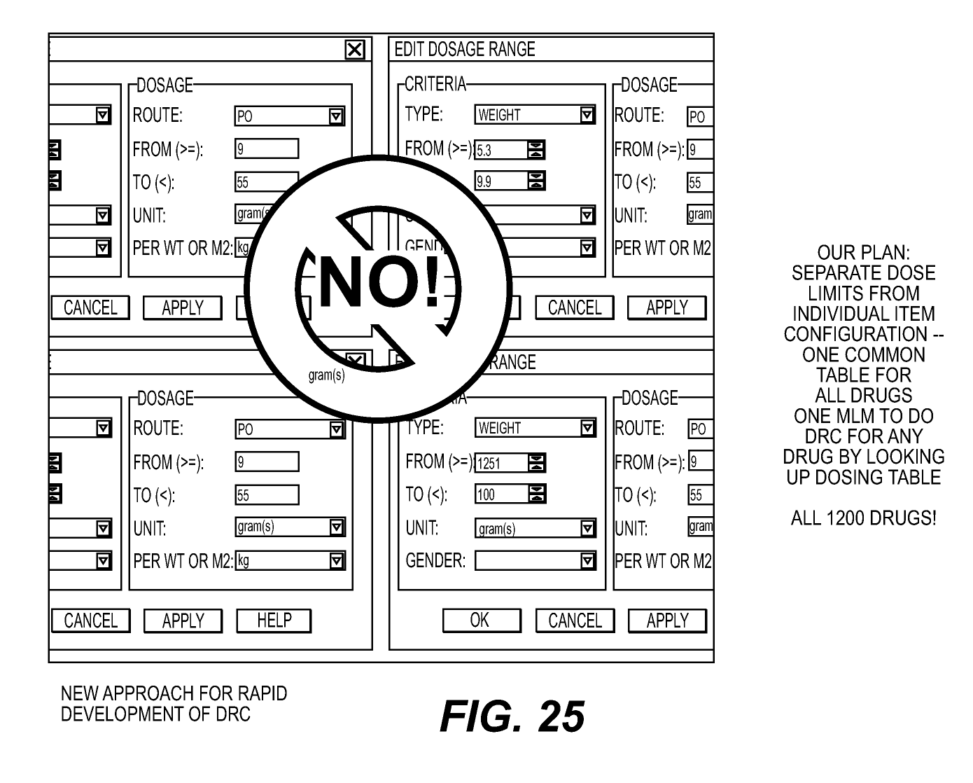

See FIG. 25.

### New Approach: Critical Step

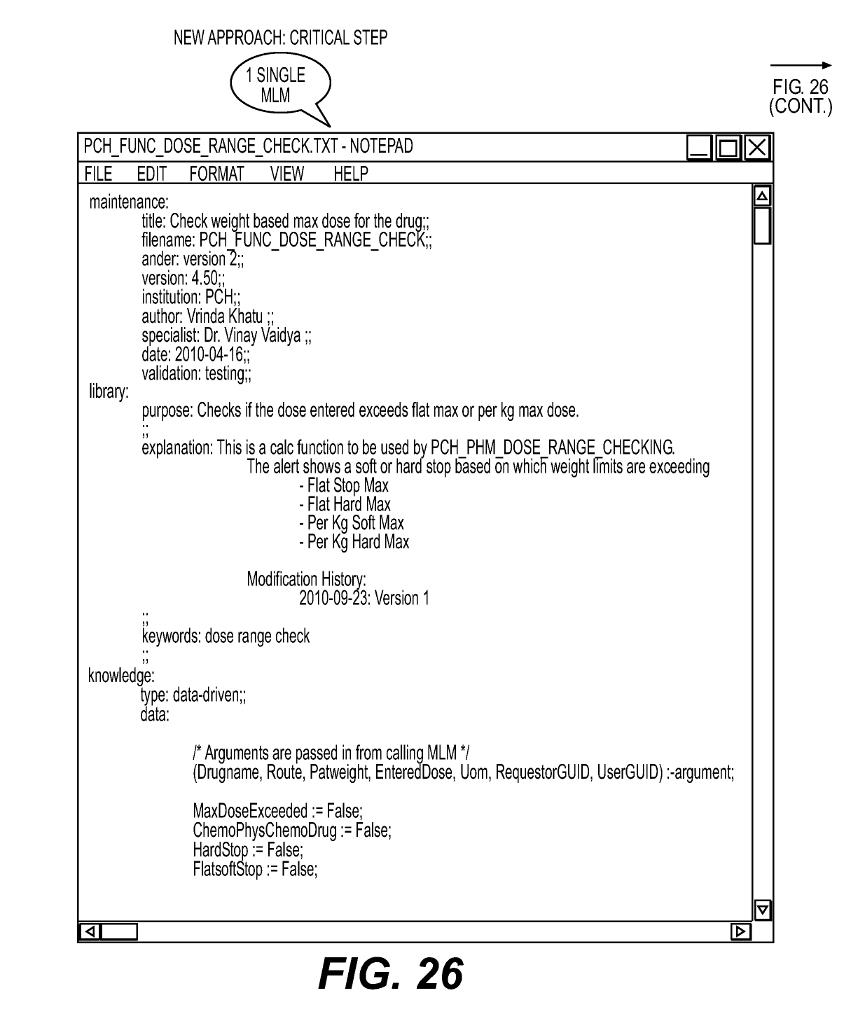

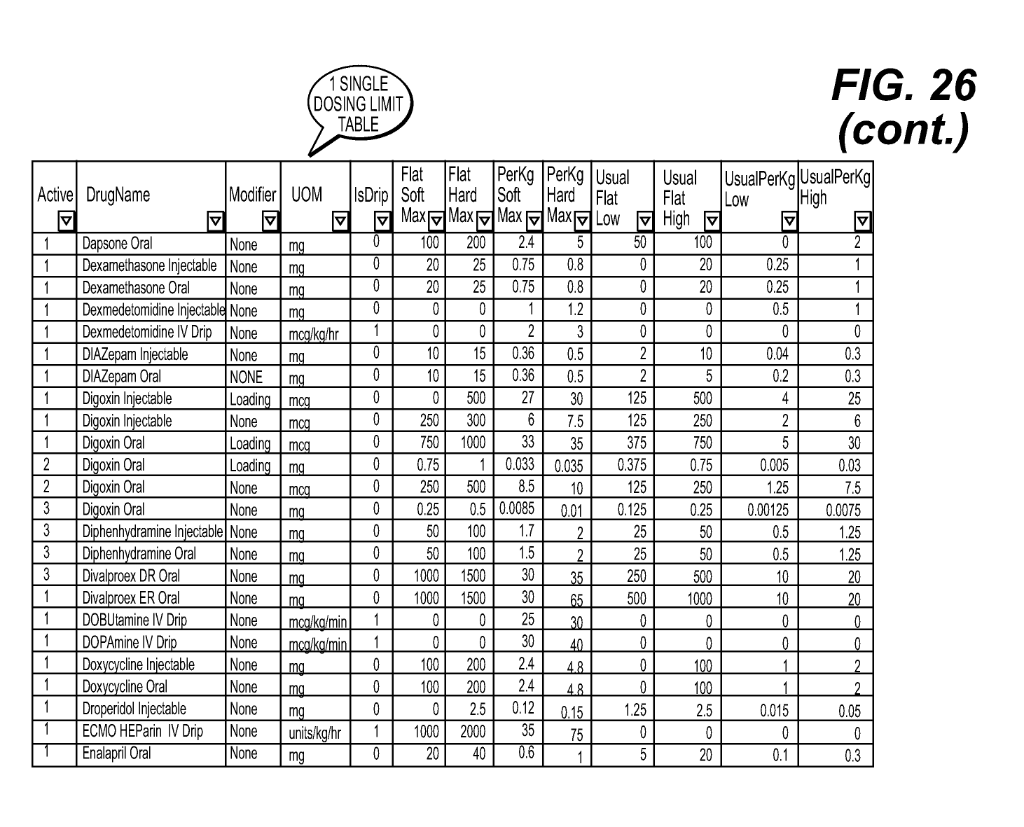

See FIG. 26.

### Analysis of Most Frequently Used Drugs

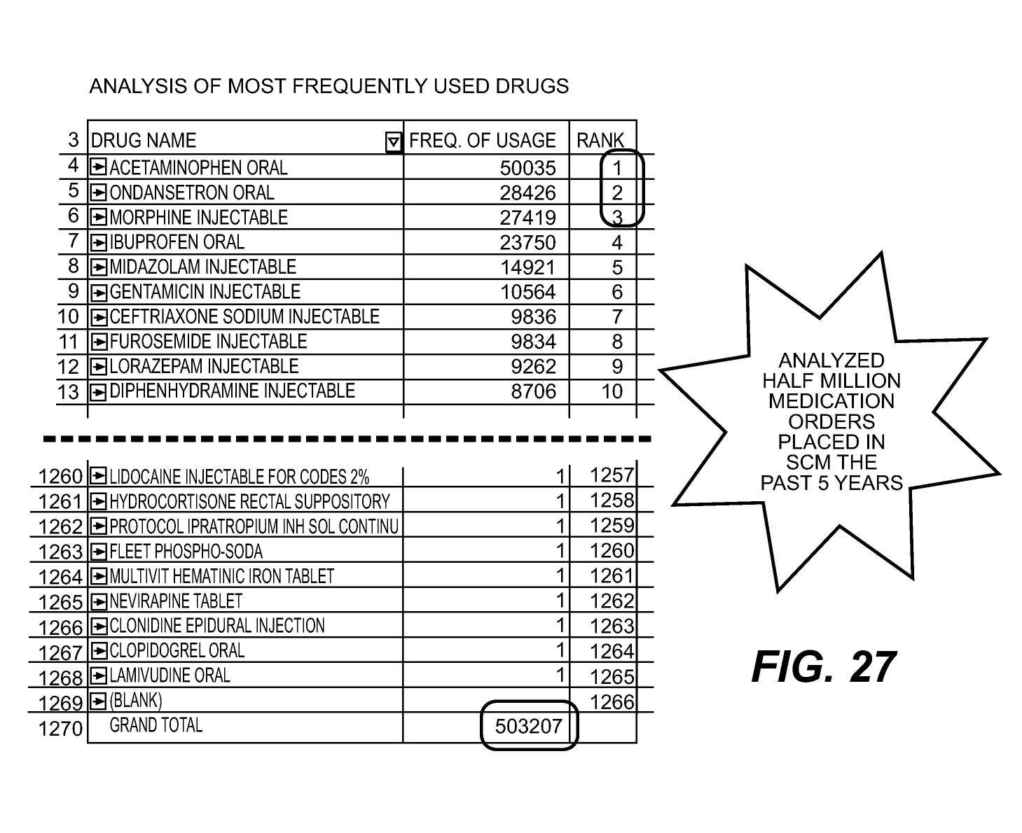

See FIG. 27.

### Basic Schematic Approach for DRC Limits

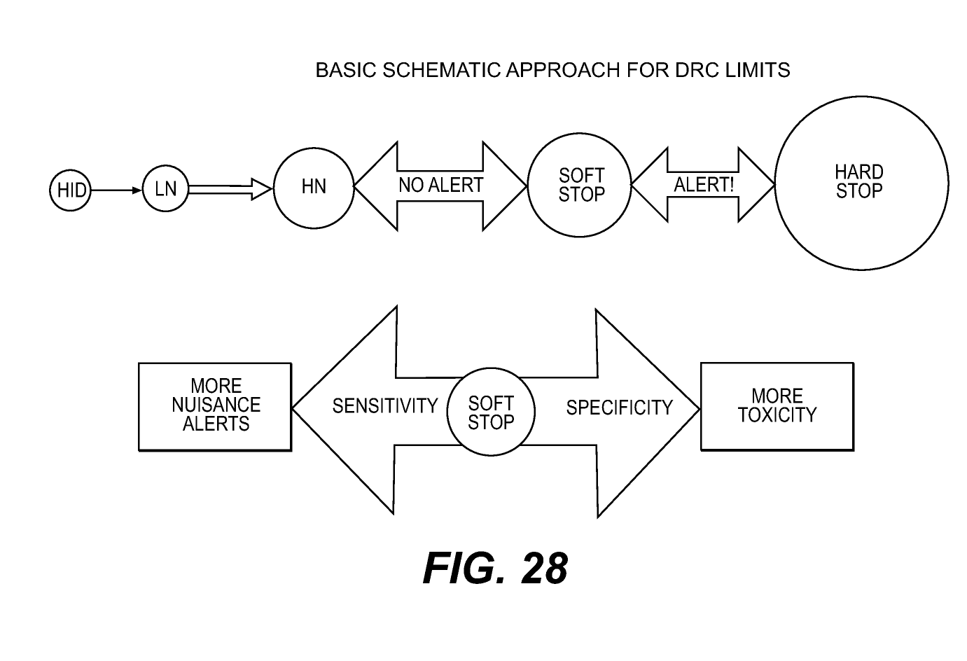

See FIG. 28.

### Determining Hard & Soft Limits:

### Historical Ordering Pattern

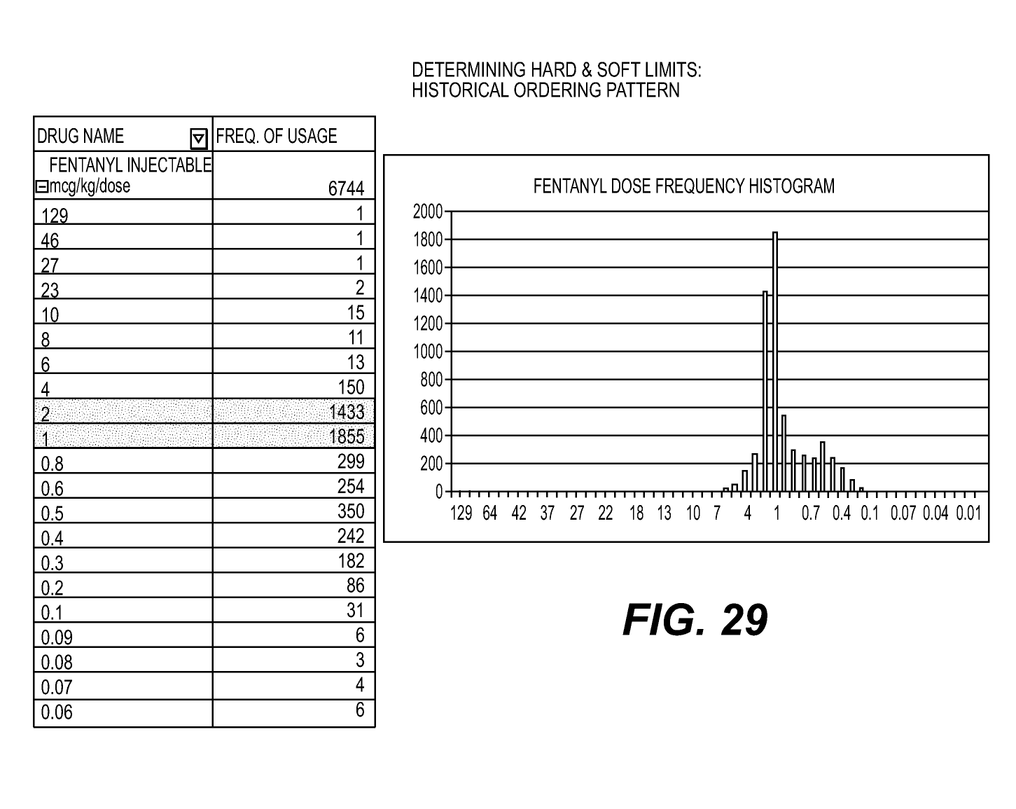

See FIG. 29.

### Create Dose Range Reference Table in Excel

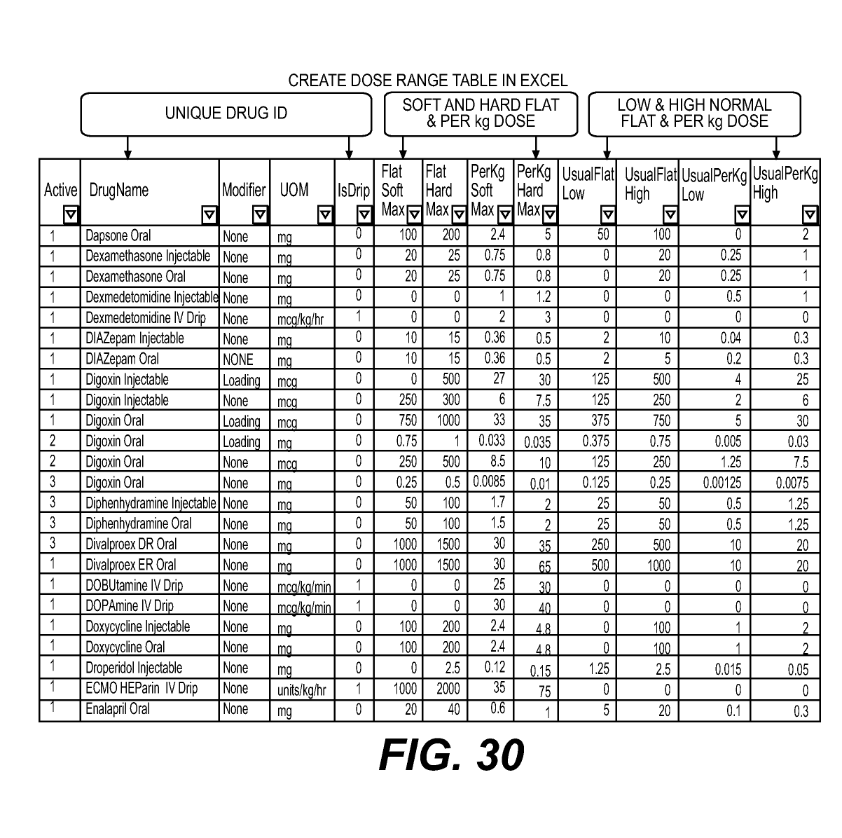

See FIG. 30.

### Step 1:

### Export Drug Item Catalogue

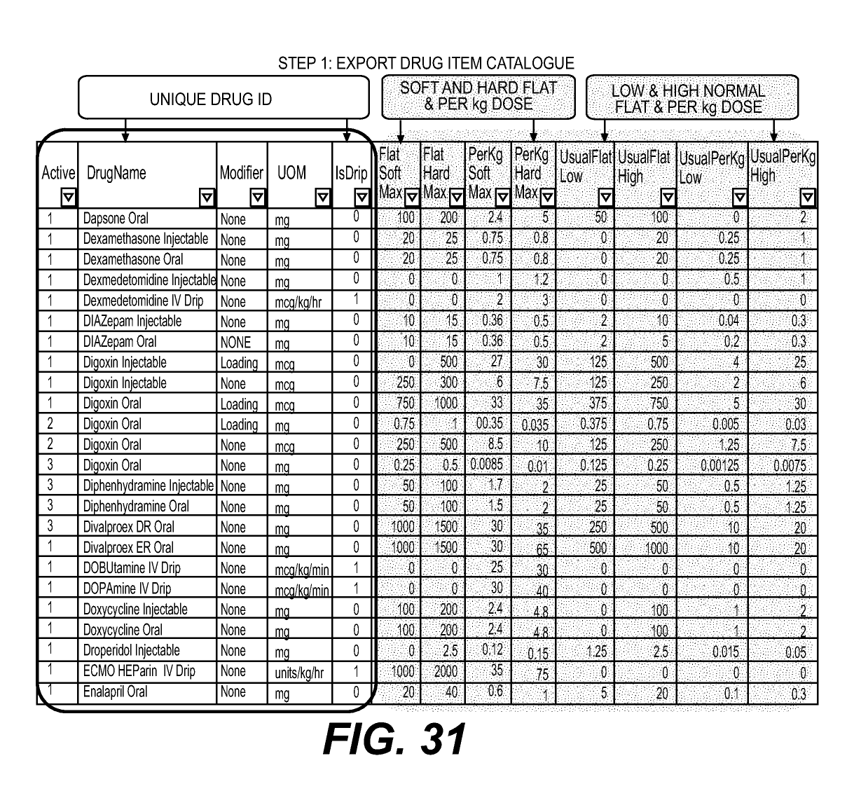

See FIG. 31.

### Step 2:

### Set Four Basic Dosing Limits

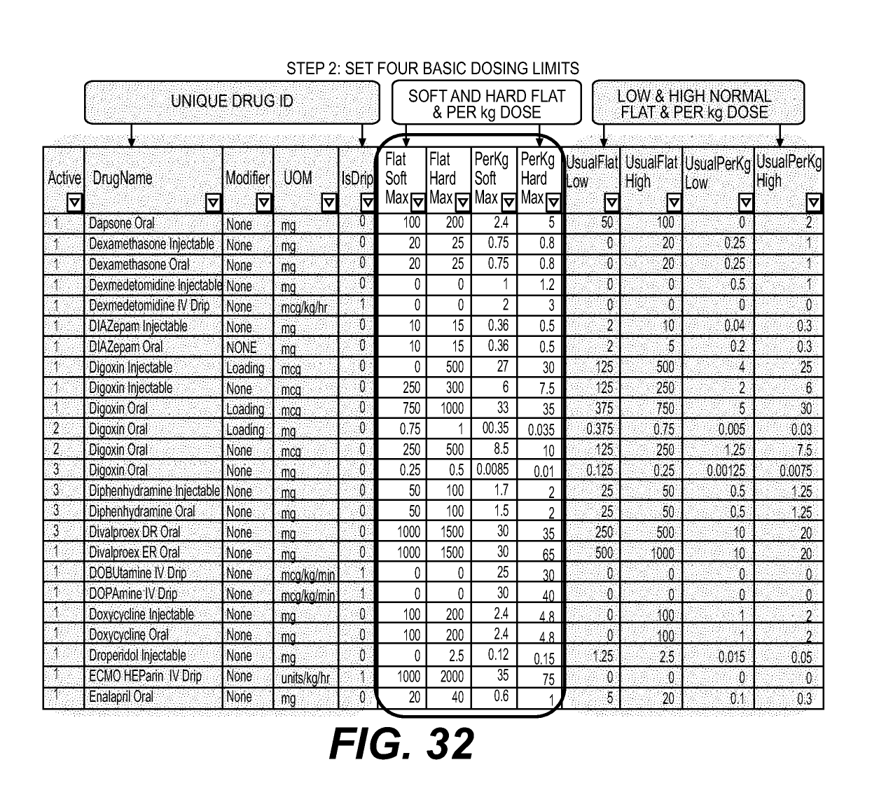

See FIG. 32.

### Step 3: Define “Normal” Values

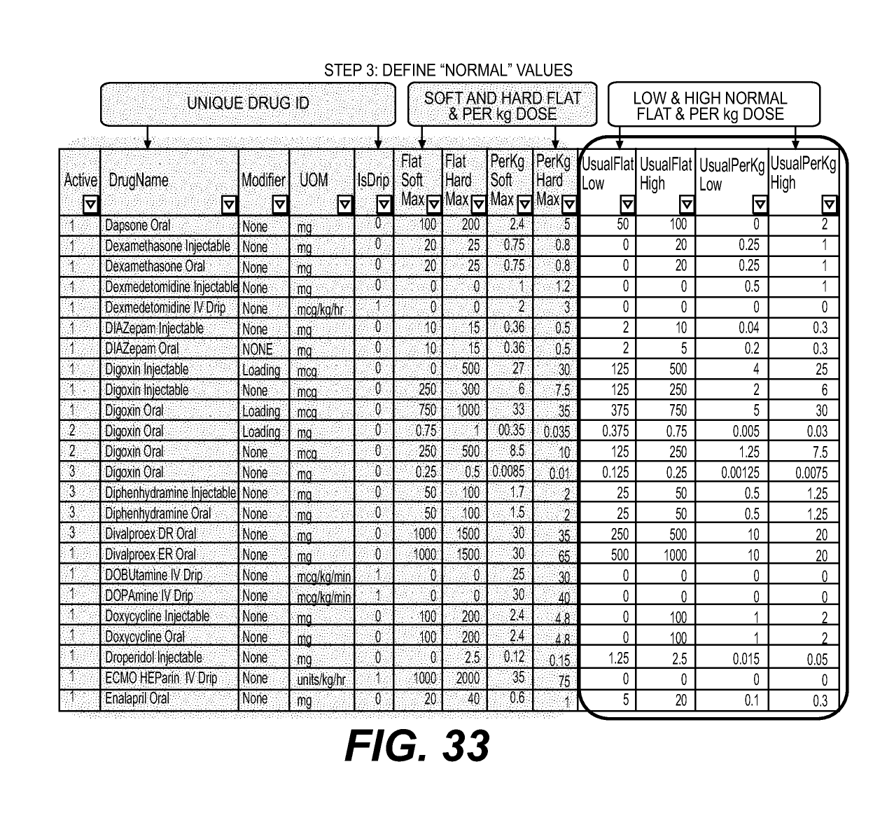

See FIG. 33.

### Final Dosing Table in Excel

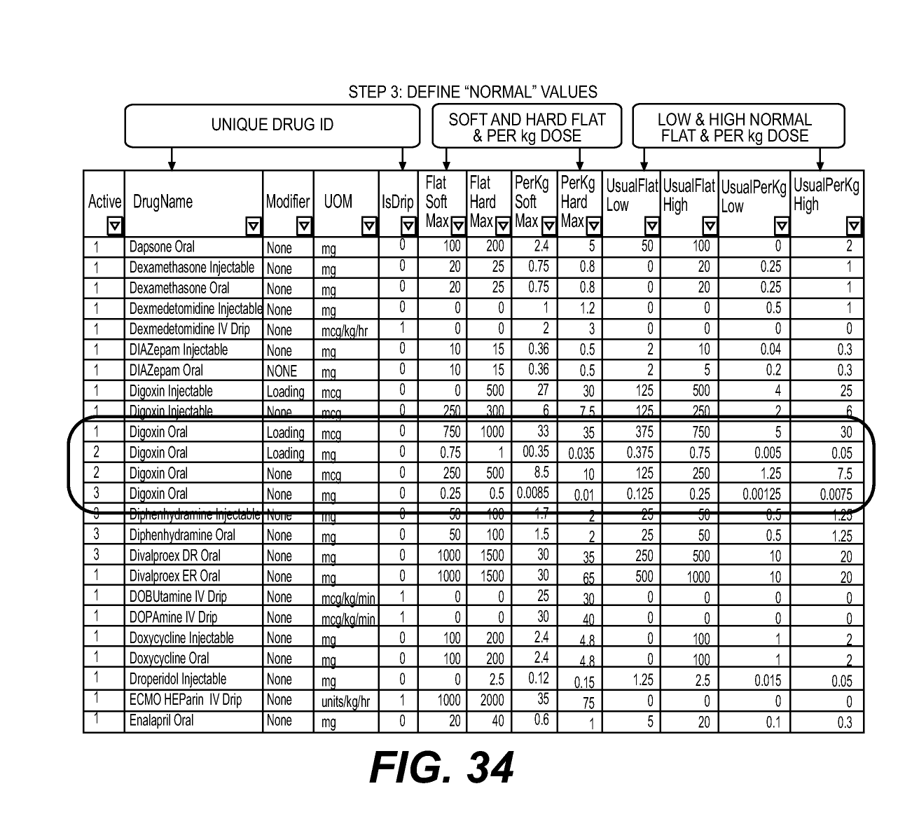

See FIG. 34.

### Future Enhancements

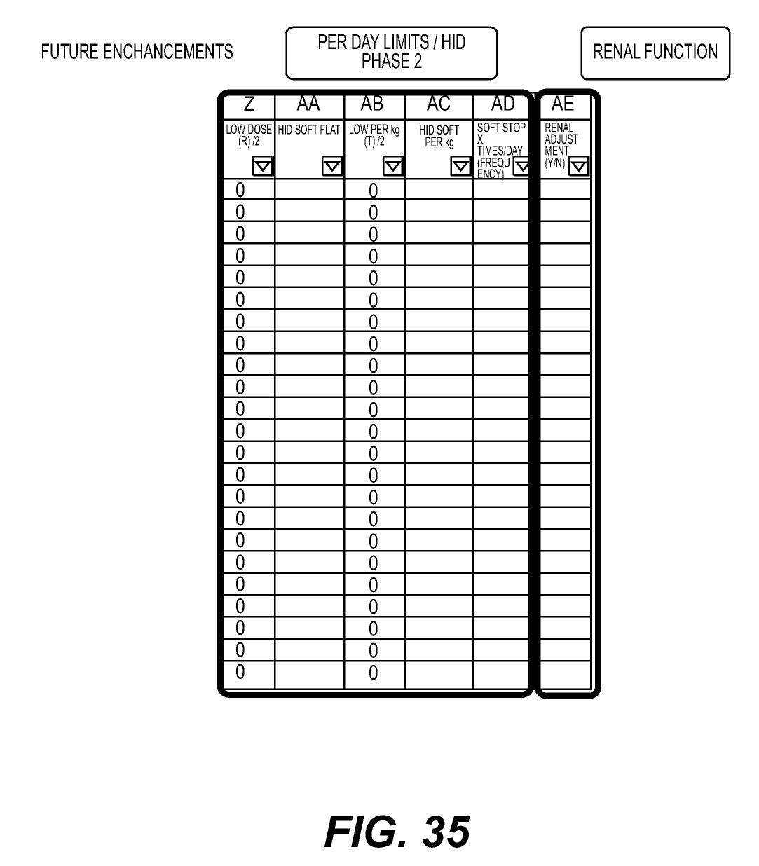

See FIG. 35.

Create Custom Dose Range table in SCM Database

### Custom DR Table in SCM Database

Macros/formula in Excel Dose Range Table used to create insert statements
Insert statements used to insert rows in custom dose range table in database
Export from SQL table is compared with the original Excel table file for accuracy
Queries to compare SQL table with drug item catalog for any missing items
MLM uses custom dose range table to check for DRC
Single DRC entries can be excluded from table if issues are found.

### Creating MLM for DRC

### Final Workflow: Specs for MLM Logic

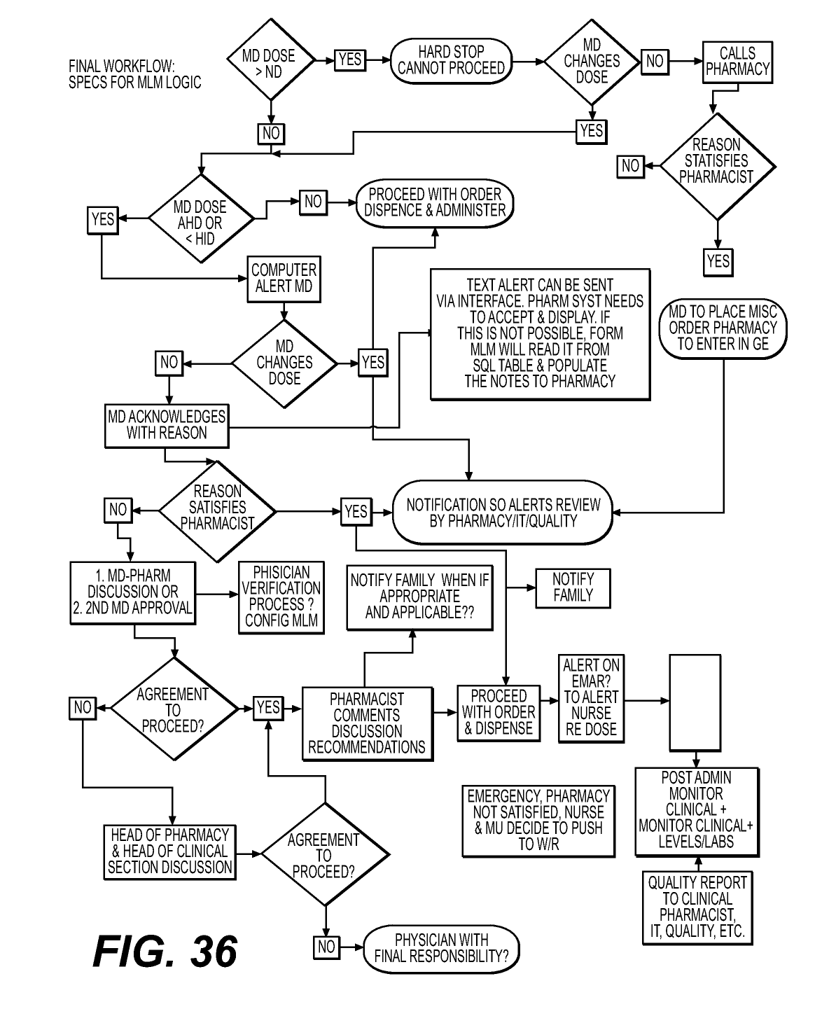

See FIG. 36.

### One Single MLM:

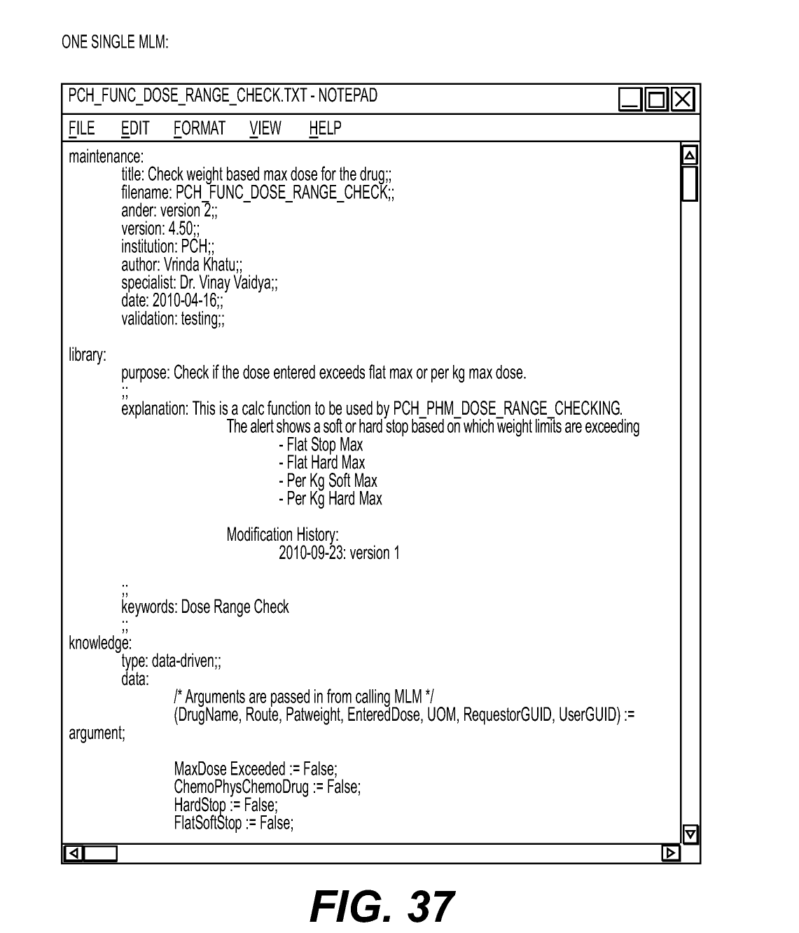

See FIG. 37.

### “English Language” Version of MLM

Drugname, Modifier, UOM and IsDrip together identifies a unique record in PCH_DoseRanges table.
Do not alert if the alert was displayed to the same user, same patient and same drug in >5 minutes and <past 48 hours.
Alert must be acknowledged with COMMENT before proceeding when soft max limits are exceeded and it hard stops on exceeding hard max limits.
If the order is entered by a pharmacist AND the order is a verbal order from physician, then do not hard stop, provide a soft stop alert and create Pharmacy Consult order.
For nurses and other non-LIPs, check only soft stop limits and if the dose exceeds that, then they are hard stopped.

### MLM Logic

Does it exceed Hard Stop Per Kg?
Does it exceed Hard Stop Flat dose?
Does it exceed SOFT Stop Per Kg?
Does it exceed SOFT Stop Flat dose?
Is it Drip?
Is it a verbal/telephone order by a Nurse (non-LIP)?
Is the order entered by Pharmacist?
Unique alert message for each of the above conditions?

### Type of Alerts in SCM

4 levels of Alerts in SCM
1. Proceed
2. Acknowledge and Proceed
3. Acknowledge+Comment and Proceed
4. Hard Stop (Cannot Proceed)
   WORDING of Alert was crucial!!

### DRC Soft Stop Example

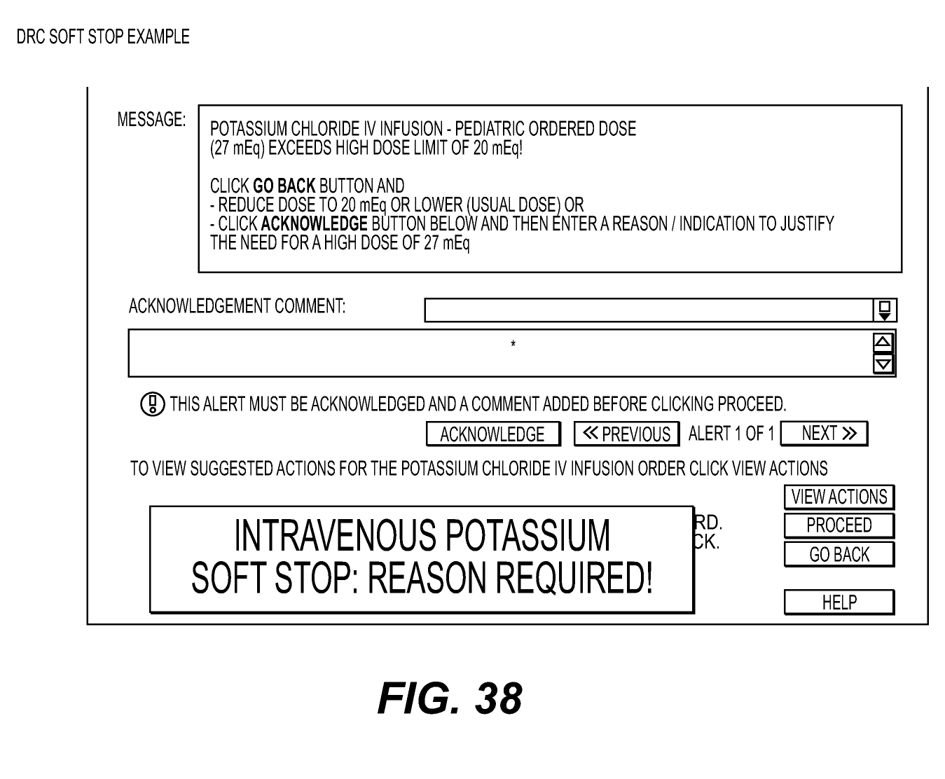

See FIG. 38.

Verbal/Telephone Order>Soft Stop limit=Hard Stop for Nurses (Non-LIP)

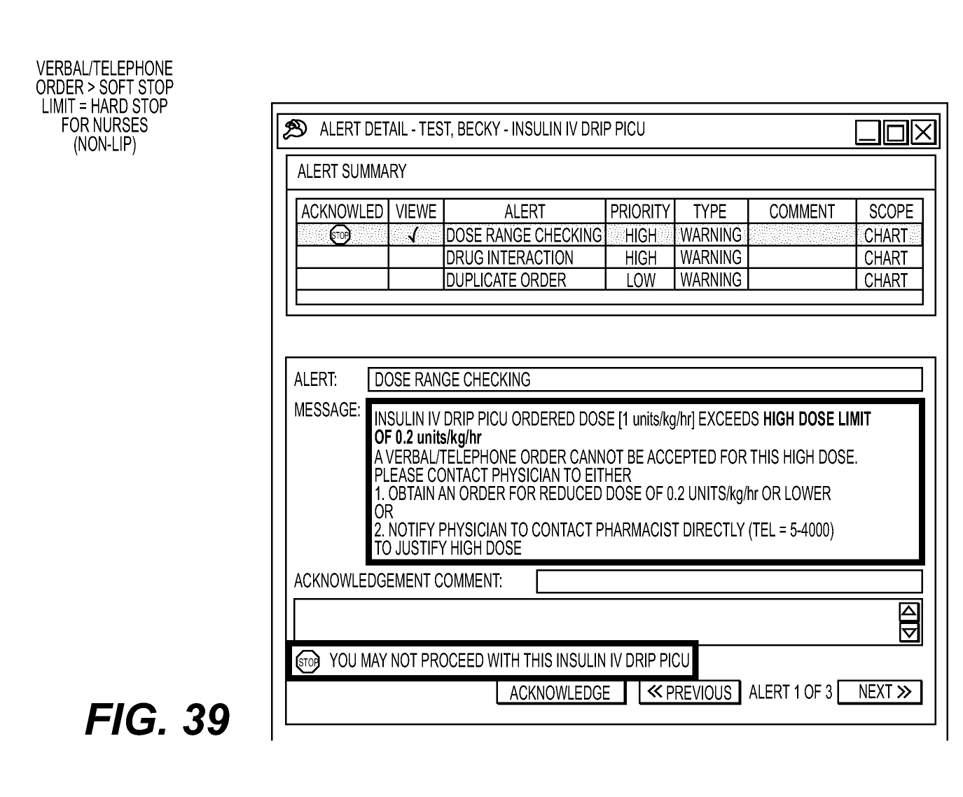

See FIG. 39.

### DRC Hard Stop Example

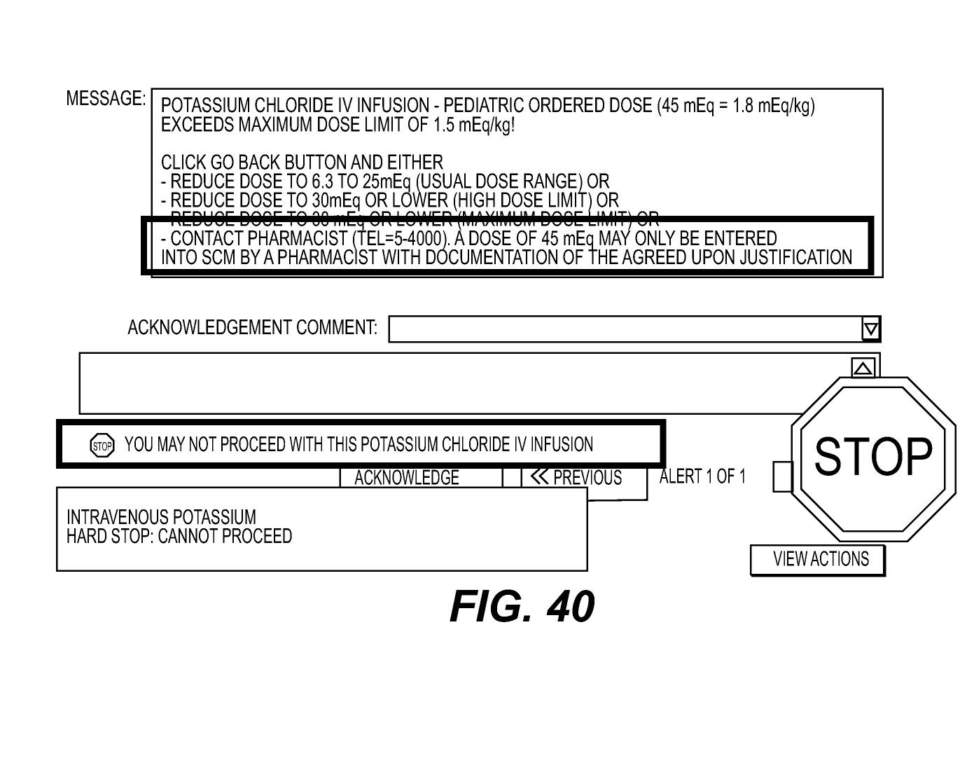

See FIG. 40.

Only a Pharmacist is permitted to override a hard stop in SCM

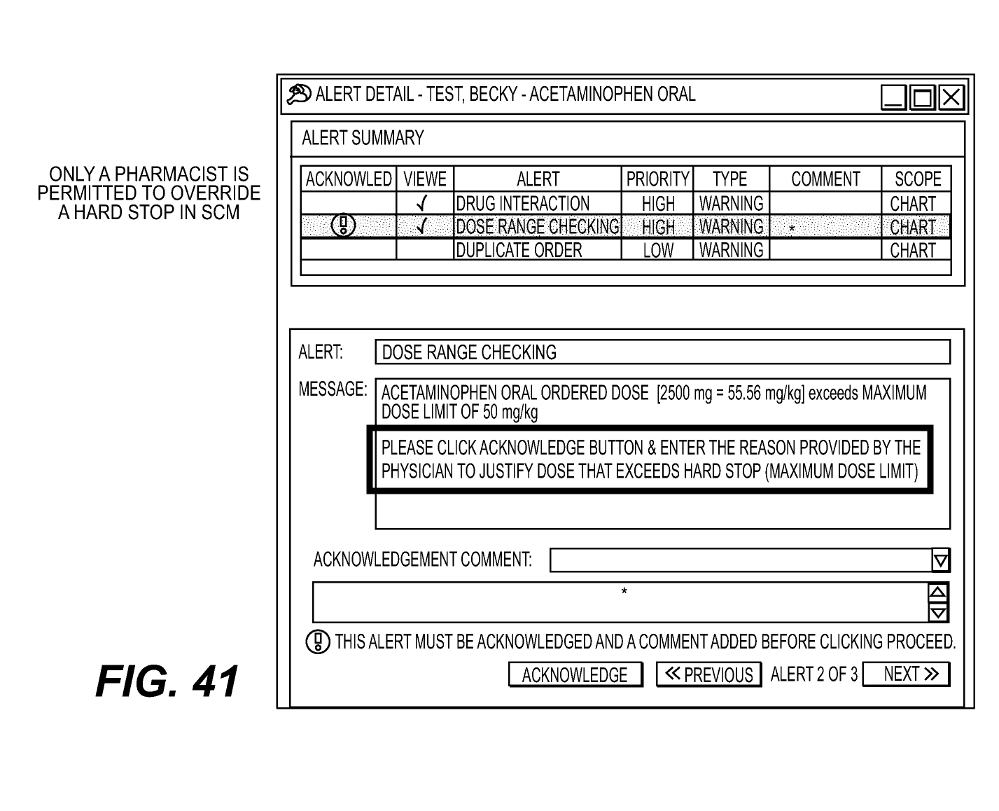

See FIG. 41.

So who gets notified?

### Soft Alert Flows From SCM to GE Pharmacy

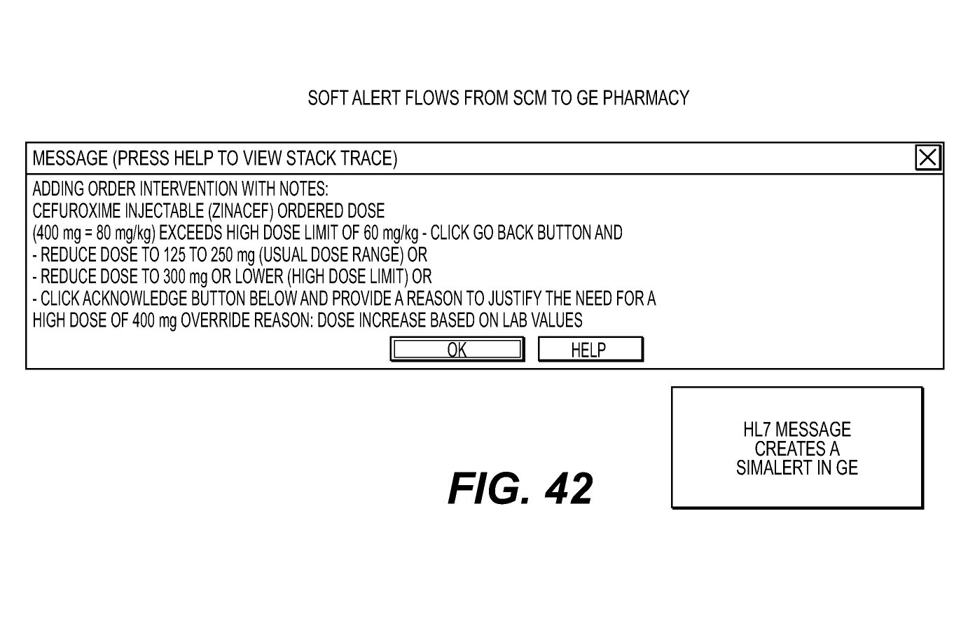

See FIG. 42.

### Automatic Order Intervention is Created in the GE Pharmacy System

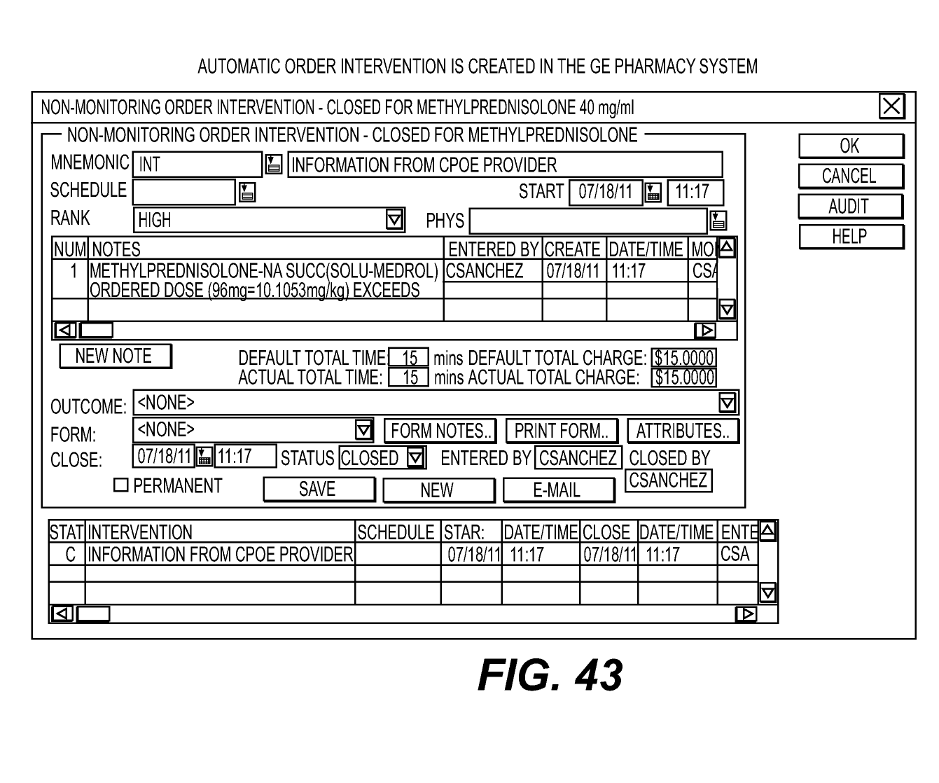

See FIG. 43

### Order Intervention in GE Pharmacy System

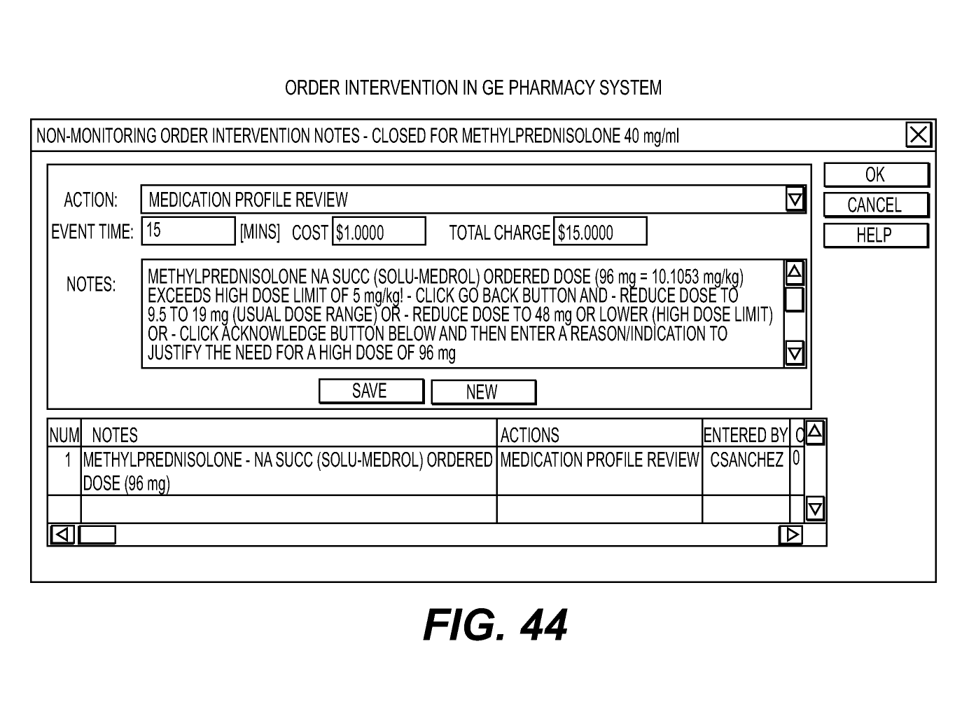

See FIG. 44.

### Email Alert Generated by MLM

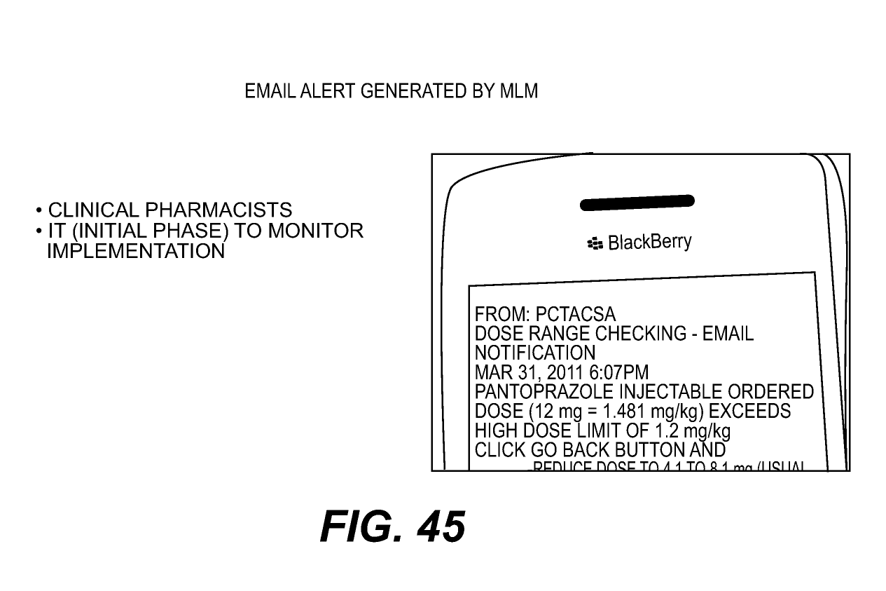

See FIG. 45.

### Closing the Loop

### Tracking the Outliers . . .

A pharmacy consult order is generated by an MLM when a hard stop is entered by pharmacy.
×1 orders are excluded
Clinical pharmacists have orders & location-based lists to track patients
Clinical pharmacists document on a structured note regarding clinical necessity and/or monitoring of the high-dose drugs.

### RESULTS!!

### Of 1154 Medication Orders, 923 (80%) Orders Checked Daily for DRC

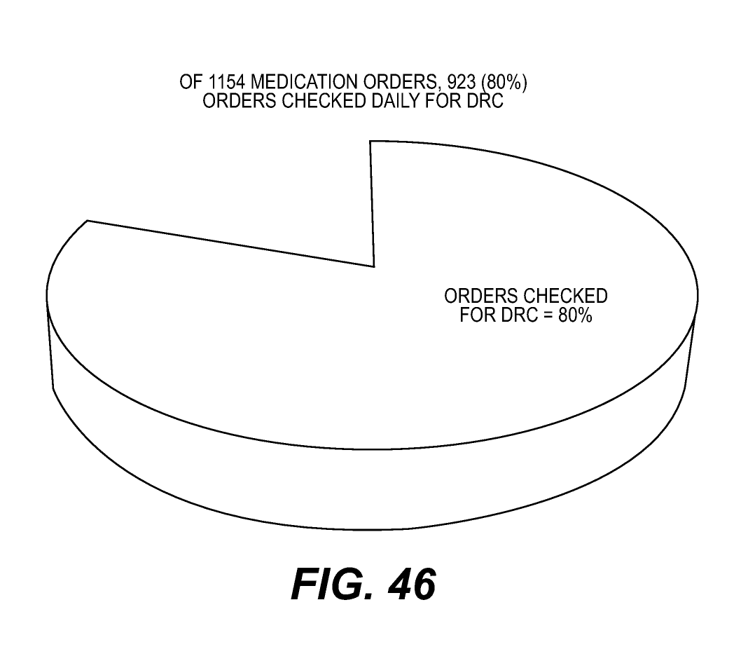

See FIG. 46.

### Of 923 Meds Checked for DRC, 30 (3%) Orders Result in Alerts (Soft or Hard Stop)

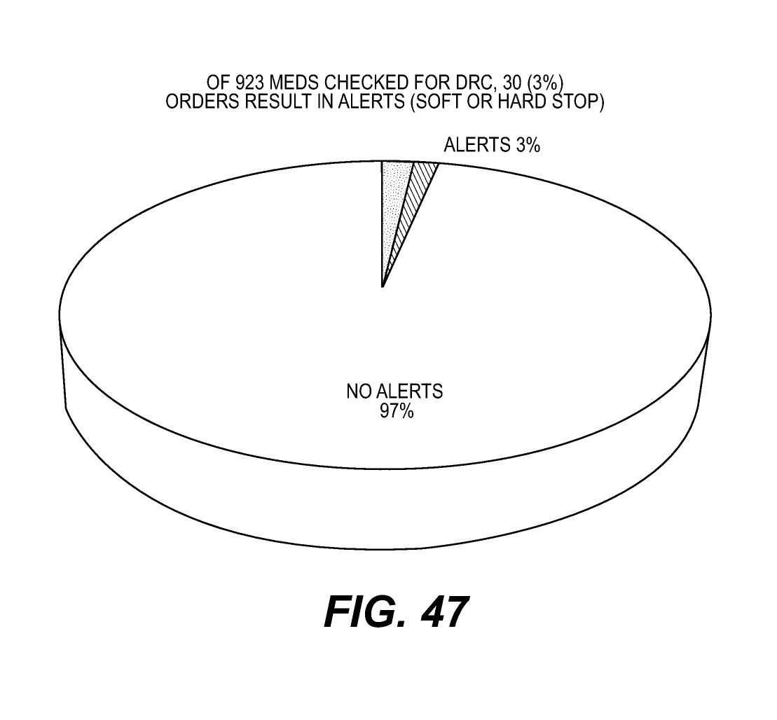

See FIG. 47.

### Of 30 Alerts: 19 Soft Stops (66%), 11 (33%) Hard Stops Per Day

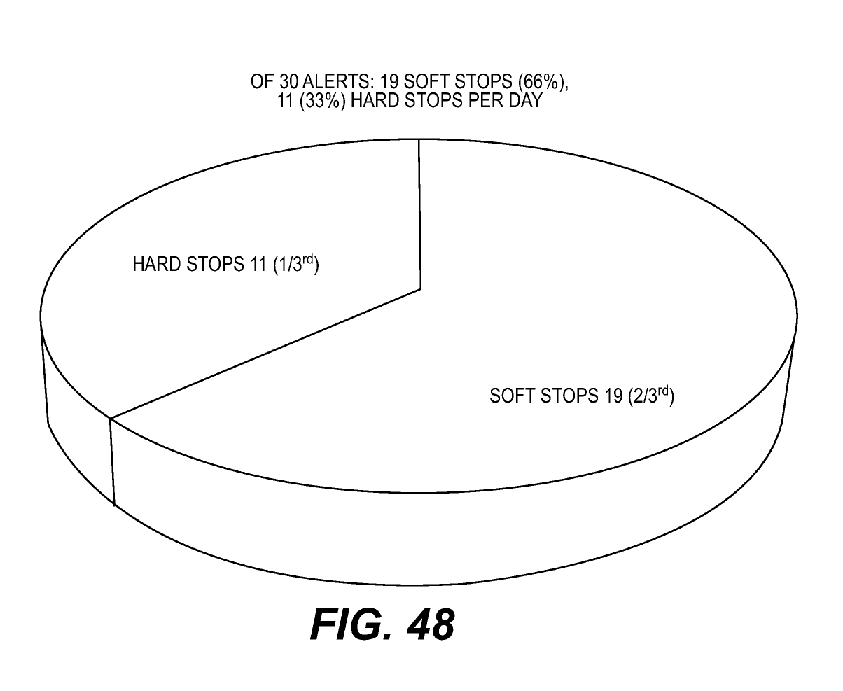

See FIG. 48.

### 17 of 30 (56%) Alerts/Day: Resulted in Cancelled or Modified Order

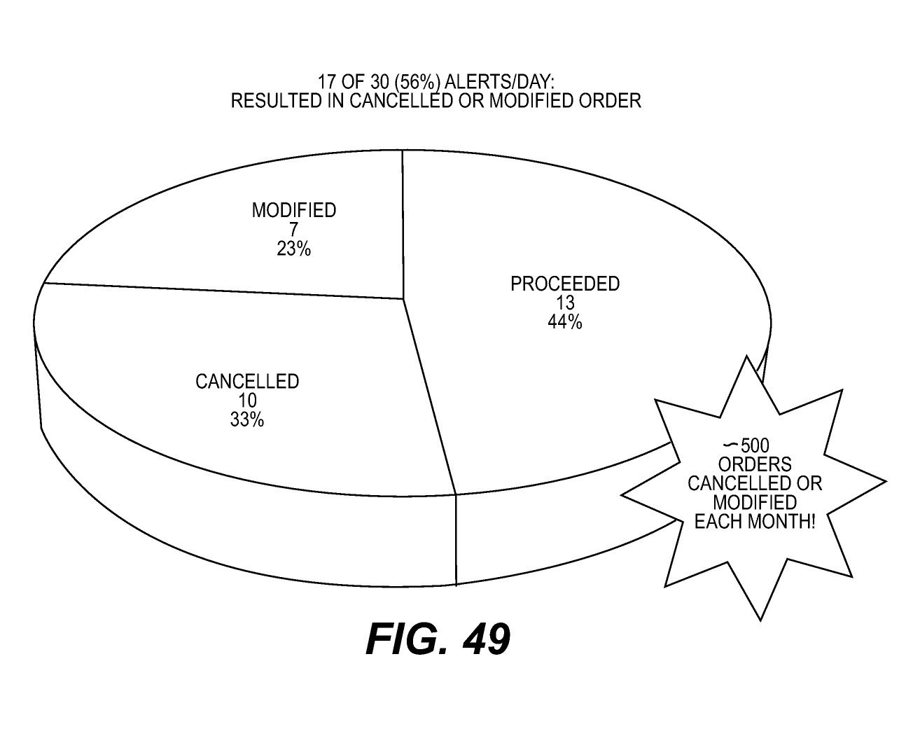

See FIG. 49.

### What Did the Modifications Look Like? (First 10 Days Data)

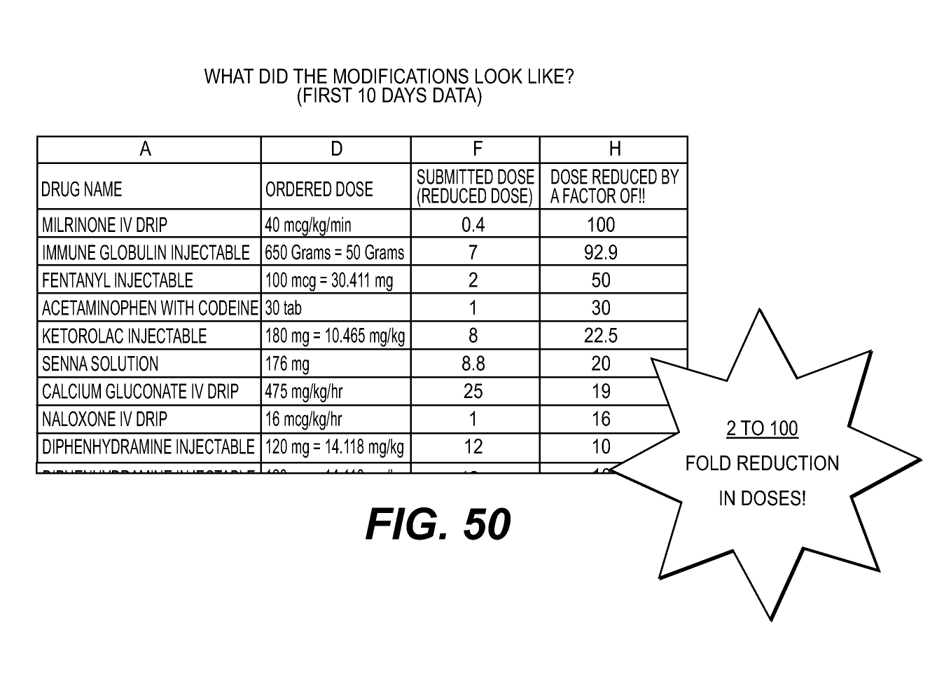

See FIG. 50.

### SUMMARY

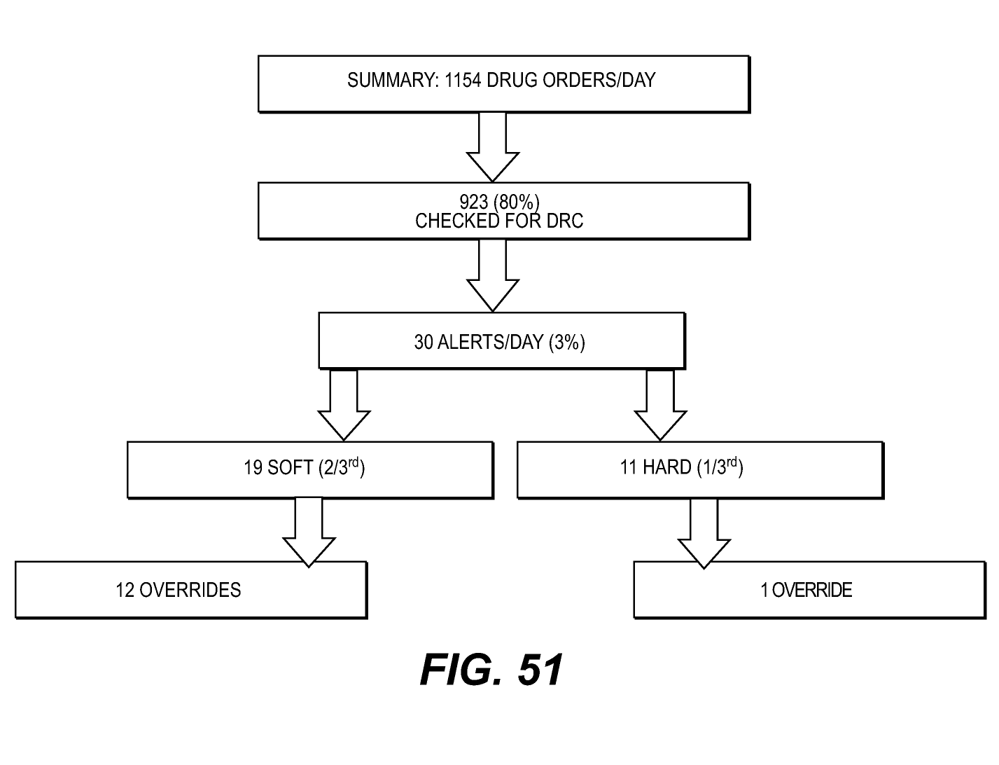

See FIG. 51.

### Results/Impacts

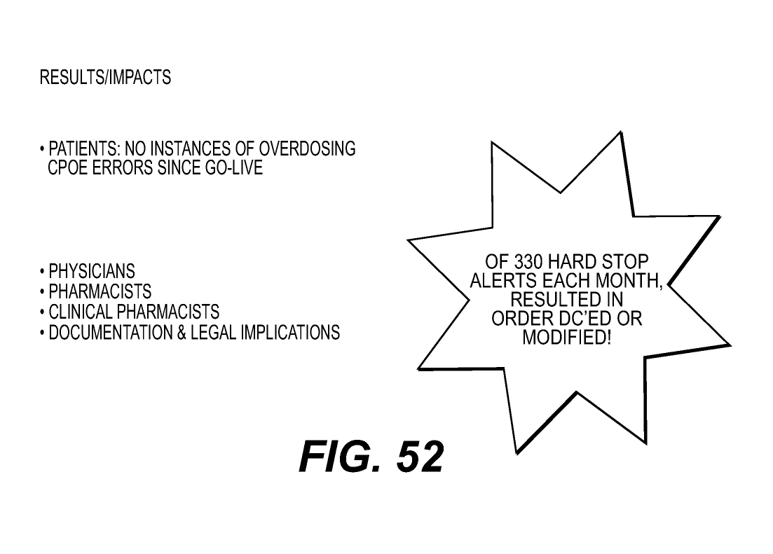

See FIG. 52.

### Alert Fatigue, Hard Stops & Other Bad Guys!

3% alert rate=1 alert only every 30 med orders
Hard stops only 1 every 75 orders
Maximum alerts per single physician (resident)=29 per month=1 per day
Maximum alerts per single ATTENDING=14 per month=1 every 2 days

### Success Factors

Pre-existing functionality:
   CPOE adoption>97%
   SCM-GE Pharmacy system bidirectional interface
   Mandatory weight requirement prior to DRC
Single MLM, Single Table (dosing limits look-up)
   Phased approach: Only per-dose DRC in phase 1
   Soft and hard limits based on analysis of 500 K orders+literature reference
   Multidisciplinary group: IT, pharmacy
   Weekly working meetings
   Communication: Care Provider IT committee, hospital leadership, P & T, Pharmacist orientation
   Post Go-Live intense monitoring

### Future Directions

Extend DRC from 600 to all 1200 drugs
Enhance features
   Maximum dose per day (based on frequency)
   Highly ineffective doses
   Body surface area (M² Dosing)
   Tablets
   Renal, Hepatic adjustments
   Alert on eMAR
   Adult dose caps/Order sentences/Order sets

### DRC: Discussion Points in Review

1. Problems & Challenges

2. Project Aims/Goals

3. DRC Solution

4. Step by Step Process

5. Results & Impact on Safety

6. Success Factors

### Phoenix Children's Hospital, Example #2

### Alerts by Users

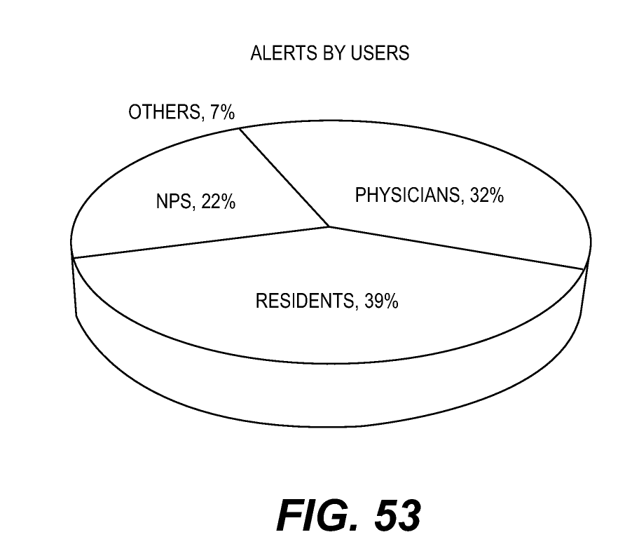

See FIG. 53.

Potassium: 11 Hard Stops 4 months

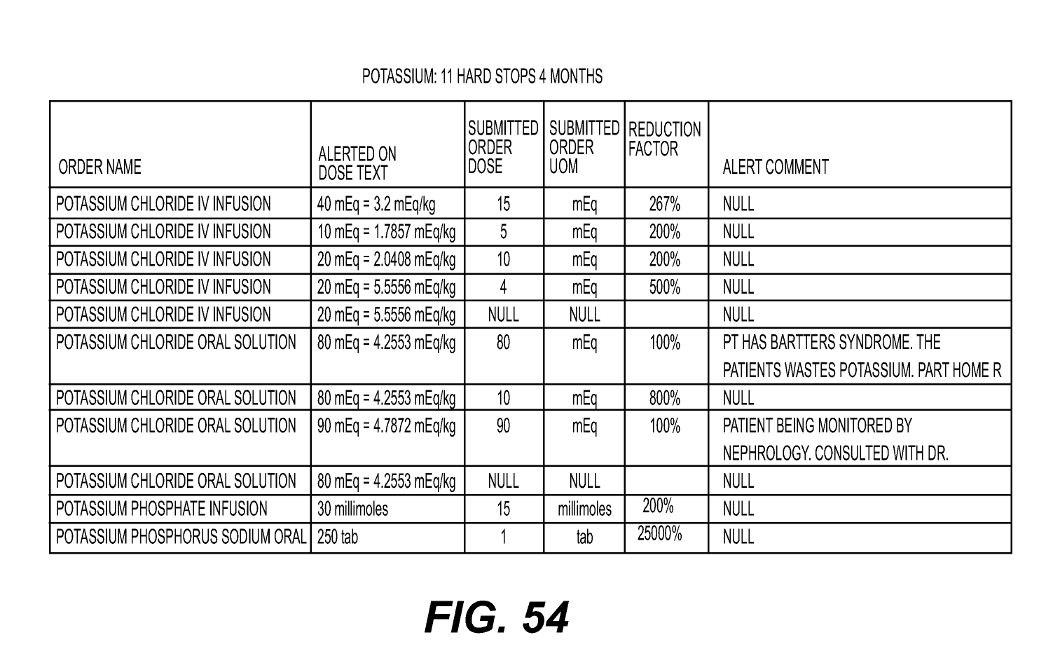

See FIG. 54.

Insulin Drip: 9 Soft+Hard stops

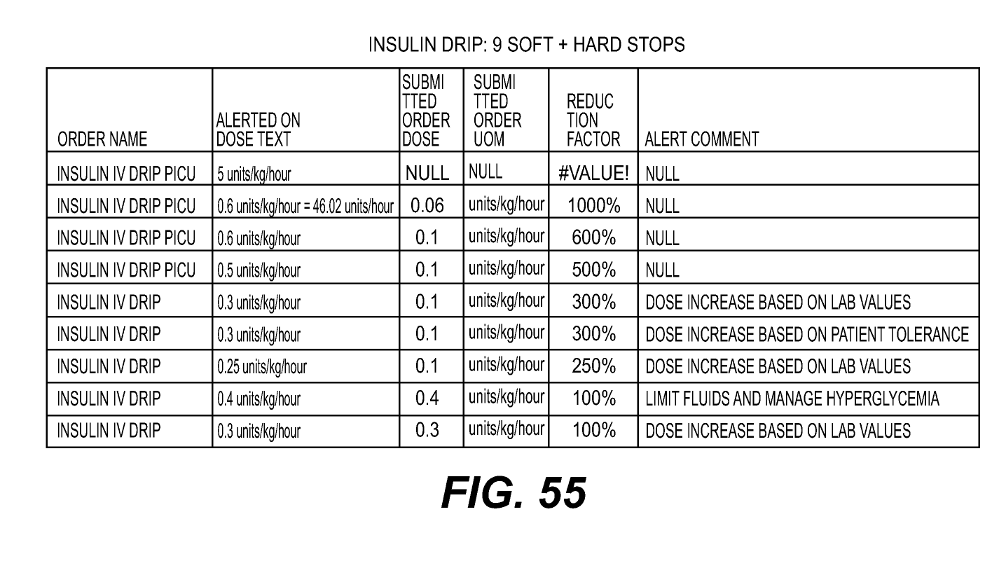

See FIG. 55.

Fentanyl: 12 Soft & Hard stops

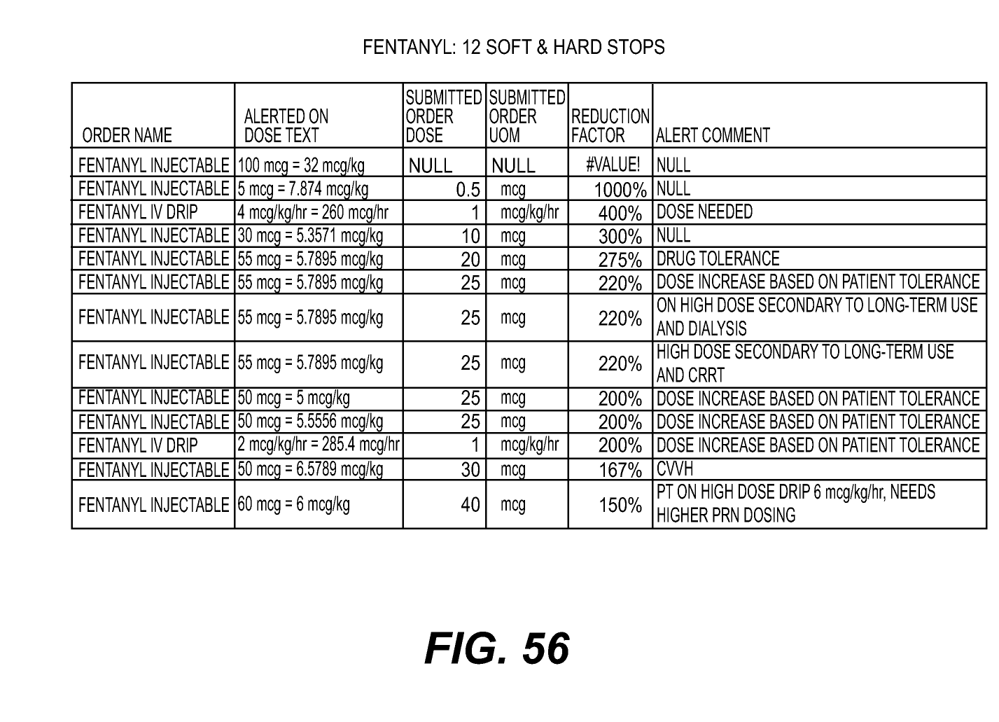

See FIG. 56.

### Hydrocodone: Tab

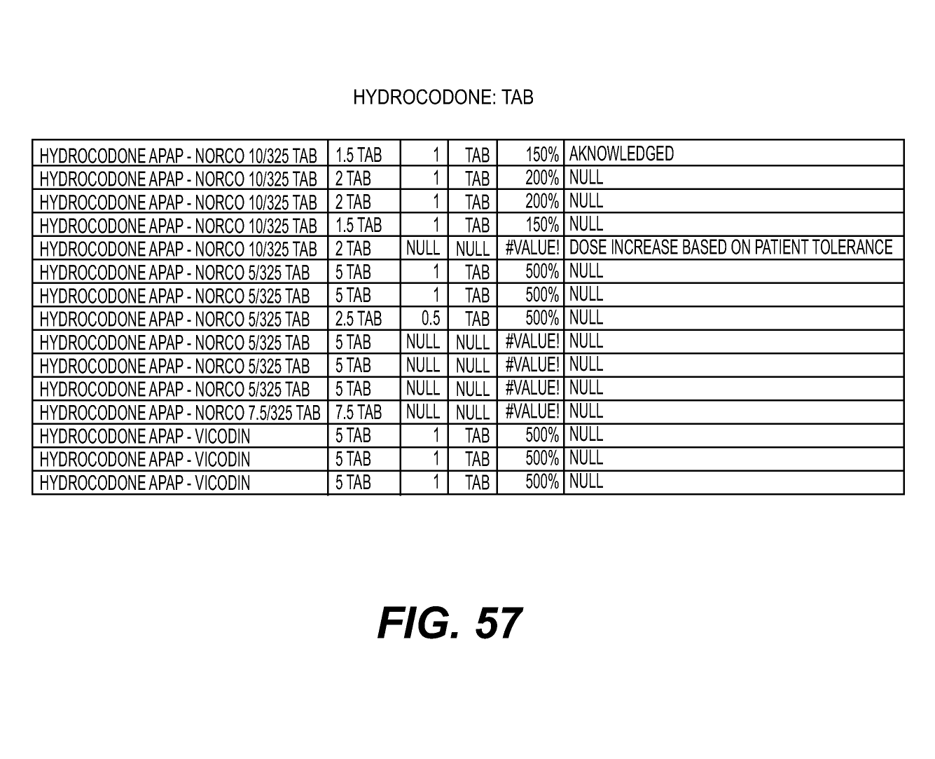

See FIG. 57.

### Hydrocodone Elixir

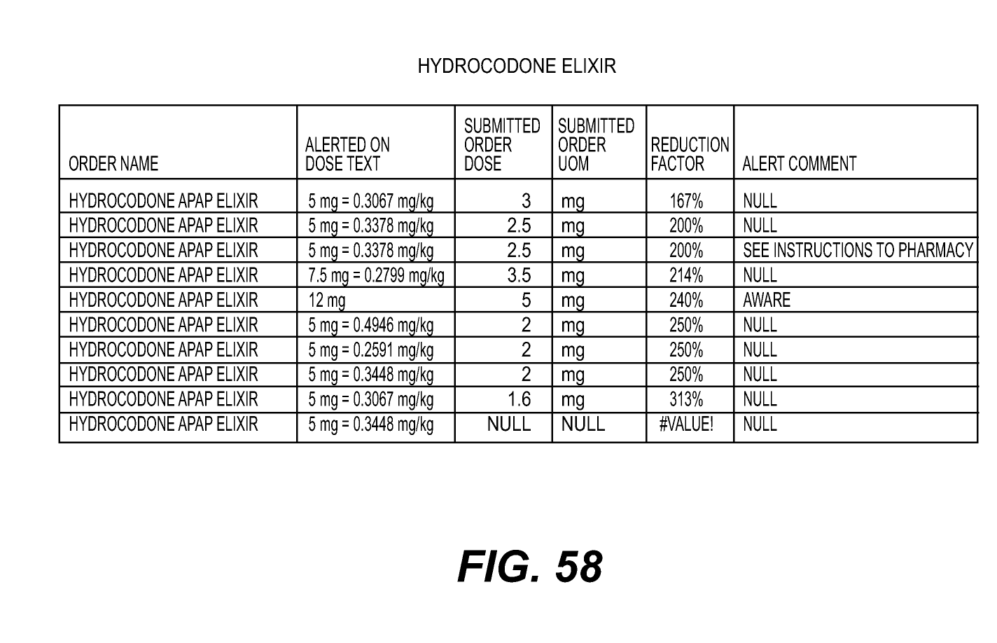

See FIG. 58.

### Morphine Soft Stop

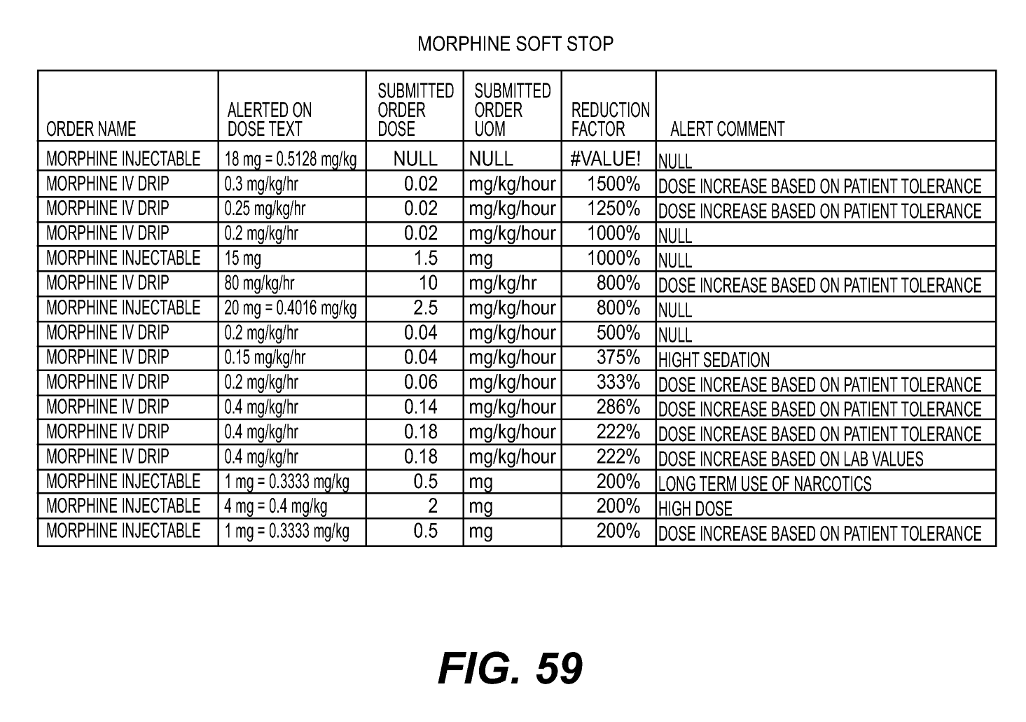

See FIG. 59.

Heparin: Overdose overlaps with increased requirements

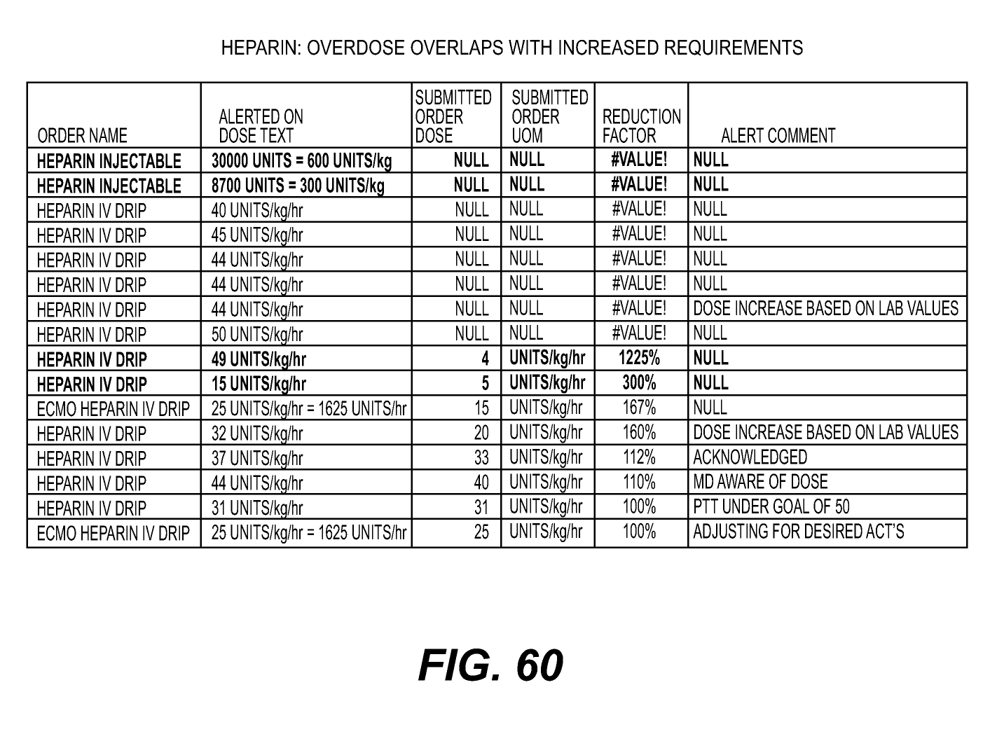

See FIG. 60.

Digoxin: Decimal Error 10 times dose=1000%

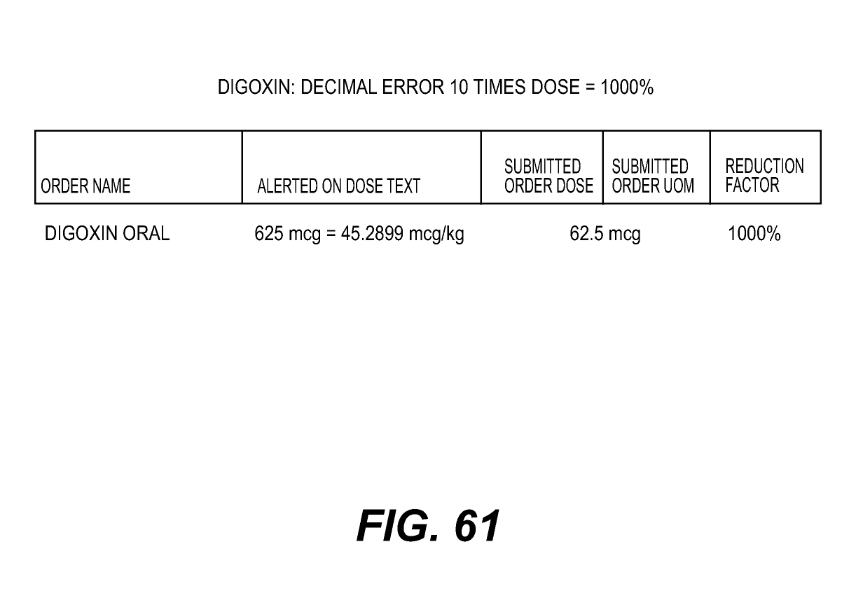

See FIG. 61.

Top 10 Hard Stops: Cancelled or reduced suggesting dosing error

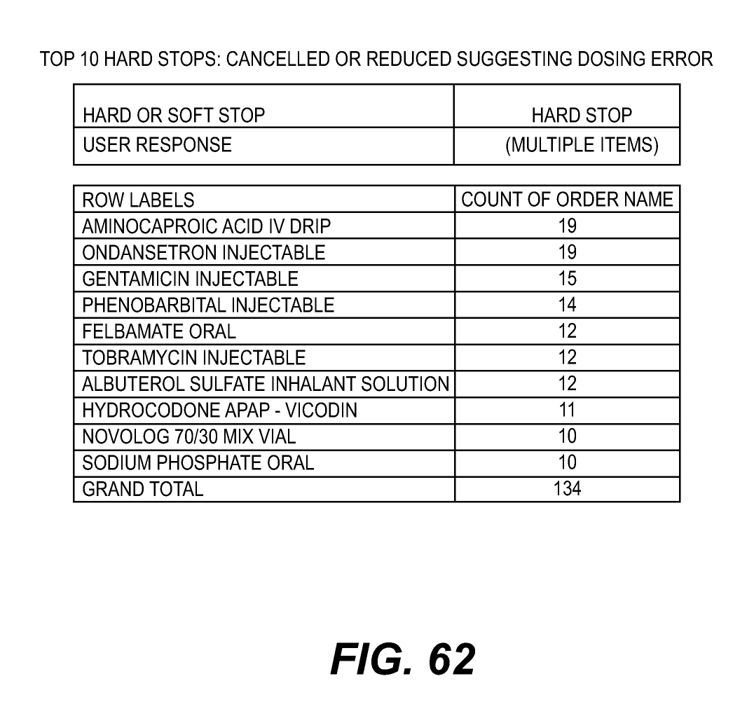

See FIG. 62.

Top 10 Drugs where Hard Stop was Overridden

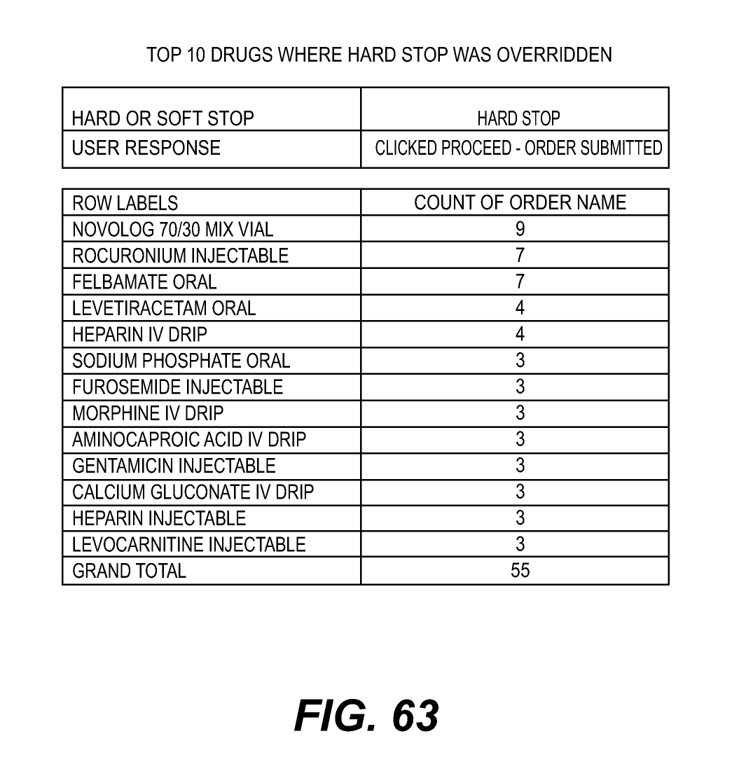

See FIG. 63.

Hard stops Cancelled/Reduced: Possible reasons?
Typo error
Decimal error: 0.5 units/kg/hour instead of 0.05 units/kg/hr (10 times)
Unit of Measure: 3 mg instead of 3 mcg (1000 times)
Tab instead of mg (5 tabs instead of 5 mg)
Patient needing high doses (relative small reduction)
Knowledge deficit
Human factors: Distraction/fatigue/system design
   Rich source of analysis
Which location in Hospital
Level of training
Which drugs most common

### Summary

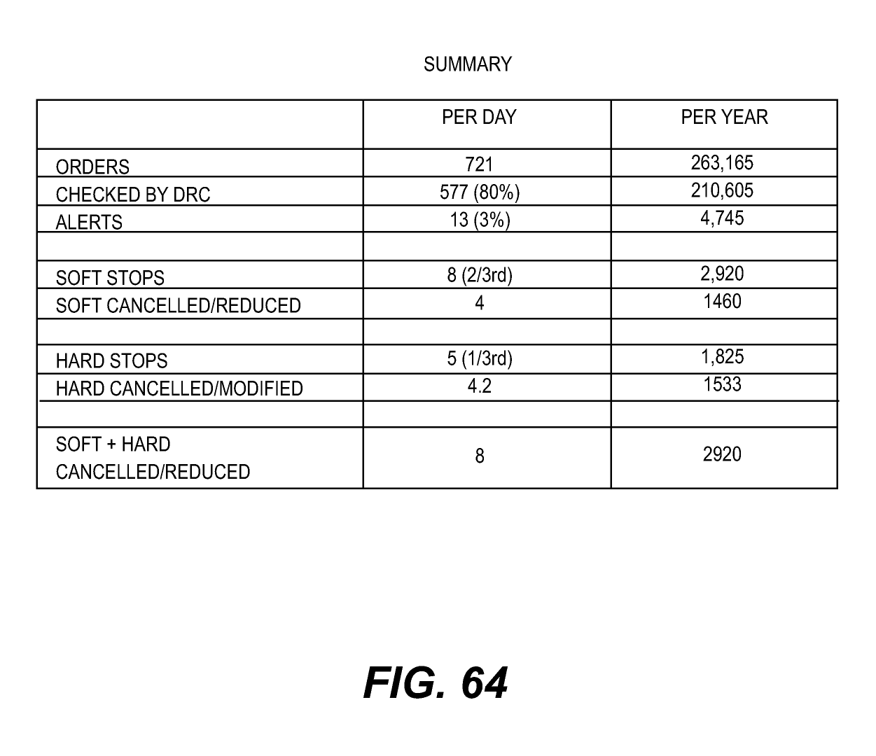

See FIG. 64.

### Phoenix Children's Hospital, Example #3

### PRACTITIONER EXPERIENCE DECREASES MEDICATION DOSING ERRORS IN A PEDIATRIC ICU

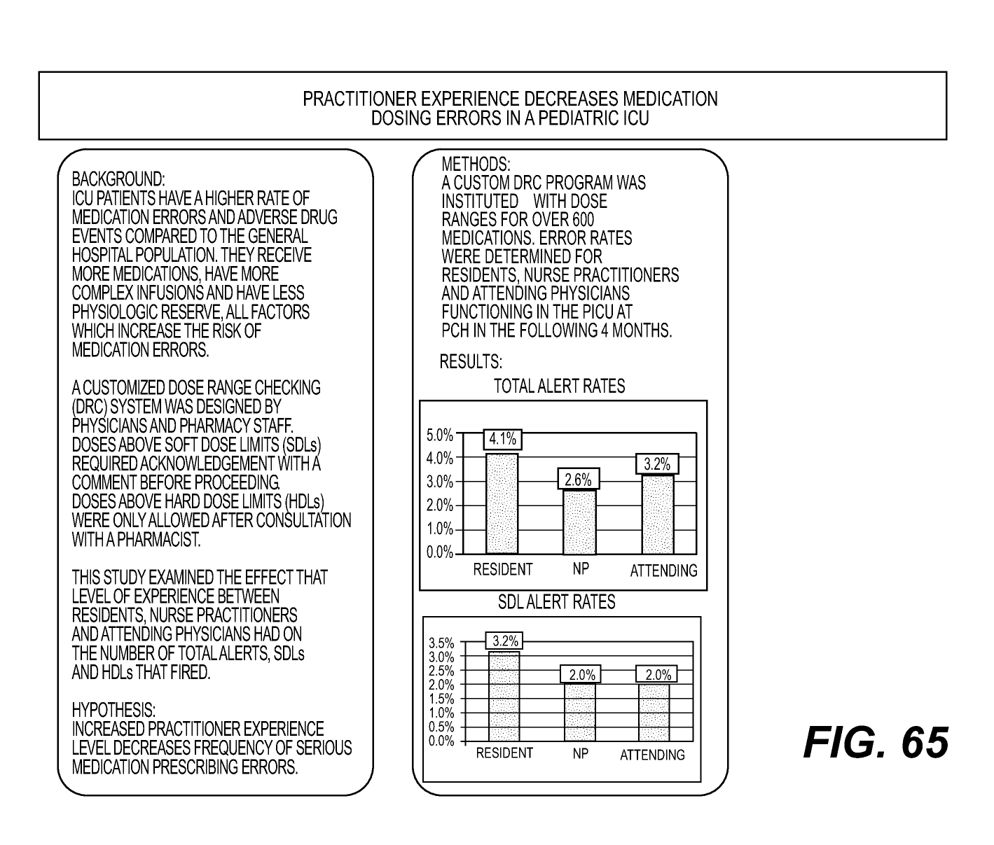

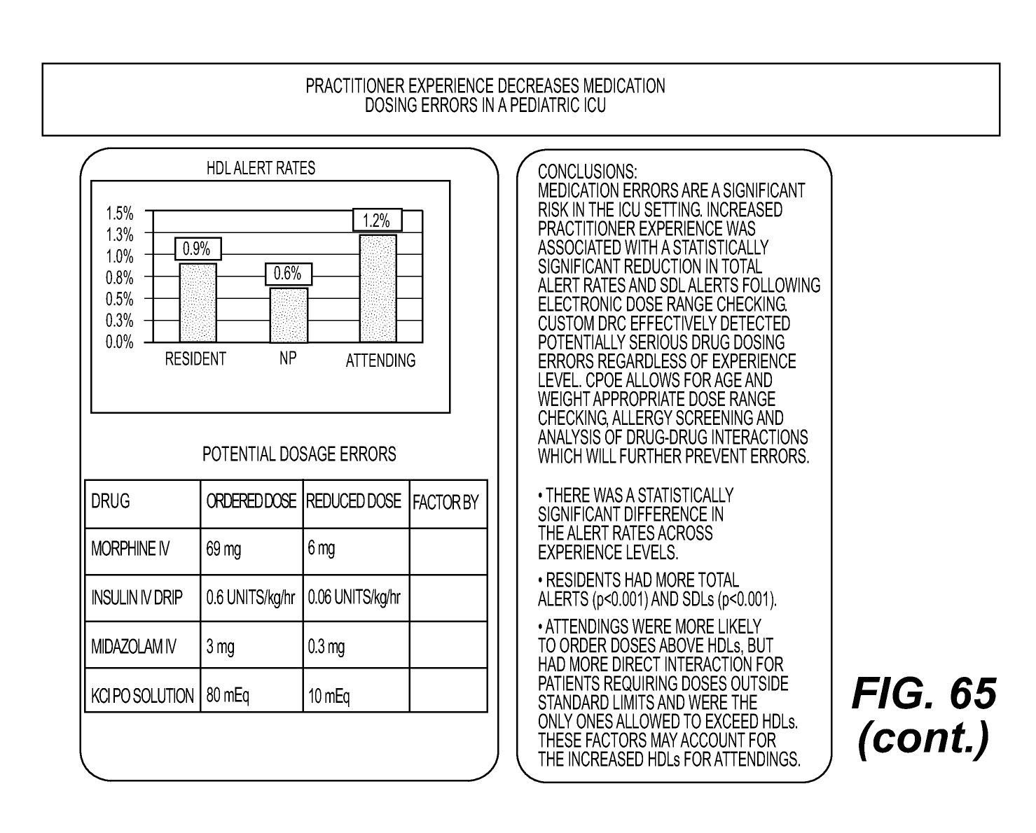

See FIG. 65.

### CUSTOMIZATION OF DOSE RANGE CHECKING SYSTEM DECREASES MEDICATION ERRORS IN A PEDIATRIC ICU

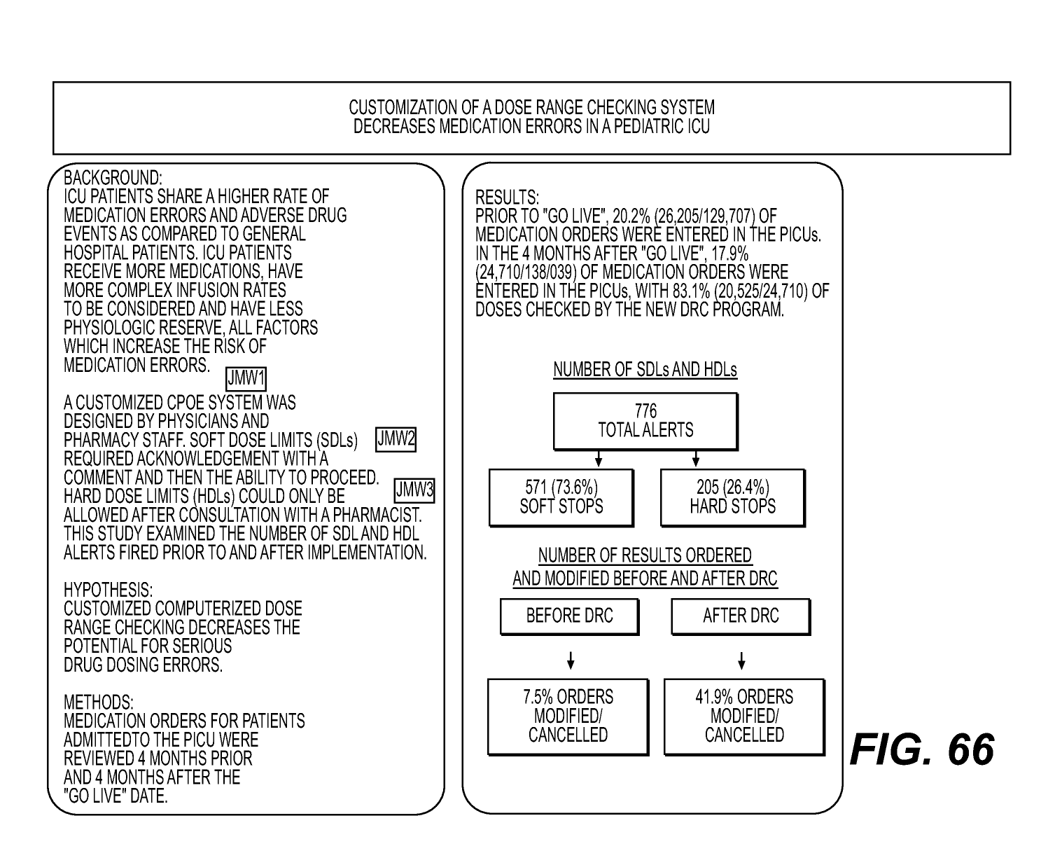

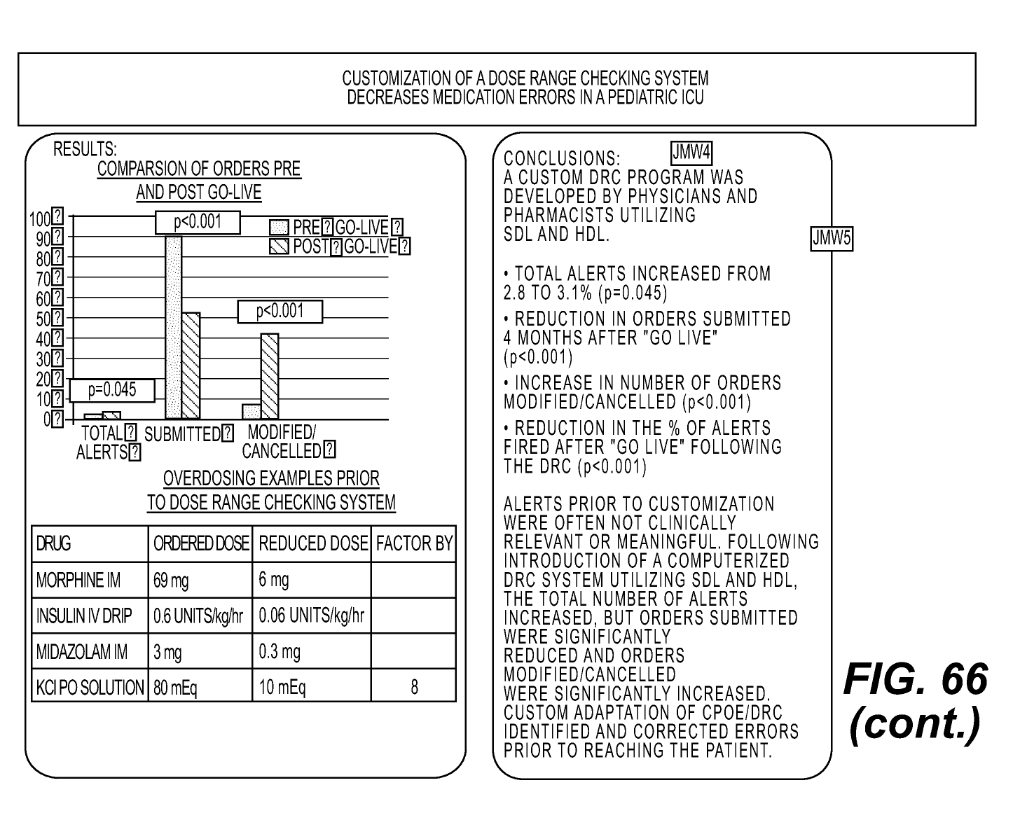

See FIG. 66.

It will be appreciated by those skilled in the art to which the present subject matter pertains that various modifications can be made without departing from the essential nature thereof. It is intended to encompass all such modification within the scope of the appended claims.

We claim:

1. A method of checking a prescription dosage using a device having a data terminal, a central processing unit, a central server, and an electronic patient record database comprising a plurality of electronic patient records and an electronic drug reference database, comprising:
entering an order into the data terminal, the order comprising a prescribed dosage of a medication for a patient;
uploading the order to the central server;
identifying a dosage or dosage range from the electronic drug reference database for the medication based on the medication prescribed and at least one patient parameter obtained from an electronic patient record for the patient contained in the electronic patient record database;
comparing the prescribed dosage with the identified dosage or dosage range;
determining whether the prescribed dosage falls above or below the identified dosage or outside the identified dosage range; and
generating and outputting an alert if the prescribed dosage falls above or below the identified dosage or outside the identified dosage range.

2. The method of claim 1, wherein the patient is a pediatric patient and the electronic patient record database is a pediatric electronic patient record database.

3. The method of claim 1, wherein the identified dosage or dosage range does not trigger an alert rate greater than 2.6%.

4. The method of claim 1, wherein if the prescribed dosage falls within the identified dosage range, then the order is filled by a pharmacist.

5. The method of claim 1, wherein the identified dosage comprises at least a maximum dosage and an alarmingly high dosage.

6. The method of claim 5, wherein when the prescribed dosage exceeds the maximum dosage but does not exceed the alarmingly high dosage, a soft stop alert is generated that can be overridden by the caregiver.

7. The method of claim 5, wherein when the prescribed dosage exceeds the alarmingly high dosage, a hard stop alert is generated that can be overridden by a pharmacist only upon communication between the caregiver and the pharmacist.

8. The method of claim 1, wherein the identified dosage comprises at least a minimum dosage and a highly ineffective dosage.

9. The method of claim 8, wherein when the prescribed dosage is less than the minimum dosage but not less than the highly ineffective dosage, a soft stop alert is generated that can be overridden by the caregiver.

10. The method of claim 8, wherein when the prescribed dosage is less than the highly ineffective dosage, a hard stop alert is generated that that can be overridden by a pharmacist only upon consultation with the caregiver.

11. The method of claim 1, wherein the identified dosage comprises at least a 1° dosage range including a minimum dosage endpoint and a maximum dosage endpoint, and a 2° dosage range including a highly ineffective dosage endpoint and an alarmingly high dosage endpoint where the 2° dosage range encompasses the 1° dosage range.

12. The method of claim 11, wherein when the prescribed dosage is outside the 1° dosage range but is within the 2° dosage range a soft stop alert is generated that can be overridden by the caregiver.

13. The method of claim 11, wherein when the prescribed dosage is outside the 2° dosage range, a hard stop alert is generated that cannot be overridden by the caregiver alone, but can be overridden by a pharmacist only upon consultation with the caregiver.

14. The method of claim 1, wherein the identified dosage or dosage range is one or more dosages or dosage ranges selected from the group consisting of a 1° dosage range including a minimum dosage endpoint and a maximum dosage endpoint, a 2° dosage range including an ineffective dosage endpoint and an alarmingly high dosage endpoint, a minimum dosage range including a minimum dosage endpoint and a highly ineffective dosage endpoint, a maximum dosage range including a maximum dosage endpoint and a highly alarming dosage endpoint, a minimum dosage, a maximum dosage, an alarmingly high dosage, and a highly ineffective dosage.

15. The method of claim 1, wherein an electronic patient record of the patient contained in the electronic patient record database is updated with patient data in real time.

16. A system for checking a prescribed dosage for a patient, comprising:
an electronic patient record database comprising a computer readable assembly of a plurality of electronic patient records each corresponding to a particular patient, and an electronic drug reference database comprising drug dosing data corresponding to one or more medications;
a terminal or personal computer for receiving an order inputted by a caregiver for a prescription dosage of a medication for the patient;
to use the patient database to identify a dosage or dosage range for the medication based on the data contained in the electronic drug reference database and at least one patient parameter contained in an electronic patient record of the patient;
a device for comparing a prescribed dosage to the identified dosage or dosage range; and
a terminal or personal computer for receiving the output an alert to the caregiver, if the prescribed dosage is different from the identified dosage or dosage range.

17. The method of claim 1, wherein the identified dosage or dosage range is determined by obtaining a dosage or dosage range based on the medication prescribed and at least one patient parameter from the electronic reference drug database and checking the obtained dosage or dosage range against dosage data for that medication contained in a different medication database, to generate the identified dosage or dosage range.

18. The method of claim 17, wherein the identified dosage or dosage range comprises at least two maximum dosage parameters selected from the group consisting of flat soft stop maximum dosage, flat hard stop maximum dosage, per kilogram soft stop maximum dosage, per kilogram hard stop maximum dosage, daily flat soft stop maximum dosage, daily flat hard stop maximum dosage, daily per kilogram soft stop maximum dosage, and daily per kilogram hard stop maximum dosage.

19. The method of claim 18, wherein the at least two maximum dosage parameters are processed serially or simultaneously when comparing the ordered prescription dosage with the identified dosage or dosage range.

20. The method of claim 1, wherein the identified dosage or dosage range comprises more than one threshold measurement point.

21. The method of claim 20, wherein the more than one threshold measurement point comprises one or more maximum and one or more minimum dosing amounts of at least one dosage form of a drug.

22. The method of claim 21, wherein each maximum and minimum dosing amount corresponds to one or more units of measurement.

23. The method of claim 22, wherein the one or more units of measurement is selected from an amount of drug/kg/dose, an amount of drug/kg/day, an amount of drug/m² of body surface area/dose; a flat amount of drug/dose and/or a flat amount of drug/day.

24. The method of claim 21, wherein the maximum dosing amount is an alarmingly high dosing amount and the minimum dosing amount is a highly ineffective dosing amount.

25. The method according to claim 24, further comprising a low normal dosing amount that is more than the highly ineffective dosing amount but less than the alarming high dosing amount.

26. The method according to claim 24, further comprising a high normal dosing amount that is less than the alarmingly high dosing amount but more than the highly ineffective dosing amount.

27. The method of claim 24, further comprising a low normal dosing amount that is more than the highly ineffective dosing amount but less than the alarming high dosing amount and a high normal dosing amount that is less than the alarmingly high dosing amount but more than the highly ineffective dosing amount.

28. The method of claim 26, wherein when the prescribed dosage is greater than the alarmingly high dosing amount, a hard stop alert is outputted.

29. The method of claim 28, wherein the hard stop alert prevents the order from processing by a pharmacy unless the prescribed dosage is reduced or a pharmacist manually overrides the hard stop alert and/or documents the reason for proceeding with the order.

30. The method of claim 29, further comprising proceeding with order and dispensing of the prescribed dosage when the prescribed dosage is reduced or the pharmacist manually overrides the hard stop and/or documents the reason for proceeding with the order.

31. The method of claim 27, wherein when the prescribed dosage is greater than the high normal dosing amount but less than the alarmingly high dosing amount, a soft stop alert is outputted.

32. The method of claim 31 wherein the soft stop alert comprises outputting a message for a caregiver indicating that the prescribed dosage is abnormal and suggesting that the prescribed dose be changed.

33. The method of claim 31, wherein the soft stop alert is suppressed if a corresponding alert was outputted for the same patient, same drug and same caregiver within the previous 48 hours.

34. The method of claim 32, wherein when the caregiver reduces the prescribed dosage pursuant to the soft stop alert, a notification of the alert is generated for review by a reviewing party and the order proceeds to being dispensed.

35. The method of claim 34, wherein the reviewing party is a pharmacist, an information technology team member, or a quality assurance team member.

36. The method of claim 32, wherein when caregiver does not change the prescribed dosage, the caregiver is required to input a reason for proceeding.

37. The method of claim 36, wherein the reason for proceeding is sent via an interface to the pharmacy for review by a pharmacist prior to dispensing the prescribed dosage.

38. The method of claim 36, wherein the reason for proceeding is populated in a virtual medical record.

39. The method of claim 37, wherein when the pharmacist rejects the reason for proceeding, a consultation form is outputted.

40. The method of claim 39, wherein the consultation form requires the approval of the caregiver and the pharmacist or the approval of a second caregiver in order for the order to be processed and dispensed by the pharmacy.

41. The method of claim 40, wherein when the consultation form is not approved by both the pharmacist and the caregiver or the second caregiver, approval is required by the head of pharmacy and/or the head of clinical.

42. The method of claim 41, wherein when the head of pharmacy and/or the head of clinical do not provide approval, the caregiver is provided with an option to proceed with the order.

43. The method of claim 40, wherein when approval is provided, the reason for approval is outputted into a virtual medical record.

44. The method of claim 27, wherein when the prescribed dosage is less than the highly ineffective dosing amount, a hard stop alert is outputted.

45. The method of claim 44, wherein the hard stop alert prevents the order from processing by a pharmacy unless the prescribed dosage is increased or a pharmacist manually overrides the hard stop alert and/or documents the reason for proceeding with the order.

46. The method of claim 45, further comprising proceeding with order and dispensing of the prescribed dosage when the prescribed dosage is increased or the pharmacist manually overrides the hard stop and/or documents the reason for proceeding with the order.

47. The method of claim 27, wherein when the prescribed dosage is less than the low normal dosing amount but greater than the highly ineffective dosing amount, a soft stop alert is outputted.

48. The method of claim 47, wherein the soft stop alert comprises outputting a message for a caregiver indicating that the prescribed dosage is abnormal and suggesting that the prescribed dose be changed.

49. The method of claim 47, wherein the soft stop alert is suppressed if a corresponding alert was outputted for the same patient, same drug and same caregiver within the previous 48 hours.

50. The method of claim 48, wherein when the caregiver increases the prescribed dosage pursuant to the soft stop alert, a notification of the alert is generated for review by a reviewing party and the order proceeds to being dispensed.

51. The method of claim 50, wherein the reviewing party is a pharmacist, an information technology team member, or a quality assurance team member.

52. The method of claim 49, wherein when the caregiver does not change the prescribed dosage, the caregiver is required to input a reason for proceeding.

53. The method of claim 52, wherein the reason for proceeding is sent via an interface to the pharmacy for review by a pharmacist prior to dispensing the prescribed dosage.

54. The method of claim 52, wherein the reason for proceeding is populated in a virtual medical record.

55. The method of claim 53, wherein when the pharmacist rejects the reason for proceeding, a consultation form is outputted.

56. The method of claim 55, wherein the consultation form requires the approval of the caregiver and the pharmacist or the approval of a second caregiver in order for the order to be processed and dispensed by the pharmacy.

57. The method of claim 56, wherein when the consultation form is not approved by both the pharmacist and the caregiver or the second caregiver, approval is required by the head of pharmacy and/or the head of clinical.

58. The method of claim 57, wherein when the head of pharmacy and/or the head of clinical do not provide approval, the caregiver is provided with an option to proceed with the order.

59. The method of claim 57, wherein when approval is provided, the reason for approval is outputted into a virtual medical record.
